(19) United States
(12) Patent Application Publication
(10) Pub. No.: US 2015/0250175 A1
(43) Pub. Date: Sep. 10, 2015

(54) PESTICIDALLY ACTIVE MIXTURES COMPRISING ANTHRANILAMIDE COMPOUNDS

(71) Applicant: BASF SE, Ludwigshafen (DE)

(72) Inventors: Karsten Koerber, Eppelheim (DE); Jean-Yves Wach, Mannheim (DE); Florian Kaiser, Mannheim (DE); Matthias Pohlman, Freinsheim (DE); Prashant Deshmukh, Mannheim (DE); Deborah L. Culbertson, Fuquay Varina, NC (US); W. David Rogers, Durham, NC (US); Koshi Gunjima, Toyohashi-city (JP); Michael David, Raleigh, NC (US); Franz Josef Braun, Durham, NC (US); Juergen Langewald, Mannheim (DE)

(73) Assignee: BASF SE, Ludwigshafen (DE)

(21) Appl. No.: 14/432,505

(22) PCT Filed: Sep. 27, 2013
(86) PCT No.: PCT/EP2013/070159

§ 371 Date: Mar. 31, 2015

Related U.S. Application Data
(60) Provisional application No. 61/708,059, filed on Oct. 1, 2012.
(60) Provisional application No. 61/763,970, filed on Feb. 13, 2013.
(60) Provisional application No. 61/847,586, filed on Jul. 18, 2013.

(51) Int. Cl. A01N 43/56; A01N 47/40; A01N 43/22; A01N 43/40; A01N 53/00; A01N 43/36; A01N 43/90; A01N 47/06; A01N 47/44

(52) U.S. Cl. CPC A01N 43/56; A01N 47/06; A01N 47/40; A01N 43/22; A01N 47/44; A01N 53/00; A01N 43/36; A01N 43/90; A01N 43/40

(57) ABSTRACT

The present invention relates to pesticidal mixtures comprising as active compounds
1) at least one pesticidally active anthranilamide compound of formula (I)

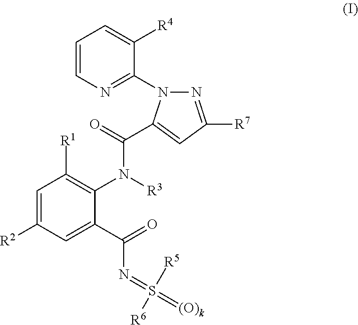

wherein R¹, R², R³, R⁴, R⁵, R⁶, R⁷ and k are as defined in the description;
and
2) at least one pesticidally active compound II selected from a group M comprising acteylcholine esterase inhibitors, GABA-gated chloride channel antagonists, sodium channel modulators, nicotinic acteylcholine receptor agonists/antagonists, allosteric nicotinic acetylcholine receptor activitaors, chloride channel activators, juvenile hormone mimics, homopteran feeding blockers, mit grow inhibitors, inhibitors of mitochondrial bATP synthase, uncouplers of the oxidative phosphorylation, inhibitors of the chitin biosynthesis, moulting disruptors, ecdyson receptor agonists, octamin receptor agonists, inhibitors of the MET, voltage-dependent sodium channel blockers, inhibitors of the lipid synthesis, ryanodine receptor modulators and other compounds as defined in the description, in synergistically effective amounts.

The invention relates further to methods and use of these mixtures for combating and controlling insects, acarids or nematodes in and on plants, and for protecting such plants being infested with pests, especially also for protecting plant propagation material, such as seeds.

The present invention relates to mixtures of active ingredients having synergistically enhanced action and to methods comprising applying said mixtures.

One typical problem arising in the field of pest control lies in the need to reduce the dosage rates of the active ingredient in order to reduce or avoid unfavorable environmental or toxicological effects whilst still allowing effective pest control.

Another problem encountered concerns the need to have available pest control agents which are effective against a broad spectrum of pests.

There also exists the need for pest control agents that combine knock-down activity with prolonged control, that is, fast action with long lasting action.

Another difficulty in relation to the use of pesticides is that the repeated and exclusive application of an individual pesticidal compound leads in many cases to a rapid selection of pests which have developed natural or adapted resistance against the active compound in question. Therefore there is a need for pest control agents that help prevent or overcome resistance induced by pesticides.

Furthermore, there is a desire for pesticide compounds or combination of compounds, which when applied improve plants, which may result in “plant health”, “vitality of plant propagation material” or “increased plant yield”.

It is therefore an object of the present invention to provide agricultural combinations which solves one or more than one of the discussed problems as
reducing the dosage rate,
enhancing the spectrum of activity,
combining knock-down activity with prolonged control,
improving resistance management,
Improved plant health;
Improved vitality of plant propagation material, also termed seed vitality;
Increased plant yield.

It was therefore an object of the present invention to provide pesticidal mixtures which solve at least one of the discussed problems as reducing the dosage rate, enhancing the spectrum of activity or combining knock-down activity with prolonged control or as to resistance management.

It has been found that this object is in part or in whole achieved by the combination of active compounds defined below.

The present invention relates to pesticidal mixtures comprising as active compounds
1) at least one pesticidally active anthranilamide compound of formula (I):

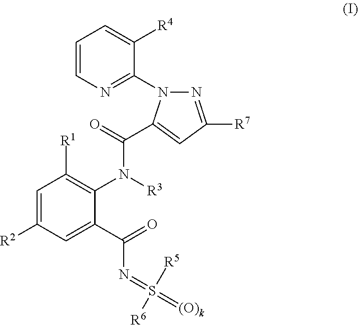

wherein
R¹ is selected from the group consisting of halogen, methyl and halomethyl;
R² is selected from the group consisting of hydrogen, halogen, halomethyl and cyano;
R³ is selected from hydrogen, C₁-C₆ alkyl, C₁-C₆ haloalkyl, C₂-C₆-alkenyl, C₂-C₆-haloalkenyl, C₂-C₆-alkinyl, C₂-C₆-haloalkinyl, C₃-C₈-cycloalkyl, C₃-C₈-halocycloalkyl, C₁-C₄-alkoxy-C₁-C₄-alkyl, C₁-C₄-haloalkoxy-C₁-C₄-alkyl,
   C(═O)R^{a}, C(═O)OR^{b} and C(═O)NR^{c}R^{d};
R⁴ is hydrogen or halogen;
R⁵, R⁶ are selected independently of one another from the group consisting of hydrogen, C₁-C₁₀-alkyl, C₃-C₈-cycloalkyl, C₂-C₁₀-alkenyl, C₂-C₁₀-alkynyl, wherein the aforementioned aliphatic and cycloaliphatic radicals may be substituted with 1 to 10 substituents R^{e}, and phenyl, which is unsubstituted or carries 1 to 5 substituents R^{f}; or
   R⁵ and R⁶ together represent a C₂-C₇-alkylene, C₂-C₇-alkenylene or C₆-C₉-alkynylene chain forming together with the sulfur atom to which they are attached a 3-, 4-, 5-, 6-, 7-, 8-, 9- or 10-membered saturated, partially unsaturated or fully unsaturated ring, wherein 1 to 4 of the CH₂ groups in the C₂-C₇-alkylene chain or 1 to 4 of any of the CH₂ or CH groups in the C₂-C₇-alkenylene chain or 1 to 4 of any of the CH₂ groups in the C₆-C₉-alkynylene chain may be replaced by 1 to 4 groups independently selected from the group consisting of C═O, C═S, O, S, N, NO, SO, SO₂ and NH, and wherein the carbon and/or nitrogen atoms in the C₂-C₇-alkylene, C₂-C₇-alkenylene or C₆-C₉-alkynylene chain may be substituted with 1 to 5 substituents independently selected from the group consisting of halogen, cyano, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₃-C₈-cycloalkyl, C₃-C₈-halocycloalkyl, C₂-C₆-alkenyl, C₂-C₆-haloalkenyl, C₂-C₆-alkynyl and C₂-C₆-haloalkynyl; said substituents being identical or different from one another if more than one substituent is present;
R⁷ is selected from the group consisting of bromo, chloro, difluoromethyl, trifluoromethyl, nitro, cyano, OCH₃, OCHF₂, OCH₂F, OCH₂CF₃, S(═O)ₙCH₃, and S(═O)ₙCF₃;
R^{a} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkylsulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄ alkoxy;
   phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy, (C₁-C₆-alkoxy)carbonyl, C₁-C₆-alkylamino and di-(C₁-C₆-alkyl)amino,
R^{b} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkylsulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄-alkoxy;
   phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy and (C₁-C₆-alkoxy)carbonyl;
R^{c}, R^{d} are, independently from one another and independently of each occurrence, selected from the group consisting of hydrogen, cyano, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄-alkoxy;
   C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, phenyl, benzyl, pyridyl and phenoxy, wherein the four last mentioned radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆ haloalkoxy and (C₁-C₆-alkoxy)carbonyl; or
   R^{c} and R^{d}, together with the nitrogen atom to which they are bound, may form a 3-, 4-, 5-, 6- or 7-membered saturated, partially unsaturated or fully unsaturated heterocyclic ring which may additionally contain 1 or 2 further heteroatoms or heteroatom groups selected from N, O, S, NO, SO and SO₂, as ring members, where the heterocyclic ring may optionally be substituted with halogen, C₁-C₄-haloalkyl, C₁-C₄-alkoxy or C₁-C₄-haloalkoxy;
R^{e} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
   C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, —C(═NR^{c})NR^{c}R^{d}, phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy and C₁-C₆-haloalkoxy; or
   two vicinal radicals R^{e} together form a group ═O, ═CH(C₁-C₄-alkyl), ═C(C₁-C₄-alkyl)C₁-C₄-alkyl, ═N(C₁-C₆-alkyl) or ═NO(C₁-C₆-alkyl);
R^{f} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
   C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, and —C(═NR^{c})NR^{c}R^{d};
k is 0 or 1;
n is 0, 1 or 2;
or a stereoisomer, salt, tautomer or N-oxide, or a polymorphic crystalline form, a co-crystal or a solvate of a compound or a stereoisomer, salt, tautomer or N-oxide thereof;
   and
2) at least one pesticidally active compound II selected from group M consisting of
II-M.1 Acetylcholine esterase (AChE) inhibitors from the class of
II-M.1A carbamates, including aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of
II-M.1B organophosphates, including acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;
II-M.2 GABA-gated chloride channel antagonists such as:
II-M.2A cyclodiene organochlorine compounds, including endosulfan or chlordane; or
II-M.2B fiproles (phenylpyrazoles), including ethiprole, fipronil, flufiprole, pyrafluprole and pyriprole;
II-M.3 Sodium channel modulators from the class of
II-M.3A pyrethroids, including acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or
II-M.3B sodium channel modulators such as DDT or methoxychlor;
II-M.4 Nicotinic acetylcholine receptor agonists (nAChR) from the class of
II-M.4A neonicotinoids, including acetamiprid, chlothianidin, dinotefuran, imidacloprid, nitenpyram, thiacloprid and thiamethoxam; or the compounds
II-M.4A.1: 1-[(6-chloro-3-pyridinyl)methyl]-2,3,5,6,7,8-hexahydro-9-nitro-(5S,8R)-5,8-Epoxy-1H-imidazo[1,2-a]azepine; or
II-M.4A.2: 1-[(6-chloro-3-pyridyl)methyl]-2-nitro-1-[(E)-pentylideneamino]guanidine; or
II-M4A.3: 1-[(6-chloro-3-pyridyl)methyl]-7-methyl-8-nitro-5-propoxy-3,5,6,7-tetrahydro-2H-imidazo[1,2-a]pyridine; or II-M.4B nicotine.
II-M.5 Nicotinic acetylcholine receptor allosteric activators from the class of spinosyns, including spinosad or spinetoram;
II-M.6 Chloride channel activators from the class of avermectins and milbemycins, including abamectin, emamectin benzoate, ivermectin, lepimectin or milbemectin;
II-M.7 Juvenile hormone mimics, such as
II-M.7A juvenile hormone analogues as hydroprene, kinoprene and methoprene; or others as
II-M.7B fenoxycarb, or
II-M.7C pyriproxyfen;
II-M.8 miscellaneous non-specific (multi-site) inhibitors, including
II-M.8A alkyl halides as methyl bromide and other alkyl halides, or
II-M.8B chloropicrin, or
II-M.8C sulfuryl fluoride, or
II-M.8D borax, or
II-M.8E tartar emetic;
II-M.9 Selective homopteran feeding blockers, including
II-M.9B pymetrozine, or
II-M.9C flonicamid;
II-M.10 Mite growth inhibitors, including
II-M.10A clofentezine, hexythiazox and diflovidazin, or
II-M.10B etoxazole;
II-M.11 Microbial disruptors of insect midgut membranes, including bacillus thuringiensis or bacillus sphaericus and the insecticdal proteins they produce such as bacillus thuringiensis subsp. israelensis, bacillus sphaericus, bacillus thuringiensis subsp. aizawai, bacillus thuringiensis subsp. kurstaki and bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;
II-M.12 Inhibitors of mitochondrial ATP synthase, including
II-M.12A diafenthiuron, or
II-M.12B organotin miticides such as azocyclotin, cyhexatin or fenbutatin oxide, or
II-M.12C propargite, or
II-M.12D tetradifon;
II-M.13 Uncouplers of oxidative phosphorylation via disruption of the proton gradient, including chlorfenapyr, DNOC or sulfluramid;
II-M.14 Nicotinic acetylcholine receptor (nAChR) channel blockers, including

nereistoxin analogues as bensultap, cartap hydrochloride, thiocyclam or thiosultap sodium;
II-M.15 Inhibitors of the chitin biosynthesis type 0, such as benzoylure including bistrifluron, chlorfluazuron, diflubenzuron, flucycloxuron, flufenoxuron, hexaflumuron, lufenuron, novaluron, noviflumuron, teflubenzuron or triflumuron;
II-M.16 Inhibitors of the chitin biosynthesis type 1, including buprofezin;
II-M.17 Moulting disruptors, Dipteran, including cyromazine;
II-M.18 Ecdyson receptor agonists such as diacylhydrazines, including methoxyfenozide, tebufenozide, halofenozide, fufenozide or chromafenozide;
II-M.19 Octopamin receptor agonists, including amitraz;
II-M.20 Mitochondrial complex III electron transport inhibitors, including
II-M.20A hydramethylnon, or
II-M.20B acequinocyl, or
II-M.20C fluacrypyrim;
II-M.21 Mitochondrial complex I electron transport inhibitors, including
II-M.21A METI acaricides and insecticides such as fenazaquin, fenpyroximate, pyrimidifen, pyridaben, tebufenpyrad or tolfenpyrad, or
II-M.21B rotenone;
II-M.22 Voltage-dependent sodium channel blockers, including
II-M.22A indoxacarb, or
II-M.22B metaflumizone; or
II-M.22C 1-[(E)-[2-(4-cyanophenyl)-1-[3-(trifluoromethyl)phenyl]ethylidene]amino]-3-[4-(difluoromethoxy)phenyl]urea;
II-M.23 Inhibitors of the acetyl CoA carboxylase, including Tetronic and Tetramic acid derivatives, including spirodiclofen, spiromesifen or spirotetramat;
II-M.24 Mitochondrial complex IV electron transport inhibitors, including
II-M.24A phosphine such as aluminium phosphide, calcium phosphide, phosphine or zinc phosphide, or
II-M.24B cyanide.
II-M.25 Mitochondrial complex II electron transport inhibitors, such as beta-ketonitrile derivatives, including cyenopyrafen or cyflumetofen;
II-M.26 Ryanodine receptor-modulators from the class of diamides, including flubendiamide, chlorantraniliprole (Rynaxypyr®), cyantraniliprole (Cyazypyr®), or
   the phthalamide compounds
II-M.26.1: (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and
II-M.26.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, or the compound
II-M.26.3: 3-bromo-N-{2-bromo-4-chloro-6-[(1-cyclopropylethyl)carbamoyl]phenyl}-1-(3-chlorpyridin-2-yl)-1H-pyrazole-5-carboxamide (proposed ISO name: cyclaniliprole), or the compound
II-M.26.4: methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate; or a compound selected from II-M.26.5a) to II-M.26.5d):
II-M.26.5a: N-[2-(5-amino-1,3,4-thiadiazol-2-yl)-4-chloro-6-methyl-phenyl]-5-bromo-2-(3-chloro-2-pyridyl)pyrazole-3-carboxamide;
II-M.26.5b: 5-chloro-2-(3-chloro-2-pyridyl)-N-[2,4-dichloro-6-[(1-cyano-1-methyl-ethyl)carbamoyl]phenyl]pyrazole-3-carboxamide;
II-M.26.5c: 5-bromo-N-[2,4-dichloro-6-(methylcarbamoyl)phenyl]-2-(3,5-dichloro-2-pyridyl)pyrazole-3-carboxamide;
II-M.26.5d: N-[2-(tert-butylcarbamoyl)-4-chloro-6-methyl-phenyl]-2-(3-chloro-2-pyridyl)-5-(fluoromethoxy)pyrazole-3-carboxamide; or
II-M.26.6: N2-(1-cyano-1-methyl-ethyl)-N1-(2,4-dimethylphenyl)-3-iodo-phthalamide; or
II-M.26.7: 3-chloro-N2-(1-cyano-1-methyl-ethyl)-N1-(2,4-dimethylphenyl)phthalamide;
II-M.X insecticidal active compounds of unknown or uncertain mode of action, including afidopyropen, azadirachtin, amidoflumet, benzoximate, bifenazate, bromopropylate, chinomethionat, cryolite, dicofol, flufenerim, flometoquin, fluensulfone, flupyradifurone, piperonyl butoxide, pyridalyl, pyrifluquinazon, sulfoxaflor, pyflubumide, or the compounds
II-M.X.1: 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide, or the compound
II-M.X.2: cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a, 12b-trimethyl-11-oxo-9-(3-pyridinyl)-2H,11H-naphtho[2,1-b]pyrano[3,4-e]pyran-3,6-diyl]ester, or the compound
II-M.X.3: 11-(4-chloro-2,6-dimethylphenyl)-12-hydroxy-1,4-dioxa-9-azadispiro[4.2.4.2]-tetradec-11-en-10-one, or the compound
II-M.X.4 3-(4′-fluoro-2,4-dimethylbiphenyl-3-yl)-4-hydroxy-8-oxa-1-azaspiro[4.5]dec-3-en-2-one, or the compound
II-M.X.5: 1-[2-fluoro-4-methyl-5-[(2,2,2-trifluoroethyl)sufinyl]phenyl]-3-(trifluoromethyl)-1H-1,2,4-triazole-5-amine, or actives on basis of bacillus firmus (Votivo, I-1582), or
II-M.X.6: a compound selected from the group of
II-M.X.6a: (E/Z)—N-[1-[(6-chloro-3-pyridyl)methyl]-2-pyridylidene]-2,2,2-trifluoro-acetamide;
II-M.X.6b: (E/Z)—N-[1-[(6-chloro-5-fluoro-3-pyridyl)methyl]-2-pyridylidene]-2,2,2-trifluoro-acetamide;
II-M.X.6c: (E/Z)-2,2,2-trifluoro-N-[1-[(6-fluoro-3-pyridyl)methyl]-2-pyridylidene]acetamide;
II-M.X.6d: (E/Z)—N-[1-[(6-bromo-3-pyridyl)methyl]-2-pyridylidene]-2,2,2-trifluoro-acetamide;
II-M.X.6e: (E/Z)—N-[1-[1-(6-chloro-3-pyridyl)ethyl]-2-pyridylidene]-2,2,2-trifluoro-acetamide;
II-M.X.6f: (E/Z)—N-[1-[(6-chloro-3-pyridyl)methyl]-2-pyridylidene]-2,2-difluoro-acetamide;
II-M.X.6g: (E/Z)-2-chloro-N-[1-[(6-chloro-3-pyridyl)methyl]-2-pyridylidene]-2,2-difluoro-acetamide;
II-M.X.6h: (E/Z)—N-[1-[(2-chloropyrimidin-5-yl)methyl]-2-pyridylidene]-2,2,2-trifluoro-acetamide and II-M.X.6i: (E/Z)—N-[1-[(6-chloro-3-pyridyl)methyl]-2-pyridylidene]-2,2,3,3,3-pentafluoro-propanamide); or
II-M.X.7: triflumezopyrim; or
II-M.X.8: 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, or
II-M.X.9: 3-[3-chloro-5-(trifluoromethyl)phenyl]-4-oxo-1-(pyrimidin-5-ylmethyl)pyrido[1,2-a]pyrimidin-1-ium-2-olate; or
II-M.X.10: 8-chloro-N-[2-chloro-5-methoxyphenyl)sulfonyl]-6-trifluoromethyl)-imidazo[1,2-a]pyridine-2-carboxamide; or
II-M.X.11: 4-[5-(3,5-dichlorophenyl)-5-(trifluoromethyl)-4H-isoxazol-3-yl]-2-methyl-N-(1-oxothietan-3-yl)benzamide; or
II-M.X.12: 5-[3-[2,6-dichloro-4-(3,3-dichloroallyloxyl)phenoxy]propoxy]-1H-pyrazole; or
II-M.Y Biopesticides, e.g.
II-M.Y-1: Microbial pesticides with insecticidal, acaricidal, molluscidal and/or nematicidal activity: Bacillus firmus, B. thuringiensis ssp. israelensis, B. t. ssp. galleriae, B. t. ssp. kurstaki, Beauveria bassiana, Burkholderia sp., Chromobacterium subtsugae, Cydia pomonella granulosis virus, Isaria fumosorosea, Lecanicillium longisporum, L. muscarium (formerly Verticillium lecanii), Metarhizium anisopliae, M. anisopliae var. acridum, Paecilomyces fumosoroseus, P. lilacinus, Paenibacillus poppiliae, Pasteuria spp., P. nishizawae, P. reneformis, P. usagae, Pseudomonas fluorescens, Steinernema feltiae, Streptomces galbus;
II-M.Y-2) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Quillay extract, Tagetes oil;
   in synergistically effective amounts.

Moreover, it has been found that simultaneous, that is joint or separate, application of one or more active compound(s) I and one or more compound(s) II or successive application (that is immediately one after another and thereby creating the mixture “in-situ” on the desired location, as e.g. the plant) of one or more active compound(s) I and one or more active compound(s) II allows enhanced control of pests compared to the control rates that are possible with the individual compounds.

Therefore, the term “mixture” as used herein is intended to include also combinations.

The present invention also provides methods for the control of insects, acarids or nematodes comprising contacting the insect, acarid or nematode or their food supply, habitat, breeding grounds or their locus with a pesticidally effective amount of mixtures of at least one active compound I with at least one active compound II.

Moreover, the present invention also relates to a method of protecting plants from attack or infestation by insects, acarids or nematodes comprising contacting the plant, or the soil or water in which the plant is growing, with a pesticidally effective amount of a mixture of at least one active compound I with at least one active compound II.

The invention also provides a method for the protection of plant propagation material, preferably seeds, from soil insects and of the seedlings' roots and shoots from soil and foliar insects which comprises contacting the plant progagation material as e.g. the seeds before sowing and/or after pregermination with a pesticidally effective amount of a mixture of at least one active compound I with at least one active compound II.

The invention also provides seeds comprising a mixture of at least one active compound I with at least one active compound II.

The invention also provides pesticidal compositions, comprising a liquid or solid carrier and a mixture of at least one active compound I with at least one active compound II.

The invention also relates to the use of a mixture of at least one active compound I with at least one active compound II for combating insects, arachnids or nematodes.

The mixture(s) of at least one active compound of formula (I) with at least one active compound II are herein referred to as “mixture(s) according to the invention”.

In a specific embodiment, the mixture according to the invention is a mixture of one active compound of formula (I) with one active compound II (binary mixture).

In another embodiment, the mixture according to the invention is a mixture of one active compound of formula (I) with at least one active compound II.

In another embodiment, the mixture according to the invention is a mixture of one active compound of formula (I) with two active compounds II, or with one active compound II and a further active compound, e.g. selected from group F, as described herein (ternary mixture).

In another embodiment, the mixture according to the invention is a mixture of one active compound of formula (I) with three active compounds II, or with three active compounds selected from group M and group F, wherein at least one compound is selected from group M (4-way mixture).

In another embodiment, the mixture according to the invention is a mixture of one active compound of formula (I) with four active compounds II or compounds selected from group M and group F, wherein at least one compound is selected from group M (5-way mixture).

### Compounds of Formula I

WO 2007/006670, describes N-thio-anthranilamide compounds with a sulfilimine or sulfoximine group and their use as pesticides. PCT/EP2012/065650, PCT/EP2012/065651, and the unpublished applications U.S. 61/578,267, U.S. 61/593,897 and U.S. 61/651,050 describe certain N-Thio-anthranilamide compounds and their use as pesticides.

PCT/EP2012/065648, PCT/EP2012/065649 and EP11189973.8 describe processes for the synthesis of N-Thio-anthranilamide compounds.

The prior art does not disclose pesticidal mixtures comprising selective anthranilamide compounds according to the present invention showing unexpected and synergistic effects in combination with other pesticidically active compounds.

The compounds of formula I as well as the terms “compounds for methods according to the (present) invention”, “compounds according to the (present) invention” or “compounds of formula (I)” or “compound(s) II”, which all compound(s) are applied in methods and uses according to the present invention comprise the compound(s) as defined herein as well as a known stereoisomer, salt, tautomer or N-oxide thereof.

The term “composition(s) according to the invention” or “composition(s) of the present invention” encompasses composition(s) comprising at least one compound of formula I or mixtures of the compounds of formula I with other pesticidally active compound(s) II for being used and/or applied in methods according to the invention as defined above.

Depending on the substitution pattern, the compounds of the formula (I) may have one or more centers of chirality, in which case they are present as mixtures of enantiomers or diastereomers. The invention provides both the pure enantiomers or pure diastereomers of the compounds of formula (I), and their mixtures and the use according to the invention of the pure enantiomers or pure diastereomers of the compound of formula (I) or its mixtures. Suitable compounds of the formula (I) also include all possible geometrical stereoisomers (cis/trans isomers) and mixtures thereof. Cis/trans isomers may be present with respect to an alkene, carbon-nitrogen double-bond, nitrogen-sulfur double bond or amide group. The term “stereoisomer(s)” encompasses both optical isomers, such as enantiomers or diastereomers, the latter existing due to more than one center of chirality in the molecule, as well as geometrical isomers (cis/trans isomers).

Salts of the compounds of the present invention are preferably agriculturally and veterinarily acceptable salts. They can be formed in a customary method, e.g. by reacting the compound with an acid if the compound of the present invention has a basic functionality or by reacting the compound with a suitable base if the compound of the present invention has an acidic functionality.

In general, suitable “agriculturally useful salts” or “agriculturally acceptable salts” are especially the salts of those cations or the acid addition salts of those acids whose cations and anions, respectively, do not have any adverse effect on the action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxyl)ethyl-ammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formate, acetate, propionate and butyrate. They can be formed by reacting the compounds of the formulae I with an acid of the corresponding anion, preferably of hydrochloric acid, hydrobromic acid, sulfuric acid, phosphoric acid or nitric acid.

The compounds of the formula (I) may be present in the form of their N-oxides. The term “N-oxide” includes any compound of the present invention which has at least one tertiary nitrogen atom that is oxidized to an N-oxide moiety. N-oxides of compounds (I) can in particular be prepared by oxidizing the ring nitrogen atom(s) of the pyridine ring and/or the pyrazole ring with a suitable oxidizing agent, such as peroxo carboxylic acids or other peroxides. The person skilled in the art knows if and in which positions compounds of the formula (I) of the present invention may form N-oxides.

The compounds of the present invention may be amorphous or may exist in one ore more different crystalline states (polymorphs) which may have different macroscopic properties such as stability or show different biological properties such as activities. The present invention includes both amorphous and crystalline compounds of formula (I), their enantiomers or diastereomers, mixtures of different crystalline states of the respective compound of formula (I), its enantiomers or diastereomers, as well as amorphous or crystalline salts thereof.

The term “co-crystal” denotes a complex of the compounds according to the invention or a stereoisomer, salt, tautomer or N-oxide thereof, with one or more other molecules (preferably one molecule type), wherein usually the ratio of the compound according to the invention and the other molecule is a stoichiometric ratio.

The term “solvate” denotes a co-complex of the compounds according to the invention, or a stereoisomer, salt, tautomer or N-oxide thereof, with solvent molecules. The solvent is usually liquid. Examples of solvents are methanol, ethanol, toluol, xylol. A preferred solvent which forms solvates is water, which solvates are referred to as “hydrates”. A solvate or hydrate is usually characterized by the presence of a fixed number of n molecules solvent per m molecules compound according to the invention.

The organic moieties mentioned in the above definitions of the variables are—like the term halogen—collective terms for individual listings of the individual group members. The prefix Cₙ-Cₘ indicates in each case the possible number of carbon atoms in the group.

The term halogen denotes in each case fluorine, bromine, chlorine or iodine, in particular fluorine, chlorine or bromine.

The term “partially or fully halogenated” will be taken to mean that 1 or more, e.g. 1, 2, 3, 4 or 5 or all of the hydrogen atoms of a given radical have been replaced by a halogen atom, in particular by fluorine or chlorine. A partially or fully halogenated radical is termed below also “halo-radical”. For example, partially or fully halogenated alkyl is also termed haloalkyl.

The term “alkyl” as used herein (and in the alkyl moieties of other groups comprising an alkyl group, e.g. alkoxy, alkylcarbonyl, alkylthio, alkylsulfinyl, alkylsulfonyl and alkoxyalkyl) denotes in each case a straight-chain or branched alkyl group having usually from 1 to 12 or 1 to 10 carbon atoms, frequently from 1 to 6 carbon atoms, preferably 1 to 4 carbon atoms and in particular from 1 to 3 carbon atoms. Examples of C₁-C₄-alkyl are methyl, ethyl, n-propyl, isopropyl, n-butyl, 2-butyl(sec-butyl), isobutyl and tert-butyl. Examples for C₁-C₆-alkyl are, apart those mentioned for C₁-C₄-alkyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl. Examples for C₁-C₁₀-alkyl are, apart those mentioned for C₁-C₆-alkyl, n-heptyl, 1-methylhexyl, 2-methylhexyl, 3-methylhexyl, 4-methylhexyl, 5-methylhexyl, 1-ethylpentyl, 2-ethylpentyl, 3-ethylpentyl, n-octyl, 1-methyloctyl, 2-methylheptyl, 1-ethylhexyl, 2-ethylhexyl, 1,2-dimethylhexyl, 1-propylpentyl, 2-propylpentyl, nonyl, decyl, 2-propylheptyl and 3-propylheptyl.

The term “alkylene” (or alkanediyl) as used herein in each case denotes an alkyl radical as defined above, wherein one hydrogen atom at any position of the carbon backbone is replaced by one further binding site, thus forming a bivalent moiety.

The term “haloalkyl” as used herein (and in the haloalkyl moieties of other groups comprising a haloalkyl group, e.g. haloalkoxy, haloalkylthio, haloalkylcarbonyl, haloalkylsulfonyl and haloalkylsulfinyl) denotes in each case a straight-chain or branched alkyl group having usually from 1 to 10 carbon atoms (“C₁-C₁₀-haloalkyl”), frequently from 1 to 6 carbon atoms (“C₁-C₆-haloalkyl”), more frequently 1 to 4 carbon atoms (“C₁-C₁₀-haloalkyl”), wherein the hydrogen atoms of this group are partially or totally replaced with halogen atoms. Preferred haloalkyl moieties are selected from C₁-C₄-haloalkyl, more preferably from C₁-C₂-haloalkyl, more preferably from halomethyl, in particular from C₁-C₂-fluoroalkyl. Halomethyl is methyl in which 1, 2 or 3 of the hydrogen atoms are replaced by halogen atoms. Examples are bromomethyl, chloromethyl, dichloromethyl, trichloromethyl, fluoromethyl, difluoromethyl, trifluoromethyl, chlorofluoromethyl, dichlorofluoromethyl, chlorodifluoromethyl and the like. Examples for C₁-C₂-fluoroalkyl are fluoromethyl, difluoromethyl, trifluoromethyl, 1-fluoroethyl, 2-fluoroethyl, 2,2-difluoroethyl, 2,2,2-trifluoroethyl, pentafluoroethyl, and the like. Examples for C₁-C₂-haloalkyl are, apart those mentioned for C₁-C₂-fluoroalkyl, chloromethyl, dichloromethyl, trichloromethyl, bromomethyl, chlorofluoromethyl, dichlorofluoromethyl, chlorodifluoromethyl, 1-chloroethyl, 2-chloroethyl, 2,2,-dichloroethyl, 2,2,2-trichloroethyl, 2-chloro-2-fluoroethyl, 2-chloro-2,2-difluoroethyl, 2,2-dichloro-2-fluoroethyl, 1-bromoethyl, and the like. Examples for C₁-C₄-haloalkyl are, apart those mentioned for C₁-C₂-haloalkyl, 1-fluoropropyl, 2-fluoropropyl, 3-fluoropropyl, 3,3-difluoropropyl, 3,3,3-trifluoropropyl, heptafluoropropyl, 1,1,1-trifluoroprop-2-yl, 3-chloropropyl, 4-chlorobutyl and the like.

The term “cycloalkyl” as used herein (and in the cycloalkyl moieties of other groups comprising a cycloalkyl group, e.g. cycloalkoxy and cycloalkylalkyl) denotes in each case a mono- or bicyclic cycloaliphatic radical having usually from 3 to 10 carbon atoms (“C₃-C₁₀-cycloalkyl”), preferably 3 to 8 carbon atoms (“C₃-C₈-cycloalkyl”) or in particular 3 to 6 carbon atoms (“C₃-C₆-cycloalkyl”). Examples of monocyclic radicals having 3 to 6 carbon atoms comprise cyclopropyl, cyclobutyl, cyclopentyl and cyclohexyl. Examples of monocyclic radicals having 3 to 8 carbon atoms comprise cyclopropyl, cyclobutyl, cyclopentyl, cyclohexyl, cycloheptyl and cyclooctyl.

Examples of bicyclic radicals having 7 or 8 carbon atoms comprise bicyclo[2.1.1]hexyl, bicyclo[2.2.1]heptyl, bicyclo[3.1.1]heptyl, bicyclo[2.2.1]heptyl, bicyclo[2.2.2]octyl and bicyclo[3.2.1]octyl.

The term “cycloalkylene” (or cycloalkanediyl) as used herein in each case denotes an cycloalkyl radical as defined above, wherein one hydrogen atom at any position of the carbon backbone is replaced by one further binding site, thus forming a bivalent moiety.

The term “halocycloalkyl” as used herein (and in the halocycloalkyl moieties of other groups comprising an halocycloalkyl group, e.g. halocycloalkylmethyl) denotes in each case a mono- or bicyclic cycloaliphatic radical having usually from 3 to 10 carbon atoms, preferably 3 to 8 carbon atoms or in particular 3 to 6 carbon atoms, wherein at least one, e.g. 1, 2, 3, 4 or 5 of the hydrogen atoms are replaced by halogen, in particular by fluorine or chlorine. Examples are 1- and 2-fluorocyclopropyl, 1,2-, 2,2- and 2,3-difluorocyclopropyl, 1,2,2-trifluorocyclopropyl, 2,2,3,3-tetrafluorocyclpropyl, 1- and 2-chlorocyclopropyl, 1,2-, 2,2- and 2,3-dichlorocyclopropyl, 1,2,2-trichlorocyclopropyl, 2,2,3,3-tetrachlorocyclpropyl, 1-,2- and 3-fluorocyclopentyl, 1,2-, 2,2-, 2,3-, 3,3-, 3,4-, 2,5-difluorocyclopentyl, 1-,2- and 3-chlorocyclopentyl, 1,2-, 2,2-, 2,3-, 3,3-, 3,4-, 2,5-dichlorocyclopentyl and the like.

The term “cycloalkyl-alkyl” used herein denotes a cycloalkyl group, as defined above, which is bound to the remainder of the molecule via an alkylene group. The term “C₃-C₈-cycloalkyl-C₁-C₄-alkyl” refers to a C₃-C₈-cycloalkyl group as defined above which is bound to the remainder of the molecule via a C₁-C₄-alkyl group, as defined above. Examples are cyclopropylmethyl, cyclopropylethyl, cyclopropylpropyl, cyclobutylmethyl, cyclobutylethyl, cyclobutylpropyl, cyclopentylmethyl, cyclopentylethyl, cyclopentylpropyl, cyclohexylmethyl, cyclohexylethyl, cyclohexylpropyl, and the like.

The term “alkenyl” as used herein denotes in each case a monounsaturated straight-chain or branched hydrocarbon radical having usually 2 to 10 (“C₂-C₁₀-alkenyl”), preferably 2 to 6 carbon atoms (“C₂-C₆-alkenyl”), in particular 2 to 4 carbon atoms (“C₂-C₄-alkenyl”), and a double bond in any position, for example C₂-C₄-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl or 2-methyl-2-propenyl; C₂-C₆-alkenyl, such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl and the like, or C₂-C₁₀-alkenyl, such as the radicals mentioned for C₂-C₆-alkenyl and additionally 1-heptenyl, 2-heptenyl, 3-heptenyl, 1-octenyl, 2-octenyl, 3-octenyl, 4-octenyl, 1-nonenyl, 2-nonenyl, 3-nonenyl, 4-nonenyl, 1-decenyl, 2-decenyl, 3-decenyl, 4-decenyl, 5-decenyl and the positional isomers thereof.

The term “alkenylene” (or alkenediyl) as used herein in each case denotes an alkenyl radical as defined above, wherein one hydrogen atom at any position of the carbon backbone is replaced by one further binding site, thus forming a bivalent moiety.

The term “haloalkenyl” as used herein, which may also be expressed as “alkenyl which may be substituted by halogen”, and the haloalkenyl moieties in haloalkenyloxy, haloalkenylcarbonyl and the like refers to unsaturated straight-chain or branched hydrocarbon radicals having 2 to 10 (“C₂-C₁₀-haloalkenyl”) or 2 to 6 (“C₂-C₆-haloalkenyl”) or 2 to 4 (“C₂-C₄-haloalkenyl”) carbon atoms and a double bond in any position, where some or all of the hydrogen atoms in these groups are replaced by halogen atoms as mentioned above, in particular fluorine, chlorine and bromine, for example chlorovinyl, chloroallyl and the like.

The term “alkynyl” as used herein denotes unsaturated straight-chain or branched hydrocarbon radicals having usually 2 to 10 (“C₂-C₁₀-alkynyl”), frequently 2 to 6 (“C₂-C₆-alkynyl”), preferably 2 to 4 carbon atoms (“C₂-C₄-alkynyl”) and one or two triple bonds in any position, for example C₂-C₄-alkynyl, such as ethynyl, 1-propynyl, 2-propynyl, 1-butynyl, 2-butynyl, 3-butynyl, 1-methyl-2-propynyl and the like, C₂-C₆-alkynyl, such as ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, 1-ethyl-1-methyl-2-propynyl and the like.

The term “alkynylene” (or alkynediyl) as used herein in each case denotes an alkynyl radical as defined above, wherein one hydrogen atom at any position of the carbon backbone is replaced by one further binding site, thus forming a bivalent moiety.

The term “haloalkynyl” as used herein, which is also expressed as “alkynyl which may be substituted by halogen”, refers to unsaturated straight-chain or branched hydrocarbon radicals having usually 3 to 10 carbon atoms (“C₂-C₁₀-haloalkynyl”), frequently 2 to 6 (“C₂-C₆-haloalkynyl”), preferably 2 to 4 carbon atoms (“C₂-C₄-haloalkynyl”), and one or two triple bonds in any position (as mentioned above), where some or all of the hydrogen atoms in these groups are replaced by halogen atoms as mentioned above, in particular fluorine, chlorine and bromine.

The term “alkoxy” as used herein denotes in each case a straight-chain or branched alkyl group usually having from 1 to 10 carbon atoms (“C₁-C₁₀-alkoxy”), frequently from 1 to 6 carbon atoms (“C₁-C₆-alkoxy”), preferably 1 to 4 carbon atoms (“C₁-C₄-alkoxy”), which is bound to the remainder of the molecule via an oxygen atom. C₁-C₂-Alkoxy is methoxy or ethoxy. C₁-C₄-Alkoxy is additionally, for example, n-propoxy, 1-methylethoxy(isopropoxy), butoxy, 1-methylpropoxy(sec-butoxy), 2-methylpropoxy(isobutoxy) or 1,1-dimethylethoxy(tert-butoxy). C₁-C₆-Alkoxy is additionally, for example, pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy or 1-ethyl-2-methylpropoxy. C₁-C₈-Alkoxy is additionally, for example, heptyloxy, octyloxy, 2-ethylhexyloxy and positional isomers thereof. C₁-C₁₀-Alkoxy is additionally, for example, nonyloxy, decyloxy and positional isomers thereof.

The term “haloalkoxy” as used herein denotes in each case a straight-chain or branched alkoxy group, as defined above, having from 1 to 10 carbon atoms (“C₁-C₁₀-haloalkoxy”), frequently from 1 to 6 carbon atoms (“C₁-C₆-haloalkoxy”), preferably 1 to 4 carbon atoms (“C₁-C₄-haloalkoxy”), more preferably 1 to 3 carbon atoms (“C₁-C₃-haloalkoxy”), wherein the hydrogen atoms of this group are partially or totally replaced with halogen atoms, in particular fluorine atoms. C₁-C₂-Haloalkoxy is, for example, OCH₂F, OCHF₂, OCF₃, OCH₂Cl, OCHCl₂, OCCl₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy or OC₂F5. C₁-C₄-Haloalkoxy is additionally, for example, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, OCH₂—C₂F5, OCF₂—C₂F₅, 1-(CH₂F)-2-fluoroethoxy, 1-(CH₂Cl)-2-chloroethoxy, 1-(CH₂Br)-2-bromoethoxy, 4-fluorobutoxy, 4-chlorobutoxy, 4-bromobutoxy or nonafluorobutoxy. C₁-C₆-Haloalkoxy is additionally, for example, 5-fluoropentoxy, 5-chloropentoxy, 5-brompentoxy, 5-iodopentoxy, undecafluoropentoxy, 6-fluorohexoxy, 6-chlorohexoxy, 6-bromohexoxy, 6-iodohexoxy or dodecafluorohexoxy.

The term “alkoxyalkyl” as used herein denotes in each case alkyl usually comprising 1 to 6 carbon atoms, preferably 1 to 4 carbon atoms, wherein 1 carbon atom carries an alkoxy radical usually comprising 1 to 10, frequently 1 to 6, in particular 1 to 4, carbon atoms as defined above. “C₁-C₆-Alkoxy-C₁-C₆-alkyl” is a C₁-C₆-alkyl group, as defined above, in which one hydrogen atom is replaced by a C₁-C₆-alkoxy group, as defined above. Examples are CH₂OCH₃, CH₂—OC₂H₅, n-propoxymethyl, CH₂—OCH(CH₃)₂, n-butoxymethyl, (1-methylpropoxy)-methyl, (2-methylpropoxy)methyl, CH₂—OC(CH₃)₃, 2-(methoxy)ethyl, 2-(ethoxy)ethyl, 2-(n-propoxy)-ethyl, 2-(1-methylethoxy)-ethyl, 2-(n-butoxy)ethyl, 2-(1-methylpropoxy)-ethyl, 2-(2-methylpropoxy)-ethyl, 2-(1,1-dimethylethoxy)-ethyl, 2-(methoxy)-propyl, 2-(ethoxy)-propyl, 2-(n-propoxy)-propyl, 2-(1-methylethoxy)-propyl, 2-(n-butoxy)-propyl, 2-(1-methylpropoxy)-propyl, 2-(2-methylpropoxy)-propyl, 2-(1,1-dimethylethoxy)-propyl, 3-(methoxy)-propyl, 3-(ethoxy)-propyl, 3-(n-propoxy)-propyl, 3-(1-methylethoxy)-propyl, 3-(n-butoxy)-propyl, 3-(1-methylpropoxy)-propyl, 3-(2-methylpropoxy)-propyl, 3-(1,1-dimethylethoxy)-propyl, 2-(methoxy)-butyl, 2-(ethoxy)-butyl, 2-(n-propoxy)-butyl, 2-(1-methylethoxy)-butyl, 2-(n-butoxy)-butyl, 2-(1-methylpropoxy)-butyl, 2-(2-methyl-propoxy)-butyl, 2-(1,1-dimethylethoxy)-butyl, 3-(methoxy)-butyl, 3-(ethoxy)-butyl, 3-(n-propoxy)-butyl, 3-(1-methylethoxy)-butyl, 3-(n-butoxy)-butyl, 3-(1-methylpropoxy)-butyl, 3-(2-methylpropoxy)-butyl, 3-(1,1-dimethylethoxy)-butyl, 4-(methoxy)-butyl, 4-(ethoxy)-butyl, 4-(n-propoxy)-butyl, 4-(1-methylethoxy)-butyl, 4-(n-butoxy)-butyl, 4-(1-methylpropoxy)-butyl, 4-(2-methylpropoxy)-butyl, 4-(1,1-dimethylethoxy)-butyl and the like.

The term “haloalkoxy-alkyl” as used herein denotes in each case alkyl as defined above, usually comprising 1 to 6 carbon atoms, preferably 1 to 4 carbon atoms, wherein 1 carbon atom carries an haloalkoxy radical as defined above, usually comprising 1 to 10, frequently 1 to 6, in particular 1 to 4, carbon atoms as defined above. Examples are fluoromethoxymethyl, difluoromethoxymethyl, trifluoromethoxymethyl, 1-fluoroethoxymethyl, 2-fluoroethoxymethyl, 1,1-difluoroethoxymethyl, 1,2-difluoroethoxymethyl, 2,2-difluoroethoxymethyl, 1,1,2-trifluoroethoxymethyl, 1,2,2-trifluoroethoxymethyl, 2,2,2-trifluoroethoxymethyl, pentafluoroethoxymethyl, 1-fluoroethoxy-1-ethyl, 2-fluoroethoxy-1-ethyl, 1,1-difluoroethoxy-1-ethyl, 1,2-difluoroethoxy-1-ethyl, 2,2-difluoroethoxy-1-ethyl, 1,1,2-trifluoroethoxy-1-ethyl, 1,2,2-trifluoroethoxy-1-ethyl, 2,2,2-trifluoroethoxy-1-ethyl, pentafluoroethoxy-1-ethyl, 1-fluoroethoxy-2-ethyl, 2-fluoroethoxy-2-ethyl, 1,1-difluoroethoxy-2-ethyl, 1,2-difluoroethoxy-2-ethyl, 2,2-difluoroethoxy-2-ethyl, 1,1,2-trifluoroethoxy-2-ethyl, 1,2,2-trifluoroethoxy-2-ethyl, 2,2,2-trifluoroethoxy-2-ethyl, pentafluoroethoxy-2-ethyl, and the like.

The term “alkylthio” (also alkylsulfanyl or alkyl-S—)” as used herein denotes in each case a straight-chain or branched saturated alkyl group as defined above, usually comprising 1 to 10 carbon atoms (“C₁-C₁₀-alkylthio”), frequently comprising 1 to 6 carbon atoms (“C₁-C₆-alkylthio”), preferably 1 to 4 carbon atoms (“C₁-C₄-alkylthio”), which is attached via a sulfur atom at any position in the alkyl group. C₁-C₂-Alkylthio is methylthio or ethylthio. C₁-C₄-Alkylthio is additionally, for example, n-propylthio, 1-methylethylthio(isopropylthio), butylthio, 1-methylpropylthio(sec-butylthio), 2-methylpropylthio(isobutylthio) or 1,1-dimethylethylthio(tertbutylthio). C₁-C₆-Alkylthio is additionally, for example, pentylthio, 1-methylbutylthio, 2-methylbutylthio, 3-methylbutylthio, 1,1-dimethylpropylthio, 1,2-dimethylpropylthio, 2,2-dimethylpropylthio, 1-ethylpropylthio, hexylthio, 1-methylpentylthio, 2-methylpentylthio, 3-methylpentylthio, 4-methylpentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio or 1-ethyl-2-methylpropylthio. C₁-C₈-Alkylthio is additionally, for example, heptylthio, octylthio, 2-ethylhexylthio and positional isomers thereof. C₁-C₁₀-Alkylthio is additionally, for example, nonylthio, decylthio and positional isomers thereof.

The term “haloalkylthio” as used herein refers to an alkylthio group as defined above wherein the hydrogen atoms are partially or fully substituted by fluorine, chlorine, bromine and/or iodine. C₁-C₂-Haloalkylthio is, for example, SCH₂F, SCHF₂, SCF₃, SCH₂Cl, SCHC₂, SCCl₃, chlorofluoromethylthio, dichlorofluoromethylthio, chlorodifluoromethylthio, 2-fluoroethylthio, 2-chloroethylthio, 2-bromoethylthio, 2-iodoethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio or SC₂F5. C₁-C₄-Haloalkylthio is additionally, for example, 2-fluoropropylthio, 3-fluoropropylthio, 2,2-difluoropropylthio, 2,3-difluoropropylthio, 2-chloropropylthio, 3-chloropropylthio, 2,3-dichloropropylthio, 2-bromopropylthio, 3-bromopropylthio, 3,3,3-trifluoropropylthio, 3,3,3-trichloropropylthio, SCH₂—C₂F5, SCF₂—C₂F₅, 1-(CH₂F)-2-fluoroethylthio, 1-(CH₂Cl)-2-chloroethylthio, 1-(CH₂Br)-2-bromoethylthio, 4-fluorobutylthio, 4-chlorobutylthio, 4-bromobutylthio or nonafluorobutylthio. C₁-C₆-Haloalkylthio is additionally, for example, 5-fluoropentylthio, 5-chloropentylthio, 5-brompentylthio, 5-iodopentylthio, undecafluoropentylthio, 6-fluorohexylthio, 6-chlorohexylthio, 6-bromohexylthio, 6-iodohexylthio or dodecafluorohexylthio.

The terms “alkylsulfinyl” and “S(O)ₙ-alkyl” (wherein n is 1) are equivalent and, as used herein, denote an alkyl group, as defined above, attached via a sulfinyl [S(O)] group. For example, the term “C₁-C₂-alkylsulfinyl” refers to a C₁-C₂-alkyl group, as defined above, attached via a sulfinyl [S(O)] group. The term “C₁-C₄-alkylsulfinyl” refers to a C₁-C₄-alkyl group, as defined above, attached via a sulfinyl [S(O)] group. The term “C₁-C₆-alkylsulfinyl” refers to a C₁-C₆-alkyl group, as defined above, attached via a sulfinyl [S(O)] group. C₁-C₂-alkylsulfinyl is methylsulfinyl or ethylsulfinyl. C₁-C₄-alkylsulfinyl is additionally, for example, n-propylsulfinyl, 1-methylethylsulfinyl(isopropylsulfinyl), butylsulfinyl, 1-methylpropylsulfinyl(sec-butylsulfinyl), 2-methylpropylsulfinyl(isobutylsulfinyl) or 1,1-dimethylethylsulfinyl(tert-butylsulfinyl). C₁-C₆-alkylsulfinyl is additionally, for example, pentylsulfinyl, 1-methylbutylsulfinyl, 2-methylbutylsulfinyl, 3-methylbutylsulfinyl, 1,1-dimethylpropylsulfinyl, 1,2-dimethylpropylsulfinyl, 2,2-dimethylpropylsulfinyl, 1-ethylpropylsulfinyl, hexylsulfinyl, 1-methylpentylsulfinyl, 2-methylpentylsulfinyl, 3-methylpentylsulfinyl, 4-methylpentylsulfinyl, 1,1-dimethylbutylsulfinyl, 1,2-dimethylbutylsulfinyl, 1,3-dimethylbutylsulfinyl, 2,2-dimethylbutylsulfinyl, 2,3-dimethylbutylsulfinyl, 3,3-dimethylbutylsulfinyl, 1-ethylbutylsulfinyl, 2-ethylbutylsulfinyl, 1,1,2-trimethylpropylsulfinyl, 1,2,2-trimethylpropylsulfinyl, 1-ethyl-1-methylpropylsulfinyl or 1-ethyl-2-methylpropylsulfinyl.

The terms “alkylsulfonyl” and “S(O)ₙ-alkyl” (wherein n is 2) are equivalent and, as used herein, denote an alkyl group, as defined above, attached via a sulfonyl [S(O)₂] group. The term “C₁-C₂-alkylsulfonyl” refers to a C₁-C₂-alkyl group, as defined above, attached via a sulfonyl [S(O)₂] group. The term “C₁-C₄-alkylsulfonyl” refers to a C₁-C₄-alkyl group, as defined above, attached via a sulfonyl [S(O)₂] group. The term “C₁-C₆-alkylsulfonyl” refers to a C₁-C₆-alkyl group, as defined above, attached via a sulfonyl [S(O)₂] group. C₁-C₂-alkylsulfonyl is methylsulfonyl or ethylsulfonyl. C₁-C₄-alkylsulfonyl is additionally, for example, n-propylsulfonyl, 1-methylethylsulfonyl(isopropylsulfonyl), butylsulfonyl, 1-methylpropylsulfonyl(secbutylsulfonyl), 2-methylpropylsulfonyl(isobutylsulfonyl) or 1,1-dimethylethylsulfonyl(tertbutylsulfonyl). C₁-C₆-alkylsulfonyl is additionally, for example, pentylsulfonyl, 1-methylbutylsulfonyl, 2-methylbutylsulfonyl, 3-methylbutylsulfonyl, 1,1-dimethylpropylsulfonyl, 1,2-dimethylpropylsulfonyl, 2,2-dimethylpropylsulfonyl, 1-ethylpropylsulfonyl, hexylsulfonyl, 1-methylpentylsulfonyl, 2-methylpentylsulfonyl, 3-methylpentylsulfonyl, 4-methylpentylsulfonyl, 1,1-dimethylbutylsulfonyl, 1,2-dimethylbutylsulfonyl, 1,3-dimethylbutylsulfonyl, 2,2-dimethylbutylsulfonyl, 2,3-dimethylbutylsulfonyl, 3,3-dimethylbutylsulfonyl, 1-ethylbutylsulfonyl, 2-ethylbutylsulfonyl, 1,1,2-trimethylpropylsulfonyl, 1,2,2-trimethylpropylsulfonyl, 1-ethyl-1-methylpropylsulfonyl or 1-ethyl-2-methylpropylsulfonyl.

The term “alkylamino” as used herein denotes in each case a group —NHR, wherein R is a straight-chain or branched alkyl group usually having from 1 to 6 carbon atoms (“C₁-C₆-alkylamino”), preferably 1 to 4 carbon atoms (“C₁-C₄-alkylamino”). Examples of C₁-C₆-alkylamino are methylamino, ethylamino, n-propylamino, isopropylamino, n-butylamino, 2-butylamino, iso-butylamino, tert-butylamino, and the like.

The term “dialkylamino” as used herein denotes in each case a group-NRR′, wherein R and R′, independently of each other, are a straight-chain or branched alkyl group each usually having from 1 to 6 carbon atoms (“di-(C₁-C₆-alkyl)-amino”), preferably 1 to 4 carbon atoms (“di-(C₁-C₄-alkyl)-amino”). Examples of a di-(C₁-C₆-alkyl)-amino group are dimethylamino, diethylamino, dipropylamino, dibutylamino, methyl-ethyl-amino, methyl-propyl-amino, methyl-isopropylamino, methyl-butyl-amino, methyl-isobutyl-amino, ethyl-propyl-amino, ethyl-isopropylamino, ethyl-butyl-amino, ethyl-isobutyl-amino, and the like.

The term “cycloalkylamino” as used herein denotes in each case a group —NHR, wherein R is a cycloalkyl group usually having from 3 to 8 carbon atoms (“C₃-C₈-cycloalkylamino”), preferably 3 to 6 carbon atoms (“C₃-C₆-cycloalkylamino”). Examples of C₃-C₈-cycloalkylamino are cyclopropylamino, cyclobutylamino, cyclopentylamino, cyclohexylamino, and the like.

The term “alkylaminosulfonyl” as used herein denotes in each case a straight-chain or branched alkylamino group as defined above, which is bound to the remainder of the molecule via a sulfonyl [S(O)₂] group. Examples of an alkylaminosulfonyl group are methylaminosulfonyl, ethylaminosulfonyl, n-propylaminosulfonyl, isopropylaminosulfonyl, n-butylaminosulfonyl, 2-butylaminosulfonyl, iso-butylaminosulfonyl, tert-butylaminosulfonyl, and the like.

The term “dialkylaminosulfonyl” as used herein denotes in each case a straight-chain or branched alkylamino group as defined above, which is bound to the remainder of the molecule via a sulfonyl [S(O)₂] group. Examples of an dialkylaminosulfonyl group are dimethylaminosulfonyl, diethylaminosulfonyl, dipropylaminosulfonyl, dibutylaminosulfonyl, methyl-ethyl-aminosulfonyl, methyl-propyl-aminosulfonyl, methyl-isopropylaminosulfonyl, methyl-butyl-aminosulfonyl, methyl-isobutyl-aminosulfonyl, ethyl-propyl-aminosulfonyl, ethyl-isopropylaminosulfonyl, ethyl-butyl-aminosulfonyl, ethyl-isobutyl-aminosulfonyl, and the like.

The suffix “-carbonyl” in a group denotes in each case that the group is bound to the remainder of the molecule via a carbonyl C═O group. This is the case e.g. in alkylcarbonyl, haloalkylcarbonyl, aminocarbonyl, alkylaminocarbonyl, dialkylaminocarbonyl, alkoxycarbonyl, haloalkoxycarbonyl.

The term “aryl” as used herein refers to a mono-, bi- or tricyclic aromatic hydrocarbon radical such as phenyl or naphthyl, in particular phenyl.

The term “het(ero)aryl” as used herein refers to a mono-, bi- or tricyclic heteroaromatic hydrocarbon radical, preferably to a monocyclic heteroaromatic radical, such as pyridyl, pyrimidyl and the like.

A saturated, partially unsaturated or unsaturated 3- to 8-membered ring system which contains 1 to 4 heteroatoms selected from oxygen, nitrogen, sulfur, is a ring system wherein two oxygen atoms must not be in adjacent positions and wherein at least 1 carbon atom must be in the ring system e.g. thiophene, furan, pyrrole, thiazole, oxazole, imidazole, isothiazole, isoxazole, pyrazole, 1,3,4-oxadiazole, 1,3,4-thiadiazole, 1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzthiazole, benzimidazole, benzisoxazole, benzisothiazole, benzopyrazole, benzothiadiazole, benztriazole, dibenzofuran, dibenzothiophene, carbazole, pyridine, pyrazine, pyrimidine, pyridazine, 1,3,5-triazine, 1,2,4-triazine, 1,2,4,5-tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine, 4H-quinolizine, piperidine, pyrrolidine, oxazoline, tetrahydrofuran, tetrahydropyran, isoxazolidine or thiazolidine, oxirane or oxetane.

A saturated, partially unsaturated or unsaturated 3- to 8-membered ring system which contains 1 to 4 heteroatoms selected from oxygen, nitrogen, sulfur also is e.g. a saturated, partially unsaturated or unsaturated 5- or 6-membered heterocycle which contains 1 to 4 heteroatoms selected from oxygen, nitrogen and sulfur, such as pyridine, pyrimidine, (1,2,4)-oxadiazole, (1,3,4)-oxadiazole, pyrrole, furan, thiophene, oxazole, thiazole, imidazole, pyrazole, isoxazole, 1,2,4-triazole, tetrazole, pyrazine, pyridazine, oxazoline, thiazoline, tetrahydrofuran, tetrahydropyran, morpholine, piperidine, piperazine, pyrroline, pyrrolidine, oxazolidine, thiazolidine; or

a saturated, partially unsaturated or unsaturated 5- or 6-membered heterocycle which contains 1 nitrogen atom and 0 to 2 further heteroatoms selected from oxygen, nitrogen and sulfur, preferably from oxygen and nitrogen, such as piperidine, piperazin and morpholine.

Preferably, this ring system is a saturated, partially unsaturated or unsaturated 3- to 6-membered ring system which contains 1 to 4 heteroatoms selected from oxygen, nitrogen, sulfur, wherein two oxygen atoms must not be in adjacent positions and wherein at least 1 carbon atom must be in the ring system.

Most preferably, this ring system is a radical of pyridine, pyrimidine, (1,2,4)-oxadiazole, 1,3,4-oxadiazole, pyrrole, furan, thiophene, oxazole, thiazole, imidazole, pyrazole, isoxazole, 1,2,4-triazole, tetrazole, pyrazine, pyridazine, oxazoline, thiazoline, tetrahydrofuran, tetrahydropyran, morpholine, piperidine, piperazine, pyrroline, pyrrolidine, oxazolidine, thiazolidine, oxirane or oxetane.

Preparation of the compounds of formula I can be accomplished according to standard methods of organic chemistry, e.g. by the methods or working examples described in WO 2007/006670, PCT/EP2012/065650 and PCT/EP2012/065651, without being limited to the routes given therein.

The preparation of the compounds of formula I above may lead to them being obtained as isomer mixtures. If desired, these can be resolved by the methods customary for this purpose, such as crystallization or chromatography, also on optically active adsorbate, to give the pure isomers.

Agronomically acceptable salts of the compounds I can be formed in a customary manner, e.g. by reaction with an acid of the anion in question.

### Compounds II

The commercially available compounds II of the group M listed above may be found in The Pesticide Manual, 15th Edition, C. D. S. Tomlin, British Crop Protection Council (2011) among other publications.

The quinoline derivative flometoquin is shown in WO2006/013896. The aminofuranone compounds flupyradifurone is known from WO 2007/115644. The sulfoximine compound sulfoxaflor is known from WO2007/149134. The pyrethroid momfluorothrin is known from U.S. Pat. No. 6,908,945. The pyrazole acaricide pyflubumide is known from WO2007/020986. The isoxazoline compound II-M.X.1 has been described in WO2005/085216, II-M.X.8 in WO2009/002809 and in WO2011/149749 and the isoxazoline II-M.X.9 in WO2013/050317.

The pyripyropene derivative II-M.X.2 has been described in WO 2006/129714. The spiroketal-substituted cyclic ketoenol derivative II-M.X.3 is known from WO2006/089633 and the biphenyl-substituted spirocyclic ketoenol derivative II-M.X.4 from WO2008/067911. Triazoylphenylsulfide like II-M.X.5 have been described in WO2006/043635 and biological control agents on basis of bacillus firmus in WO2009/124707. The neonicotionids II-M4A.1 is known from WO20120/069266 and WO2011/06946, the II-M.4A.2 from WO2013/003977, the II-M4A.3.from WO2010/069266. The metaflumizone analogue II-M.22C is described in CN 10171577.

Cyantraniliprole (Cyazypyr) is known from e.g. WO 2004/067528. The phthalamides II-M.26.1 and II-M.26.2 are both known from WO 2007/101540. The anthranilamide II-M.26.3 has been described in WO 2005/077934. The hydrazide compound II-M.26.4 has been described in WO 2007/043677. The anthranilamide II-M.26.5a) is described in WO2011/085575, the II-M.26.5b) in WO2008/134969, the II-M.26.5c) in US2011/046186 and the II-M.26.5d in WO2012/034403.

The diamide compounds II-M.26.6 and II-M.26.7 can be found in CN102613183.

The compounds II-M.X.6a) to II-M.X.6i) listed in II-M.X.6 have been described in WO2012/029672.

The mesoionic antagonist compound II-M.X.8 was described in WO2012/092115, the nematicide II-M.X.9 in WO2013/055584 and the Pyridalyl-type analogue II-M.X.12 in WO2010/060379.

### Biopesticides

The biopesticides from group II-M.Y, and from group F.XIII) as described below, their preparation and their biological activity e.g. against harmful fungi, pests is known (e-Pesticide Manual V 5.2 (ISBN 978 1 901396 85 0) (2008-2011); http://www.epa.gov/opp00001/biopesticides/, see product lists therein; http://www.omri.org/omri-lists, see lists therein; Bio-Pesticides Database BPDB http://sitem.herts.ac.uklaeru/bpdb/, see A to Z link therein). Many of these biopesticides are registered and/or are commercially available: aluminium silicate (SCREEN™ DUO from Certis LLC, USA), Ampelomyces quisqualis M-10 (e.g. AQ 10® from Intrachem Bio GmbH & Co. KG, Germany), Ascophyllum nodosum (Norwegian kelp, Brown kelp) extract (e.g. ORKA GOLD from Becker Underwood, South Africa), Aspergillus flavus NRRL 21882 (e.g. AFLA-GUARD® from Syngenta, CH), Aureobasidium pullulans (e.g. BOTECTOR® from bio-ferm GmbH, Germany), Azospirillum brasilense XOH (e.g. AZOS from Xtreme Gardening, USA USA or RTI Reforestation Technologies International; USA), Bacillus amyloliquefaciens IT-45 (CNCM I 3800, NCBI 1091041) (e.g. RHIZOCELL C from ITHEC, France), B. amyloliquefaciens subsp. plantarum MBI600 (NRRL B-50595, deposited at United States Department of Agriculture) (e.g. INTEGRAL®, CLARITY, SUBTILEX NG from Becker Underwood, USA), B. pumilus QST 2808 (NRRL Accession No. B 30087) (e.g. SONATA® and BALLAD® Plus from AgraQuest Inc., USA), B. subtilis GB03 (e.g. KODIAK from Gustafson, Inc., USA), B. subtilis GB07 (EPIC from Gustafson, Inc., USA), B. subtilis QST-713 (NRRL-Nr. B 21661 in RHAPSODY®, SERENADE® MAX and SERENADE® ASO from AgraQuest Inc., USA), B. subtilis var. amyloliquefaciens FZB24 (e.g. TAEGRO® from Novozyme Biologicals, Inc., USA), B. subtilis var. amyloliquefaciens D747 (e.g. Double Nickel 55 from Certis LLC, USA), Bacillus thuringiensis ssp. kurstaki SB4 (e.g. BETA PRO® from Becker Underwood, South Africa), Beauveria bassiana GHA (BOTANIGARD® 22WGP from Laverlam Int. Corp., USA), B. bassiana 12256 (e.g. BIOEXPERT® SC from Live Sytems Technology S.A., Colombia), B. bassiana PRPI 5339 (ARSEF number 5339 in the USDA ARS collection of entomopathogenic fungal cultures) (e.g. BROAD-BAND® from Becker Underwood, South Africa), Bradyrhizobium sp. (e.g. VAULT® from Becker Underwood, USA), B. japonicum (e.g. VAULT® from Becker Underwood, USA), Candida oleophila 1-82 (e.g. ASPIRE from Ecogen Inc., USA), Candida saitoana (e.g. BIOCURE® (in mixture with lysozyme) and BIOCOAT® from Micro Flo Company, USA (BASF SE) and Arysta), Chitosan (e.g. ARMOUR-ZEN from BotriZen Ltd., NZ), Clonostachys rosea f. catenulata, also named Gliocladium catenulatum (e.g. isolate J1446: PRESTOP® from Verdera, Finland), Coniothyrium minitans CON/M/91-08 (e.g. Contans® WG from Prophyta, Germany), Cryphonectria parasitica (e.g. Endothia parasitica from CNICM, France), Cryptococcus albidus (e.g. YIELD PLUS® from Anchor Bio-Technologies, South Africa), Ecklonia maxima (kelp) extract (e.g. KELPAK SL from Kelp Products Ltd, South Africa), Fusarium oxysporum (e.g. BIOFOX® from S.I.A.P.A., Italy, FUSACLEAN® from Natural Plant Protection, France), Glomus intraradices (e.g. MYC 4000 from ITHEC, France), Glomus intraradices RTI-801 (e.g. MYKOS from Xtreme Gardening, USA or RTI Reforestation Technologies International; USA), grapefruit seeds and pulp extract (e.g. BC-1000 from Chemie S.A., Chile), Isaria fumosorosea Apopka-97 (ATCC 20874) (PFR-97™ from Certis LLC, USA), Lecanicillium muscarium (formerly Verticillium lecanii) (e.g. MYCOTAL from Koppert BV, Netherlands), Lecanicillium longisporum KV42 and KV71 (e.g. VERTALEC® from Koppert BV, Netherlands), Metarhizium anisopliae var. acridum IMI 330189 (deposited in European Culture Collections CABI) (e.g. GREEN MUSCLE® from Becker Underwood, South Africa), M. anisopliae FI-1045 (e.g. BIOCANE® from Becker Underwood Pty Ltd, Australia), M. anisopliae var. acridum FI-985 (e.g. GREEN GUARD® SC from Becker Underwood Pty Ltd, Australia), M. anisopliae F52 (e.g. MET52® Novozymes Biologicals BioAg Group, Canada), M. anisopliae ICIPE 69 (e.g. METATHRI [symbol] POL from ICIPE, Kenya), Metschnikowia fructicola (e.g. SHEMER® from Agrogreen, Israel), Microdochium dimerum (e.g. ANTIBOT® from Agrauxine, France), Neem oil (e.g. TRILOGY®, TRIACT® 70 EC from Certis LLC, USA), Paecilomyces fumosoroseus strain FE 9901 (e.g. NO FLY™ from Natural Industries, Inc., USA), P. lilacinus DSM 15169 (e.g. NEMATA® SC from Live Systems Technology S.A., Colombia), P. lilacinus BCP2 (e.g. PL GOLD from Becker Underwood BioAg SA Ltd, South Africa), mixture of Paenibacillus alvei NAS6G6 and Bacillus pumilis (e.g. BAC-UP from Becker Underwood South Africa), Penicillium bilaiae (e.g. JUMP START® from Novozymes Biologicals BioAg Group, Canada), Phlebiopsis gigantea (e.g. ROTSTOP® from Verdera, Finland), potassium silicate (e.g. Sil-MATRIX™ from Certis LLC, USA), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis extract (e.g. REGALIA® from Marrone Biolnnovations, USA), Rhizobium leguminosarum bv. phaseolii (e.g. RHIZO-STICK from Becker Underwood, USA), R. I. trifolii (e.g. DORMAL from Becker Underwood, USA), R. I. bv. viciae (e.g. NODULATOR from Becker Underwood, USA), Sinorhizobium meliloti (e.g. DORMAL ALFALFA from Becker Underwood, USA; NITRAGIN® Gold from Novozymes Biologicals BioAg Group, Canada), Steinernema feltiae (NEMA [symbol] SHIELD® from BioWorks, Inc., USA), Streptomyces lydicus WYEC 108 (e.g. Actinovate® from Natural Industries, Inc., USA, U.S. Pat. No. 5,403,584), S. violaceusniger YCED-9 (e.g. DT-9® from Natural Industries, Inc., USA, U.S. Pat. No. 5,968,503), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. fertile JM41R (e.g. RICHPLUS™ from Becker Underwood Bio Ag SA Ltd, South Africa), T. harzianum T-22 (e.g. PLANTSHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000® from Mycontrol Ltd., Israel and Makhteshim Ltd., Israel), T. harzianum and T. viride (e.g. TRICHOPEL from Agrimm Technologies Ltd, NZ), T. harzianum ICC012 and T. viride ICC080 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (also named Gliocladium virens) (e.g. SOILGARD® from Certis LLC, USA), T. viride (e.g. TRIECO® from Ecosense Labs. (India) Pvt. Ltd., Indien, BIOCURE® F from T. Stanes & Co. Ltd., Indien), T. viride TV1 (e.g. T. viride TV1 from Agribiotec srl, Italy), Ulocladium oudemansii HRU3 (e.g. BOTRY-ZEN® from Botry-Zen Ltd, NZ), Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. mojavensis AP-209 (No. NRRL B-50616), B. solisalsi AP-217 (NRRL B-50617), B. pumilus strain INR-7 (otherwise referred to as BU-F22 (NRRL B-50153) and BU-F33 (NRRL B-50185)), B. simplex ABU 288 (NRRL B-50340) and B. amyloliquefaciens subsp. plantarum MB1600 (NRRL B-50595) have been mentioned i.a. in US patent appl. 20120149571, WO 2012/079073. Beauveria bassiana DSM 12256 is known from US200020031495. Bradyrhizobium japonicum USDA is known from U.S. Pat. No. 7,262,151. Sphaerodes mycoparasitica IDAC 301008-01 (IDAC=International Depositary Authority of Canada Collection) is known from WO 2011/022809.

Bacillus amyloliquefaciens subsp. plantarum MBI600 having the accession number NRRL B-50595 is deposited with the United States Department of Agriculture on Nov. 10, 2011 under the strain designation Bacillus subtilis 1430. It has also been deposited at The National Collections of Industrial and Marine Bacteria Ltd. (NCIB), Torry Research Station, P.O. Box 31, 135 Abbey Road, Aberdeen, AB9 8DG, Scotland. under accession number 1237 on Dec. 22, 1986. Bacillus amyloliquefaciens MBI600 is known as plant growth-promoting rice seed treatment from Int. J. Microbiol. Res. ISSN 0975-5276, 3(2) (2011), 120-130 and further described e.g. in US 2012/0149571 A1. This strain MBI600 is commercially available as liquid formulation product Integral® (Becker-Underwood Inc., USA). Recently, the strain MBI 600 has been reclassified as Bacillus amyloliquefaciens subsp. plantarum based on polyphasic testing which combines classical microbiological methods relying on a mixture of traditional tools (such as culture-based methods) and molecular tools (such as genotyping and fatty acids analysis).

Thus, Bacillus subtilis MB1600 (or MBI 600 or MBI-600) is identical to Bacillus amyloliquefaciens subsp. plantarum MBI600, formerly Bacillus subtilis MBI600.

Metarhizium anisopliae IMI33 is commercially available from Becker Underwood as product Green Guard. M. anisopliae var acridium strain IMI 330189 (NRRL-50758) is commercially available from Becker Underwood as product Green Muscle.

Bacillus subtilis strain FB17 was originally isolated from red beet roots in North America (System Appl. Microbiol 27 (2004) 372-379). This Bacillus subtilis strain promotes plant health (US 2010/0260735 A1; WO 2011/109395 A2). B. subtilis FB17 has also been deposited at American Type Culture Collection (ATCC), Manassas, Va., USA, under accession number PTA-11857 on Apr. 26, 2011. Bacillus subtilis strain FB17 may also be referred to as UD1022 or UD10-22.

According to one embodiment of the inventive mixtures, the at least one biopesticide II is selected from the groups II-M.Y-1 to II-M.Y-2:
II-M.Y-1: Microbial pesticides with insecticidal, acaricidal, molluscidal and/or nematicidal activity: Bacillus firmus St 1582, B. thuringiensis ssp. israelensis SUM-6218, B. t. ssp. galleriae SDS-502, B. t. ssp. kurstaki, Beauveria bassiana GHA, B. bassiana H123, B. bassiana DSM 12256, B. bassiana PRPI 5339, Burkholderia sp. A396, Chromobacterium subtsugae PRAA4-1T, Cydia pomonella granulosis virus isolate V22, Isaria fumosorosea Apopka-97, Lecanicillium longisporum KV42, L. longisporum KV71, L. muscarium (formerly Verticillium lecanii), Metarhizium anisopliae FI-985, M. anisopliae F1-1045, M. anisopliae F52, M. anisopliae ICIPE 69, M. anisopliae var. acridum IMI 330189, Paecilomyces fumosoroseus FE 9901, P. lilacinus DSM 15169, P. lilacinus BCP2, Paenibacillus poppiliae Dutky-1940 (NRRL B-2309=ATCC 14706), P. poppiliae KLN 3, P. poppiliae Dutky 1, Pasteuria spp. Ph3, P. nishizawae PN-1, P. reneformis Pr-3, P. usagae, Pseudomonas fluorescens CL 145A, Steinernema feltiae, Streptomces galbus;
II-M.Y-2: Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Quillay extract, Tagetes oil;

According to one embodiment of the inventive mixtures, the at least one biopesticide II is selected from group II-M.Y-1.

According to one embodiment of the inventive mixtures, the at least one biopesticide II is selected from II-M.Y-2.

According to one embodiment of the inventive mixtures, the at least one biopesticide II is Bacillus amyloliquefaciens subsp. plantarum MBI600. These mixtures are particularly suitable in soybean.

According to another embodiment of the inventive mixtures, the at least one biopesticide II is B. pumilus strain INR-7 (otherwise referred to as BU-F22 (NRRL B-50153) and BU-F33 (NRRL B-50185; see WO 2012/079073). These mixtures are particularly suitable in soybean and corn.

According to another embodiment of the inventive mixtures, the at least one biopesticide II is Bacillus pumilus, preferably B. pumilis strain INR-7 (otherwise referred to as BU-F22 (NRRL B-50153) and BU-F33 (NRRL B-50185). These mixtures are particularly suitable in soybean and corn.

According to another embodiment of the inventive mixtures, the at least one biopesticide II is Bacillus simplex, preferably B. simplex strain ABU 288 (NRRL B-50340). These mixtures are particularly suitable in soybean and corn.

According to another embodiment of the inventive mixtures, the at least one biopesticide II is selected from Trichoderma asperellum, T. atroviride, T. fertile, T. gamsii, T. harmatum; mixture of T. harzia [symbol] num and T. viride; mixture of T. polysporum and T. harzianum; T. stromaticum, T. virens (also named Gliocladium virens) and T. viride; preferably Trichoderma fertile, in particular T. fertile strain JM41R. These mixtures are particularly suitable in soybean and corn.

According to another embodiment of the inventive mixtures, the at least one biopesticide II is Sphaerodes mycoparasitica, preferably Sphaerodes mycoparasitica strain IDAC 301008-01 (also referred to as strain SMCD2220-01). These mixtures are particularly suitable in soybean and corn.

According to another embodiment of the inventive mixtures, the at least one biopesticide II is Beauveria bassiana, preferably Beauveria bassiana strain PPR15339. These mixtures are particularly suitable in soybean and corn.

According to another embodiment of the inventive mixtures, the at least one biopesticide II is Metarhizium anisopliae or M. anisopliae var. acridium, preferably selected from M anisolpiae strain IMI33 and M. anisopliae var. acridium strain IMI 330189. These mixtures are particularly suitable in soybean and corn.

According to another embodiment of the inventive mixtures, Bradyrhizobium sp. (meaning any Bradyrhizobium species and/or strain) as biopesticide II is Bradyrhizobium japonicum (B. japonicum). These mixtures are particularly suitable in soybean. Preferably B. japonicum is not one of the strains TA-11 or 532c. B. japonicum strains were cultivated using media and fermentation techniques known in the art, e.g. in yeast extract-mannitol broth (YEM) at 27° C. for about 5 days.

References for various B. japonicum strains are given e.g. in U.S. Pat. No. 7,262,151 (B. japonicum strains USDA 110 (=IITA 2121, SEMIA 5032, RCR 3427, ARS I-110, Nitragin 61A89; isolated from Glycine max in Florida in 1959, Serogroup 110; Appl Environ Microbiol 60, 940-94, 1994), USDA 31 (=Nitragin 61A164; isolated from Glycine max in Wisconsin in 1941, USA, Serogroup 31), USDA 76 (plant passage of strain USDA 74 which has been isolated from Glycine max in California, USA, in 1956, Serogroup 76), USDA 121 (isolated from Glycine max in Ohio, USA, in 1965), USDA 3 (isolated from Glycine max in Virginia, USA, in 1914, Serogroup 6) and USDA 136 (=CB 1809, SEMIA 586, Nitragin 61A136, RCR 3407; isolated from Glycine max in Beltsville, Md. in 1961; Appl Environ Microbiol 60, 940-94, 1994). USDA refers to United States Department of Agriculture Culture Collection, Beltsville, Md., USA (see e.g. Beltsville Rhizobium Culture Collection Catalog March 1987 ARS-30). Further suitable B. japonicum strain G49 (INRA, Angers, France) is described in Fernandez-Flouret, D. & Cleyet-Marel, J. C. (1987) C R Acad Agric Fr 73, 163-171), especially for soybean grown in Europe, in particular in France. Further suitable B. japonicum strain TA-11 (TA11 NOD+) (NRRL B-18466) is i.a. described in U.S. Pat. No. 5,021,076; Appl Environ Microbiol (1990) 56, 2399-2403 and commercially available as liquid inoculant for soybean (VAULT® NP, Becker Underwood, USA).

Further B. japonicum strains as example for biopesticide II are described in US2012/0252672A. Further suitable and especially in Canada commercially available strain 532c (The Nitragin Company, Milwaukee, Wis., USA, field isolate from Wisconsin; Nitragin strain collection No. 61A152; Can J Plant Sci 70 (1990), 661-666).

Other suitable and commercially available B. japonicum strains (see e.g. Appl Environ Microbiol 2007, 73(8), 2635) are SEMIA 566 (isolated from North American inoculant in 1966 and used in Brazilian commercial inoculants from 1966 to 1978), SEMIA 586 (=CB 1809; originally isolated in Maryland, USA but received from Australia in 1966 and used in Brazilian inoculants in 1977), CPAC 15 (=SEMIA 5079; a natural variant of SEMIA 566 used in commercial inoculants since 1992) and CPAC 7 (=SEMIA 5080; a natural variant of SEMIA 586 used in commercial inoculants since 1992). These strains are especially suitable for soybean grown in Australia or South America, in particular in Brazil. Some of the abovementioned strains have been reclassified as a novel species Bradyrhizobium elkanii, e.g. strain USDA 76 (Can. J. Microbiol., 1992, 38, 501-505).

Another suitable and commercially available B. japonicum strain is E-109 (variant of strain USDA 138, see e.g. Eur. J. Soil Biol. 45 (2009) 28-35; Biol Fertil Soils (2011) 47:81-89, deposited at Agriculture Collection Laboratory of the Instituto de Microbiologia y Zoologia Agricola (IMYZA), Instituto Nacional de Tecnologi'a Agropecuaria (INTA), Castelar, Argentina). This strain is especially suitable for soybean grown in South America, in particular in Argentina.

The present invention also relates to mixtures, wherein the at least one biopesticide II is selected from Bradyrhizobium elkanii and Bradyrhizobium liaoningense (B. elkanii and B. liaoningense), more preferably from B. elkanii. These mixtures are particularly suitable in soybean. B. elkanii and liaoningense were cultivated using media and fermentation techniques known in the art, e.g. in yeast extract-mannitol broth (YEM) at 27° C. for about 5 days.

Suitable and commercially available B. elkanii strains are SEMIA 587 and SEMIA 5019 (=29W) (see e.g. Appl Environ Microbiol 2007, 73(8), 2635) and USDA 3254 and USDA 76 and USDA 94. Further commercially available B. elkanii strains are U-1301 and U-1302 (e.g. product Nitroagin® Optimize from Novozymes Bio As S.A., Brazil or NITRASEC for soybean from LAGE y Cia, Brazil). These strains are especially suitable for soybean grown in Australia or South America, in particular in Brazil.

The present invention also relates to mixtures, wherein the at least one biopesticide II is selected from Bradyrhizobium japonicum (B. japonicum) and further comprises a compound III, wherein compound III is selected from jasmonic acid or salts or derivatives thereof including cis-jasmone, preferably methyl-jasmonate or cis-jasmone.

The present invention also relates to mixtures, wherein biopesticide II is selected from Bradyrhizobium sp. (Arachis) (B. sp. Arachis) which shall describe the cowpea miscellany cross-inoculation group which includes inter alia indigenous cowpea bradyrhizobia on cowpea (Vigna unguiculata), siratro (Macroptilium atropurpureum), lima bean (Phaseolus lunatus), and peanut (Arachis hypogaea). This mixture comprising as biopesticide II B. sp. Arachis is especially suitable for use in peanut, Cowpea, Mung bean, Moth bean, Dune bean, Rice bean, Snake bean and Creeping vigna, in particular peanut.

Suitable and commercially available B. sp. (Arachis) strain is CB1015 (=IITA 1006, USDA 3446 presumably originally collected in India; from Australian Inoculants Research Group; see e.g. http://www.qaseeds.com.au/inoculant_applic.php; Beltsville Rhizobium Culture Collection Catalog March 1987 USDA-ARS ARS-30). These strains are especially suitable for peanut grown in Australia, North America or South America, in particular in Brazil. Further suitable strain is bradyrhizobium sp. PNL01 (Becker Underwood; ISO Rep Marita McCreary, QC Manager Padma Somasageran; IDENTIFICATION OF RHIZOBIA SPECIES THAT CAN ESTABLISH NITROGEN-FIXING NODULES IN CROTALARIA LONGIROSTRATA. Apr. 29, 2010, University of Massachusetts Amherst: http://www.wpi.edu/Pubs/E-project/Available/E-project-04281 0-163614/unrestricted/Bisson.Mason._Identification_of_{—}Rhizobia_Species_That_can_Establish_Nit rogen-Fixing_Nodules_in_{—}Crotalia_{—}Longirostrata. pdf).

Suitable and commercially available Bradyrhizobium sp. (Arachis) strains especially for cowpea and peanut but also for soybean are Bradyrhizobium SEMIA 6144, SEMIA 6462 (=BR 3267) and SEMIA 6464 (=BR 3262) (deposited at FEPAGRO-MIRCEN, R. Gonçalves Dias, 570 Porto Alegre—RS, 90130-060, Brazil; see e.g. FEMS Microbiology Letters (2010) 303(2), 123-131; Revista Brasileira de Ciencia do Solo (2011) 35(3); 739-742, ISSN 0100-0683).

The present invention also relates to mixtures wherein the at least one biopesticide II is selected from Bradyrhizobium sp. (Arachis) and further comprises a compound III, wherein compound III is selected from jasmonic acid or salts or derivatives thereof including cis-jasmone, preferably methyl-jasmonate or cis-jasmone.

The present invention also relates to mixtures, wherein the at least one biopesticide II is selected from Bradyrhizobium sp. (Lupine) (also called B. lupini, B. lupines or Rhizobium lupini).

This mixture is especially suitable for use in dry beans and lupins.

Suitable and commercially available B. lupini strain is LL13 (isolated from Lupinus iuteus nodules from French soils; deposited at INRA, Dijon and Angers, France; http://agriculture.gouv.fr/IMG/pdf/ch20060216.pdf). This strain is especially suitable for lupins grown in Australia, North America or Europe, in particular in Europe.

Further suitable and commercially available B. lupini strains WU425 (isolated in Esperance, Western Australia from a non-Australian legume Ornthopus compressus), WSM4024 (isolated from lupins in Australia by CRS during a 2005 survey) and WSM471 (isolated from Ornithopus pinnatus in Oyster Harbour, Western Australia) are described e.g. in Palta J. A. and Berger J. B. (eds), 2008, Proceedings 12th International Lupin Conference, 14-18 Sep. 2008, Fremantle, Western Australia. International Lupin Association, Canterbury, New Zealand, 47-50, ISBN 0-86476-153-8: http://www.lupins.org/pdf/conference/2008/Agronomy%20and%20Production/John%20Howieso n%20and%20G%20OHara.pdf; Appl Environ Microbiol (2005) 71, 7041-7052 and Australian J. Exp. Agricult. (1996) 36(1), 63-70.

The present invention also relates to mixtures wherein the at least one biopesticide II is selected from Bradyrhizobium sp. (Lupine) (B. lupini) and further comprises a compound III, wherein compound III is selected from jasmonic acid or salts or derivatives thereof including cis-jasmone, preferably methyl-jasmonate or cis-jasmone.

The present invention also relates to mixtures, wherein the at least one biopesticide II is selected from Mesorhizobium sp. (meaning any Mesorhizobium species and/or strain), more preferably Mesorhizobium ciceri. These mixtures are particularly suitable in cowpea.

Suitable and commercially available M. sp. strains are e.g. M. ciceri CC1192 (=UPM 848, CECT 5549; from Horticultural Research Station, Gosford, Australia; collected in Israel from Cicer arietinum nodules; Can J Microbial (2002) 48, 279-284) and Mesorhizobium sp. strains WSM1271 (collected in Sardinia, Italy, from plant host Biserrula pelecinus), WSM 1497 (collected in Mykonos, Greece, from plant host Biserrula pelecinus), M. loti strains CC₈₂₉ (commerical inoculant for Lotus pedunculatus and L. ulginosus in Australia, isolated from L. ulginosus nodules in USA) and SU343 (commercial inoculant for Lotus corniculatus in Australia; isolated from host nodules in USA) all of which are deposited at Western Australian Soil Microbiology (WSM) culture collection, Australia and/or CSIRO collection (CC), Canberra, Australian Capirtal Territory (see e.g. Soil Biol Biochem (2004) 36(8), 1309-1317; Plant and Soil (2011) 348(1-2), 231-243).

Suitable and commercially available M. loti strains are e.g. M. loti CC₈₂₉ for Lotus pedunculatus.

The present invention also relates to mixtures wherein the at least one biopesticide II is selected from Bradyrhizobium sp. (Lupine) (B. lupini) and further comprises a compound III, wherein compound III is selected from jasmonic acid or salts or derivatives thereof including cis-jasmone, preferably methyl-jasmonate or cis-jasmone.

The present invention also relates to mixtures wherein the at least one biopesticide II is selected from Mesorhizobium huakuii, also referred to as Rhizobium huakuii (see e.g. Appl. Environ. Microbiol. 2011, 77(15), 5513-5516). These mixtures are particularly suitable in Astralagus, e.g. Astalagus sinicus (Chinese milkwetch), Thermopsis, e.g. Thermopsis luinoides (Goldenbanner) and alike.

Suitable and commercially available M. huakuii strain is HN3015 which was isolated from Astralagus sinicus in a rice-growing field of Southern China (see e.g. World J. Microbiol. Biotechn. (2007) 23(6), 845-851, ISSN 0959-3993).

The present invention also relates to mixtures wherein the at least one biopesticide II is selected from Mesorhizobium huakuii and further comprises a compound III, wherein compound III is selected from jasmonic acid or salts or derivatives thereof including cis-jasmone, preferably methyl-jasmonate or cis-jasmone.

The present invention also relates to mixtures, wherein the at least one biopesticide II is selected from Azospirillum amazonense, A. brasilense, A. lipoferum, A. irakense, A. halopraeferens, more preferably from A. brasilense, in particular selected from A. brasilense strains BR 11005 (SP 245) and AZ39 which are both commercially used in Brazil and are obtainable from EMBRAPA, Brazil. These mixtures are particularly suitable in soybean.

Humates are humic and fulvic acids extracted from a form of lignite coal and clay, known as leonardite. Humic acids are organic acids that occur in humus and other organically derived materials such as peat and certain soft coal. They have been shown to increase fertilizer efficiency in phosphate and micro-nutrient uptake by plants as well as aiding in the development of plant root systems.

Salts of jasmonic acid (jasmonate) or derivatives include without limitation the jasmonate salts potassium jasmonate, sodium jasmonate, lithium jasmonate, ammonium jasmonate, dimethylammonium jasmonate, isopropylammonium jasmonate, diolammonium jasmonate, diethtriethanolammonium jasmonate, jasmonic acid methyl ester, jasmonic acid amide, jasmonic acid methylamide, jasmonic acid-L-amino acid (amide-linked) conjugates (e.g., conjugates with L-isoleucine, L-valine, L-leucine, or L-phenylalanine), 12-oxo-phytodienoic acid, coronatine, coronafacoyl-L-serine, coronafacoyl-L-threonine, methyl esters of 1-oxo-indanoyl-isoleucine, methyl esters of 1-oxo-indanoyl-leucine, coronalon (2-[(6-ethyl-1-oxo-indane-4-carbonyl)-amino]-3-methyl-pentanoic acid methyl ester), linoleic acid or derivatives thereof and cis-jasmone, or combinations of any of the above.

According to one embodiment, the microbial pesticides embrace not only the isolated, pure cultures of the respective micro-organism as defined herein, but also its cell-free extract, its suspensions in a whole broth culture or as a metabolite-containing supernatant or a purified metabolite obtained from a whole broth culture of the microorganism or microorganism strain.

According to a further embodiment, the microbial pesticides embrace not only the isolated, pure cultures of the respective micro-organism as defined herein, but also a cell-free extract thereof or at least one metabolite thereof, and/or a mutant of the respective micro-organism having all the identifying characteristics thereof and also a cell-free extract or at least one metabolite of the mutant.

“Whole broth culture” refers to a liquid culture containing both cells and media.

“Supernatant” refers to the liquid broth remaining when cells grown in broth are removed by centrifugation, filtration, sedimentation, or other means well known in the art.

The term “metabolite” refers to any compound, substance or byproduct produced by a microorganism (such as fungi and bacteria) that has improves plant growth, water use efficiency of the plant, plant health, plant appearance, or the population of beneficial microorganisms in the soil around the plant activity.

The term “mutant” refers a microorganism obtained by direct mutant selection but also includes microorganisms that have been further mutagenized or otherwise manipulated (e.g., via the introduction of a plasmid). Accordingly, embodiments include mutants, variants, and or derivatives of the respective microorganism, both naturally occurring and artificially induced mutants. For example, mutants may be induced by subjecting the microorganism to known mutagens, such as N-methyl-nitrosoguanidine, using conventional methods.

According to the invention, the solid material (dry matter) of the biopesticides (with the exception of oils such as Neem oil, Tagetes oil, etc.) are considered as active components (e.g. to be obtained after drying or evaporation of the extraction medium or the suspension medium in case of liquid formulations of the microbial pesticides).

In accordance with the present invention, the weight ratios and percentages used herein for biological extract such as Quillay extract are based on the total weight of the dry content (solid material) of the respective extract(s).

For microbial pesticides, weight ratios and/or percentages refer to the total weight of a preparation of the respective biopesticide with at least 1×106 CFU/g (“colony forming units per gram total weight”), preferably with at least 1×108 CFU/g, even more preferably from 1×108 to 1×1012 CFU/g dry matter. Colony forming unit is measure of viable microbial cells, in particular fungal and bacterial cells. In addition, here CFU may also be understood as number of (juvenile) individual nematodes in case of (entomo [symbol] pathogenic) nematode biopesticides, such as Steinernema feltiae.

Herein, microbial pesticides may be supplied in any physiological state such as active or dormant. Such dormant active component may be supplied for example frozen, dried, or lyophilized or partly desiccated (procedures to produce these partly desiccated organisms are given in WO2008/002371) or in form of spores.

Microbial pesticides used as organism in an active state can be delivered in a growth medium without any additional additives or materials or in combination with suitable nutrient mixtures.

According to a further embodiment, microbial pesticides are delivered and formulated in a dormant stage, more preferably in form of spores.

The total weight ratios of compositions, which comprise a microbial pesticide as component 2, can be determined based on the total weight of the solid material (dry matter) of component 1) and using the amount of CFU of component 2) to calculate the total weight of component 2) with the following equation that 1×10⁹ CFU equals one gram of total weight of component 2).

According to one embodiment, the compositions, which comprise a microbial pesticide, comprise between 0.01 and 90% (w/w) of dry matter (solid material) of component 1) and from 1×10⁵ CFU to 1×10¹² CFU of component 2) per gram total weight of the composition.

According to another embodiment, the compositions, which comprise a microbial pesticide, comprise between 5 and 70% (w/w) of dry matter (solid material) of component 1) and from 1×10⁶ CFU to 1×10¹⁰ CFU of component 2) per gram total weight of the composition.

According to another embodiment, the compositions, wherein one component is a microbial pesticide, comprise between 25 and 70% (w/w) of dry matter (solid material) of component 1) and from 1×10⁷ CFU to 1×10⁹ CFU of component 2) per gram total weight of the composition.

In the case of mixtures comprising a microbial pesticide, the application rates preferably range from about 1×10⁶ to 5×10¹⁵ (or more) CFU/ha. Preferably, the spore concentration is about 1×107 to about 1×1011 CFU/ha. In the case of (entomopathogenic) nematodes as microbial pesticides (e.g. Steinernema feltiae), the application rates preferably range inform about 1×10⁵ to 1×10¹² (or more), more preferably from 1×10⁸ to 1×10¹¹, even more preferably from 5×10⁸ to 1×10¹⁰ individuals (e.g. in the form of eggs, juvenile or any other live stages, preferably in an infetive juvenile stage) per ha.

the case of mixtures comprising microbial pesticides, the application rates with respect to plant propagation material preferably range from about 1×10⁶ to 1×10¹² (or more) CFU/seed.

Preferably, the concentration is about 1×10⁶ to about 1×10¹¹ CFU/seed. In the case of microbial pesticides, the application rates with respect to plant propagation material also preferably range from about 1×10⁷ to 1×10¹⁴ (or more) CFU per 100 kg of seed, preferably from 1×109 to about 1×10¹¹ CFU per 100 kg of seed.

### Preferences

The remarks made below as to preferred embodiments of the variables (substituents) of the compounds of formulae (I) are valid on their own as well as preferably in combination with each other, as well as in combination with the stereoisomers, tautomers, N-oxides or salts thereof, and, where applicable, as well as concerning the uses and methods according to the invention and the compositions according to the invention.

Preferred compounds according to the invention are compounds of formulae (I) or a stereoisomer, N-oxide or salt thereof, wherein the salt is an agriculturally or veterinarily acceptable salt.

The compounds I of formula (I) and their examples include their tautomers, racemic mixtures, individual pure enantiomers and diasteroemers and their optically active mixtures.

Preferred are mixtures of compounds of formula (I), wherein the compound of formula I is a compound of formula IA:

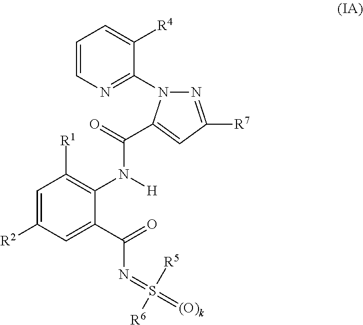

wherein
R⁴ is halogen, and
wherein the variables R¹, R², R⁷, R⁵, R⁶ and k are as defined herein.

Preferred are mixtures of compounds of formula (I), in which the compound of formula I is a compound of formula IB:

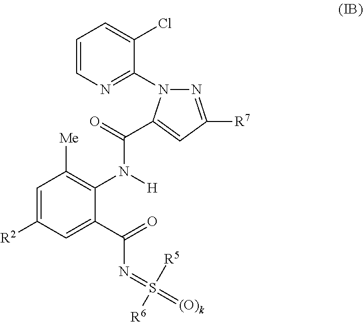

wherein
R² is selected from the group consisting of bromo, chloro, cyano;
R⁷ is selected from the group consisting of bromo, chloro, trifluoromethyl, OCHF₂, and
wherein the variables R², R⁷, R⁵, R⁶ and k are as defined herein.

Preferred are mixtures of compounds of formula (I), in which the compound of formula I is a compound of formula IC:

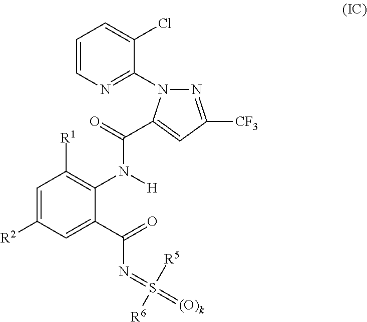

wherein
R¹ is selected from the group consisting of halogen and halomethyl;
R² is selected from the group consisting of bromo, chloro and cyano, and
wherein the variables R⁵, R⁶ and k are as defined herein.

Preferred are mixtures of compounds of formula (I), in which the compound of formula I is a compound of formula ID:

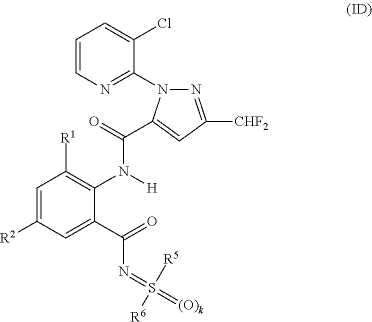

wherein
R¹ is selected from the group consisting of halogen, methyl and halomethyl;
R² is selected from the group consisting of bromo, chloro and cyano, and
wherein the variables R⁵, R⁶ and k are as defined herein.

Preferred are mixtures of compounds of formula (I), in which R⁵, R⁶ are selected independently of one another from the group consisting of hydrogen, C₁-C₁₀-alkyl, C₃-C₈-cycloalkyl, wherein the aforementioned aliphatic and cycloaliphatic radicals may be substituted with 1 to 10 substituents R^{e}; or

R⁵ and R⁶ together represent a C₂-C₇-alkylene chain forming together with the sulfur atom to which they are attached a 3-, 4-, 5-, 6-, 7- or 8-membered saturated, partially unsaturated or fully unsaturated ring, wherein 1 to 4 of the CH₂ groups in the C₂-C₇-alkylene chain may be replaced by 1 to 4 groups independently selected from the group consisting of C═O, C═S, O, S, N, NO, SO, SO₂ and NH, and wherein the carbon and/or nitrogen atoms in the C₂-C₇-alkylene chain may be substituted with 1 to 5 substituents independently selected from the group consisting of halogen, cyano, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₃-C₈-cycloalkyl, C₃-C₈-halocycloalkyl, C₂-C₆-alkenyl, C₂-C₆-haloalkenyl, C₂-C₆-alkynyl and C₂-C₆-haloalkynyl; said substituents being identical or different from one another if more than one substituent is present.

Preferred are mixtures of compounds of formula (I), in which R⁵, R⁶ are selected independently of one another from the group consisting of hydrogen, C₁-C₁₀-alkyl, C₃-C₈-cycloalkyl, wherein the aforementioned aliphatic and cycloaliphatic radicals may be substituted with 1 to 10 substituents R^{e}.

Preferred are mixtures of compounds of formula (I), in which R⁷ is selected from the group consisting of bromo, difluoromethyl, trifluoromethyl, cyano, OCHF₂, OCH₂F and OCH₂CF₃,

Preferred are mixtures of compounds of formula (I), in which R⁷ is selected from the group consisting of bromo, difluoromethyl, trifluoromethyl and OCHF₂.

Preferred are mixtures of compounds of formula (I), in which R^{e} is independently selected from the group consisting of halogen, cyano, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, —C(═NR)NR^{c}R^{d}, phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy and C₁-C₆-haloalkoxy.

Preferred are mixtures of compounds of formula (I), in which R^{e} is independently selected from the group consisting of halogen, cyano, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated.

Preferred are mixtures of compounds of formula (I) as described herein, in which in the compound of formula I

R⁵ and R⁶ are selected from methyl, ethyl, isopropyl, n-propyl, n-butyl, isobutyl, tert-butyl, cyclopropyl, cyclopropylmethyl.

Preferred are mixtures of compounds of formula (I) as described herein, in which in the compound of formula I

R⁵ and R⁶ are identical.

In a particularly preferred embodiment, the mixtures according to the invention comprise at least one compound of formula (IA)

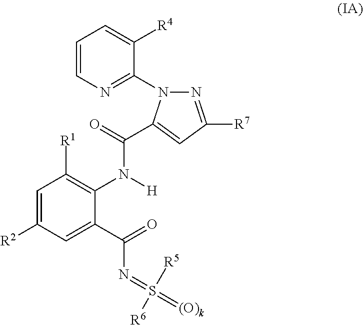

wherein
R⁴ is Cl,
R¹ is selected from the group consisting of Cl, Br, and methyl;
R² is selected from the group consisting of bromo and chloro;
R⁵, R⁶ are selected independently of one another from the group consisting of methyl, ethyl, n-propyl, isopropyl, n-butyl, isobutyl, tert-butyl.
R⁷ is selected from the group consisting of difluoromethyl, trifluoromethyl.

Examples of especially preferred anthranilamide compounds I of the present invention are of formula (IA-1)

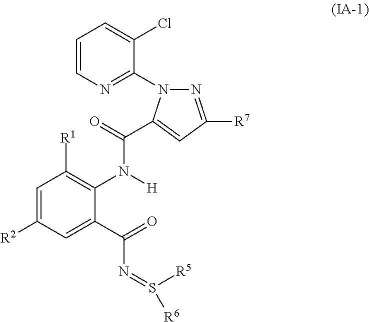

wherein R¹, R², R⁷, R⁵, R⁶ are as defined herein.

Examples of preferred compounds of formula I in the mixtures according to the invention are compiled in tables 1 to 60 below. Moreover, the meanings mentioned below for the individual variables in the tables are per se, independently of the combination in which they are mentioned, a particularly preferred embodiment of the substituents in question.

Table 1 Compounds of the formula (IA-1) in which R¹ is F, R² is Cl, R⁷ is CF₃ and the combination of R⁵ and R⁶ for a compound corresponds in each case to one row of Table A;

Table 2 Compounds of the formula (IA-1) in which R¹ is Br, R² is Cl, R⁷ is CF₃ and the combination of R⁵ and R⁶ for a compound corresponds in each case to one row of Table A;

Table 3 Compounds of the formula (IA-1) in which R¹ is Cl, R² is Cl, R⁷ is CF₃ and the combination of R⁵ and R⁶ for a compound corresponds in each case to one row of Table A;

Table 4 Compounds of the formula (IA-1) in which R¹ is methyl, R² is Cl, R⁷ is CF₃ and the combination of R⁵ and R⁶ for a compound corresponds in each case to one row of Table A;

Table 5 Compounds of the formula (IA-1) in which R¹ is F, R² is Br, R⁷ is CF₃ and the combination of R⁵ and R⁶ for a compound corresponds in each case to one row of Table A;

Table 6 Compounds of the formula (IA-1) in which R¹ is Br, R² is Br, R⁷ is CF₃ and the combination of R⁵ and R⁶ for a compound corresponds in each case to one row of Table A;

Table 7 Compounds of the formula (IA-1) in which R¹ is Cl, R² is Br, R⁷ is CF₃ and the combination of R⁵ and R⁶ for a compound corresponds in each case to one row of Table A;

Table 8 Compounds of the formula (IA-1) in which R¹ is methyl, R² is Br, R⁷ is CF₃ and the combination of R⁵ and R⁶ for a compound corresponds in each case to one row of Table A;

Table 9 Compounds of the formula (IA-1) in which R¹ is F, R² is cyano, R⁷ is CF₃ and the combination of R⁵ and R⁶ for a compound corresponds in each case to one row of Table A;

Table 10 Compounds of the formula (IA-1) in which R¹ is Br, R² is cyano, R⁷ is CF₃ and the combination of R⁵ and R⁶ for a compound corresponds in each case to one row of Table A;

Table 11 Compounds of the formula (IA-1) in which R¹ is Cl, R² is cyano, R⁷ is CF₃ and the combination of R⁵ and R⁶ for a compound corresponds in each case to one row of Table A;

Table 12 Compounds of the formula (IA-1) in which R¹ is methyl, R² is cyano, R⁷ is CF₃ and the combination of R⁵ and R⁶ for a compound corresponds in each case to one row of Table A;

Table 13 Compounds of the formula (IA-1) in which R¹ is F, R² is Cl, R⁷ is CHF₂ and the combination of R⁵ and R⁶ for a compound corresponds in each case to one row of Table A;

Table 14 Compounds of the formula (IA-1) in which R¹ is Br, R² is Cl, R⁷ is CHF₂ and the combination of R⁵ and R⁶ for a compound corresponds in each case to one row of Table A;

Table 15 Compounds of the formula (IA-1) in which R¹ is Cl, R² is Cl, R⁷ is CHF₂ and the combination of R⁵ and R⁶ for a compound corresponds in each case to one row of Table A;

Table 16 Compounds of the formula (IA-1) in which R¹ is methyl, R² is Cl, R⁷ is CHF₂ and the combination of R⁵ and R⁶ for a compound corresponds in each case to one row of Table A;

Table 17 Compounds of the formula (IA-1) in which R¹ is F, R² is Br, R⁷ is CHF₂ and the combination of R⁵ and R⁶ for a compound corresponds in each case to one row of Table A;

Table 18 Compounds of the formula (IA-1) in which R¹ is Br, R² is Br, R⁷ is CHF₂ and the combination of R⁵ and R⁶ for a compound corresponds in each case to one row of Table A;

Table 19 Compounds of the formula (IA-1) in which R¹ is Cl, R² is Br, R⁷ is CHF₂ and the combination of R⁵ and R⁶ for a compound corresponds in each case to one row of Table A;

Table 20 Compounds of the formula (IA-1) in which R¹ is methyl, R² is Br, R⁷ is CHF₂ and the combination of R⁵ and R⁶ for a compound corresponds in each case to one row of Table A;

Table 21 Compounds of the formula (IA-1) in which R¹ is F, R² is cyano, R⁷ is CHF₂ and the combination of R⁵ and R⁶ for a compound corresponds in each case to one row of Table A;

Table 22 Compounds of the formula (IA-1) in which R¹ is Br, R² is cyano, R⁷ is CHF₂ and the combination of R⁵ and R⁶ for a compound corresponds in each case to one row of Table A;

Table 23 Compounds of the formula (IA-1) in which R¹ is Cl, R² is cyano, R⁷ is CHF₂ and the combination of R⁵ and R⁶ for a compound corresponds in each case to one row of Table A;

Table 24 Compounds of the formula (IA-1) in which R¹ is methyl, R² is cyano, R⁷ is CHF₂ and the combination of R⁵ and R⁶ for a compound corresponds in each case to one row of Table A;

Table 25 Compounds of the formula (IA-1) in which R¹ is F, R² is Cl, R⁷ is Br and the combination of R⁵ and R⁶ for a compound corresponds in each case to one row of Table A;

Table 26 Compounds of the formula (IA-1) in which R¹ is Br, R² is Cl, R⁷ is Br and the combination of R⁵ and R⁶ for a compound corresponds in each case to one row of Table A;

Table 27 Compounds of the formula (IA-1) in which R¹ is Cl, R² is Cl, R⁷ is Br and the combination of R⁵ and R⁶ for a compound corresponds in each case to one row of Table A;

Table 28 Compounds of the formula (IA-1) in which R¹ is methyl, R² is Cl, R⁷ is Br and the combination of R⁵ and R⁶ for a compound corresponds in each case to one row of Table A;

Table 29 Compounds of the formula (IA-1) in which R¹ is F, R² is Br, R⁷ is Br and the combination of R⁵ and R⁶ for a compound corresponds in each case to one row of Table A;

Table 30 Compounds of the formula (IA-1) in which R¹ is Br, R² is Br, R⁷ is Br and the combination of R⁵ and R⁶ for a compound corresponds in each case to one row of Table A;

Table 31 Compounds of the formula (IA-1) in which R¹ is Cl, R² is Br, R⁷ is Br and the combination of R⁵ and R⁶ for a compound corresponds in each case to one row of Table A;

Table 32 Compounds of the formula (IA-1) in which R¹ is methyl, R² is Br, R⁷ is Br and the combination of R⁵ and R⁶ for a compound corresponds in each case to one row of Table A;

Table 33 Compounds of the formula (IA-1) in which R¹ is F, R² is cyano, R⁷ is Br and the combination of R⁵ and R⁶ for a compound corresponds in each case to one row of Table A;

Table 34 Compounds of the formula (IA-1) in which R¹ is Br, R² is cyano, R⁷ is Br and the combination of R⁵ and R⁶ for a compound corresponds in each case to one row of Table A;

Table 35 Compounds of the formula (IA-1) in which R¹ is Cl, R² is cyano, R⁷ is Br and the combination of R⁵ and R⁶ for a compound corresponds in each case to one row of Table A;

Table 36 Compounds of the formula (IA-1) in which R¹ is methyl, R² is cyano, R⁷ is Br and the combination of R⁵ and R⁶ for a compound corresponds in each case to one row of Table A;

Table 37 Compounds of the formula (IA-1) in which R¹ is F, R² is Cl, R⁷ is Cl and the combination of R⁵ and R⁶ for a compound corresponds in each case to one row of Table A;

Table 38 Compounds of the formula (IA-1) in which R¹ is Br, R² is Cl, R⁷ is Cl and the combination of R⁵ and R⁶ for a compound corresponds in each case to one row of Table A;

Table 39 Compounds of the formula (IA-1) in which R¹ is Cl, R² is Cl, R⁷ is Cl and the combination of R⁵ and R⁶ for a compound corresponds in each case to one row of Table A;

Table 40 Compounds of the formula (IA-1) in which R¹ is methyl, R² is Cl, R⁷ is Cl and the combination of R⁵ and R⁶ for a compound corresponds in each case to one row of Table A;

Table 41 Compounds of the formula (IA-1) in which R¹ is F, R² is Br, R⁷ is Cl and the combination of R⁵ and R⁶ for a compound corresponds in each case to one row of Table A;

Table 42 Compounds of the formula (IA-1) in which R¹ is Br, R² is Br, R⁷ is Cl and the combination of R⁵ and R⁶ for a compound corresponds in each case to one row of Table A;

Table 43 Compounds of the formula (IA-1) in which R¹ is Cl, R² is Br, R⁷ is Cl and the combination of R⁵ and R⁶ for a compound corresponds in each case to one row of Table A;

Table 44 Compounds of the formula (IA-1) in which R¹ is methyl, R² is Br, R⁷ is Cl and the combination of R⁵ and R⁶ for a compound corresponds in each case to one row of Table A;

Table 45 Compounds of the formula (IA-1) in which R¹ is F, R² is cyano, R⁷ is Cl and the combination of R⁵ and R⁶ for a compound corresponds in each case to one row of Table A;

Table 46 Compounds of the formula (IA-1) in which R¹ is Br, R² is cyano, R⁷ is Cl and the combination of R⁵ and R⁶ for a compound corresponds in each case to one row of Table A;

Table 47 Compounds of the formula (IA-1) in which R¹ is Cl, R² is cyano, R⁷ is Cl and the combination of R⁵ and R⁶ for a compound corresponds in each case to one row of Table A;

Table 48 Compounds of the formula (IA-1) in which R¹ is methyl, R² is cyano, R⁷ is Cl and the combination of R⁵ and R⁶ for a compound corresponds in each case to one row of Table A;

Table 49 Compounds of the formula (IA-1) in which R¹ is F, R² is Cl, R⁷ is OCHF₂ and the combination of R⁵ and R⁶ for a compound corresponds in each case to one row of Table A;

Table 50 Compounds of the formula (IA-1) in which R¹ is Br, R² is Cl, R⁷ is OCHF₂ and the combination of R⁵ and R⁶ for a compound corresponds in each case to one row of Table A;

Table 51 Compounds of the formula (IA-1) in which R¹ is Cl, R² is Cl, R⁷ is OCHF₂ and the combination of R⁵ and R⁶ for a compound corresponds in each case to one row of Table A;

Table 52 Compounds of the formula (IA-1) in which R¹ is methyl, R² is Cl, R⁷ is OCHF₂ and the combination of R⁵ and R⁶ for a compound corresponds in each case to one row of Table A;

Table 53 Compounds of the formula (IA-1) in which R¹ is F, R² is Br, R⁷ is OCHF₂ and the combination of R⁵ and R⁶ for a compound corresponds in each case to one row of Table A;

Table 54 Compounds of the formula (IA-1) in which R¹ is Br, R² is Br, R⁷ is OCHF₂ and the combination of R⁵ and R⁶ for a compound corresponds in each case to one row of Table A;

Table 55 Compounds of the formula (IA-1) in which R¹ is Cl, R² is Br, R⁷ is OCHF₂ and the combination of R⁵ and R⁶ for a compound corresponds in each case to one row of Table A;

Table 56 Compounds of the formula (IA-1) in which R¹ is methyl, R² is Br, R⁷ is OCHF₂ and the combination of R⁵ and R⁶ for a compound corresponds in each case to one row of Table A;

Table 57 Compounds of the formula (IA-1) in which R¹ is F, R² is cyano, R⁷ is OCHF₂ and the combination of R⁵ and R⁶ for a compound corresponds in each case to one row of Table A;

Table 58 Compounds of the formula (IA-1) in which R¹ is Br, R² is cyano, R⁷ is OCHF₂ and the combination of R⁵ and R⁶ for a compound corresponds in each case to one row of Table A;

Table 59 Compounds of the formula (IA-1) in which R¹ is Cl, R² is cyano, R⁷ is OCHF₂ and the combination of R⁵ and R⁶ for a compound corresponds in each case to one row of Table A;

Table 60 Compounds of the formula (IA-1) in which R¹ is methyl, R² is cyano, R⁷ is OCHF₂ and the combination of R⁵ and R⁶ for a compound corresponds in each case to one row of Table A.

TABLE A

| | R⁵ | R⁶ |
|---|---|---|
| A-1 | CH₃ | CH₃ |
| A-2 | C₂H₅ | CH₃ |
| A-3 | CH═CH₂ | CH₃ |
| A-4 | CH₂CH₂CH₃ | CH₃ |
| A-5 | CH(CH₃)₂ | CH₃ |
| A-6 | CH₂CH₂CH₂CH₃ | CH₃ |
| A-7 | C(CH₃)₃ | CH₃ |
| A-8 | CH₂CH(CH₃)₂ | CH₃ |
| A-9 | CH(CH₃)CH₂CH₃ | CH₃ |
| A-10 | CH₂CH═CH₂ | CH₃ |
| A-11 | CH₂C≡CH | CH₃ |
| A-12 | CH(CH₃)CH═CH₂ | CH₃ |
| A-13 | CHF₂ | CH₃ |
| A-14 | CH₂Cl | CH₃ |
| A-15 | CH₂CH₂CN | CH₃ |
| A-16 | CH₂CH₂Cl | CH₃ |
| A-17 | c-C₃H₅ | CH₃ |
| A-18 | c-C₄H₇ | CH₃ |
| A-19 | c-C₅H₉ | CH₃ |
| A-20 | c-C₆H₁₁ | CH₃ |
| A-21 | CH₂—c-C₃H₅ | CH₃ |
| A-22 | CH(CH₃)—c-C₃H₅ | CH₃ |
| A-23 | CH₂—c-C₅H₉ | CH₃ |
| A-24 | CH₂—c-C₆H₁₁ | CH₃ |
| A-25 | C₆H₅ | CH₃ |
| A-26 | CH₃ | C₂H₅ |
| A-27 | C₂H₅ | C₂H₅ |
| A-28 | CH═CH₂ | C₂H₅ |
| A-29 | CH₂CH₂CH₃ | C₂H₅ |
| A-30 | CH(CH₃)₂ | C₂H₅ |
| A-31 | CH₂CH₂CH₂CH₃ | C₂H₅ |
| A-32 | C(CH₃)₃ | C₂H₅ |
| A-33 | CH₂CH(CH₃)₂ | C₂H₅ |
| A-34 | CH(CH₃)CH₂CH₃ | C₂H₅ |
| A-35 | CH₂CH═CH₂ | C₂H₅ |
| A-36 | CH₂C≡CH | C₂H₅ |
| A-37 | CH(CH₃)CH═CH₂ | C₂H₅ |
| A-38 | CHF₂ | C₂H₅ |
| A-39 | CH₂Cl | C₂H₅ |
| A-40 | CH₂CH₂CN | C₂H₅ |
| A-41 | CH₂CH₂Cl | C₂H₅ |
| A-42 | c-C₃H₅ | C₂H₅ |
| A-43 | c-C₄H₇ | C₂H₅ |
| A-44 | c-C₅H₉ | C₂H₅ |
| A-45 | c-C₆H₁₁ | C₂H₅ |
| A-46 | CH₂—c-C₃H₅ | C₂H₅ |
| A-47 | CH(CH₃)—c-C₃H₅ | C₂H₅ |
| A-48 | CH₂—c-C₅H₉ | C₂H₅ |
| A-49 | CH₂—c-C₆H₁₁ | C₂H₅ |
| A-50 | C₆H₅ | C₂H₅ |
| A-51 | CH₃ | CH═CH₂ |
| A-52 | C₂H₅ | CH═CH₂ |
| A-53 | CH═CH₂ | CH═CH₂ |
| A-54 | CH₂CH₂CH₃ | CH═CH₂ |
| A-55 | CH(CH₃)₂ | CH═CH₂ |
| A-56 | CH₂CH₂CH₂CH₃ | CH═CH₂ |
| A-57 | C(CH₃)₃ | CH═CH₂ |
| A-58 | CH₂CH(CH₃)₂ | CH═CH₂ |
| A-59 | CH(CH₃)CH₂CH₃ | CH═CH₂ |
| A-60 | CH₂CH═CH₂ | CH═CH₂ |
| A-61 | CH₂C≡CH | CH═CH₂ |
| A-62 | CH(CH₃)CH═CH₂ | CH═CH₂ |
| A-63 | CHF₂ | CH═CH₂ |
| A-64 | CH₂Cl | CH═CH₂ |
| A-65 | CH₂CH₂CN | CH═CH₂ |
| A-66 | CH₂CH₂Cl | CH═CH₂ |
| A-67 | c-C₃H₅ | CH═CH₂ |
| A-68 | c-C₄H₇ | CH═CH₂ |
| A-69 | c-C₅H₉ | CH═CH₂ |
| A-70 | c-C₆H₁₁ | CH═CH₂ |
| A-71 | CH₂—c-C₃H₅ | CH═CH₂ |
| A-72 | CH(CH₃)—c-C₃H₅ | CH═CH₂ |
| A-73 | CH₂—c-C₅H₉ | CH═CH₂ |
| A-74 | CH₂—c-C₆H₁₁ | CH═CH₂ |
| A-75 | C₆H₅ | CH═CH₂ |
| A-76 | CH₃ | CH₂CH₂CH₃ |
| A-77 | C₂H₅ | CH₂CH₂CH₃ |
| A-78 | CH═CH₂ | CH₂CH₂CH₃ |
| A-79 | CH₂CH₂CH₃ | CH₂CH₂CH₃ |
| A-80 | CH(CH₃)₂ | CH₂CH₂CH₃ |
| A-81 | CH₂CH₂CH₂CH₃ | CH₂CH₂CH₃ |
| A-82 | C(CH₃)₃ | CH₂CH₂CH₃ |
| A-83 | CH₂CH(CH₃)₂ | CH₂CH₂CH₃ |
| A-84 | CH(CH₃)CH₂CH₃ | CH₂CH₂CH₃ |
| A-85 | CH₂CH═CH₂ | CH₂CH₂CH₃ |
| A-86 | CH₂C≡CH | CH₂CH₂CH₃ |
| A-87 | CH(CH₃)CH═CH₂ | CH₂CH₂CH₃ |
| A-88 | CHF₂ | CH₂CH₂CH₃ |
| A-89 | CH₂Cl | CH₂CH₂CH₃ |
| A-90 | CH₂CH₂CN | CH₂CH₂CH₃ |
| A-91 | CH₂CH₂Cl | CH₂CH₂CH₃ |
| A-92 | c-C₃H₅ | CH₂CH₂CH₃ |
| A-93 | c-C₄H₇ | CH₂CH₂CH₃ |
| A-94 | c-C₅H₉ | CH₂CH₂CH₃ |
| A-95 | c-C₆H₁₁ | CH₂CH₂CH₃ |
| A-96 | CH₂—c-C₃H₅ | CH₂CH₂CH₃ |
| A-97 | CH(CH₃)—c-C₃H₅ | CH₂CH₂CH₃ |
| A-98 | CH₂—c-C₅H₉ | CH₂CH₂CH₃ |
| A-99 | CH₂—c-C₆H₁₁ | CH₂CH₂CH₃ |
| A-100 | C₆H₅ | CH₂CH₂CH₃ |
| A-101 | CH₃ | CH(CH₃)₂ |
| A-102 | C₂H₅ | CH(CH₃)₂ |
| A-103 | CH═CH₂ | CH(CH₃)₂ |
| A-104 | CH₂CH₂CH₃ | CH(CH₃)₂ |
| A-105 | CH(CH₃)₂ | CH(CH₃)₂ |
| A-106 | CH₂CH₂CH₂CH₃ | CH(CH₃)₂ |
| A-107 | C(CH₃)₃ | CH(CH₃)₂ |
| A-108 | CH₂CH(CH₃)₂ | CH(CH₃)₂ |
| A-109 | CH(CH₃)CH₂CH₃ | CH(CH₃)₂ |
| A-110 | CH₂CH═CH₂ | CH(CH₃)₂ |
| A-111 | CH₂C≡CH | CH(CH₃)₂ |
| A-112 | CH(CH₃)CH═CH₂ | CH(CH₃)₂ |
| A-113 | CHF₂ | CH(CH₃)₂ |
| A-114 | CH₂Cl | CH(CH₃)₂ |
| A-115 | CH₂CH₂CN | CH(CH₃)₂ |
| A-116 | CH₂CH₂Cl | CH(CH₃)₂ |
| A-117 | c-C₃H₅ | CH(CH₃)₂ |
| A-118 | c-C₄H₇ | CH(CH₃)₂ |
| A-119 | c-C₅H₉ | CH(CH₃)₂ |
| A-120 | c-C₆H₁₁ | CH(CH₃)₂ |
| A-121 | CH₂—c-C₃H₅ | CH(CH₃)₂ |
| A-122 | CH(CH₃)—c-C₃H₅ | CH(CH₃)₂ |
| A-123 | CH₂—c-C₅H₉ | CH(CH₃)₂ |
| A-124 | CH₂—c-C₆H₁₁ | CH(CH₃)₂ |
| A-125 | C₆H₅ | CH(CH₃)₂ |
| A-126 | CH₃ | CH₂CH₂CH₂CH₃ |
| A-127 | C₂H₅ | CH₂CH₂CH₂CH₃ |
| A-128 | CH═CH₂ | CH₂CH₂CH₂CH₃ |
| A-129 | CH₂CH₂CH₃ | CH₂CH₂CH₂CH₃ |
| A-130 | CH(CH₃)₂ | CH₂CH₂CH₂CH₃ |
| A-131 | CH₂CH₂CH₂CH₃ | CH₂CH₂CH₂CH₃ |
| A-132 | C(CH₃)₃ | CH₂CH₂CH₂CH₃ |
| A-133 | CH₂CH(CH₃)₂ | CH₂CH₂CH₂CH₃ |
| A-134 | CH(CH₃)CH₂CH₃ | CH₂CH₂CH₂CH₃ |
| A-135 | CH₂CH═CH₂ | CH₂CH₂CH₂CH₃ |
| A-136 | CH₂C≡CH | CH₂CH₂CH₂CH₃ |
| A-137 | CH(CH₃)CH═CH₂ | CH₂CH₂CH₂CH₃ |
| A-138 | CHF₂ | CH₂CH₂CH₂CH₃ |
| A-139 | CH₂Cl | CH₂CH₂CH₂CH₃ |
| A-140 | CH₂CH₂CN | CH₂CH₂CH₂CH₃ |
| A-141 | CH₂CH₂Cl | CH₂CH₂CH₂CH₃ |
| A-142 | c-C₃H₅ | CH₂CH₂CH₂CH₃ |
| A-143 | c-C₄H₇ | CH₂CH₂CH₂CH₃ |
| A-144 | c-C₅H₉ | CH₂CH₂CH₂CH₃ |
| A-145 | c-C₆H₁₁ | CH₂CH₂CH₂CH₃ |
| A-146 | CH₂—c-C₃H₅ | CH₂CH₂CH₂CH₃ |
| A-147 | CH(CH₃)—c-C₃H₅ | CH₂CH₂CH₂CH₃ |
| A-148 | CH₂—c-C₅H₉ | CH₂CH₂CH₂CH₃ |
| A-149 | CH₂—c-C₆H₁₁ | CH₂CH₂CH₂CH₃ |
| A-150 | C₆H₅ | CH₂CH₂CH₂CH₃ |
| A-151 | CH₃ | C(CH₃)₃ |
| A-152 | C₂H₅ | C(CH₃)₃ |
| A-153 | CH═CH₂ | C(CH₃)₃ |
| A-154 | CH₂CH₂CH₃ | C(CH₃)₃ |
| A-155 | CH(CH₃)₂ | C(CH₃)₃ |
| A-156 | CH₂CH₂CH₂CH₃ | C(CH₃)₃ |
| A-157 | C(CH₃)₃ | C(CH₃)₃ |
| A-158 | CH₂CH(CH₃)₂ | C(CH₃)₃ |
| A-159 | CH(CH₃)CH₂CH₃ | C(CH₃)₃ |
| A-160 | CH₂CH═CH₂ | C(CH₃)₃ |
| A-161 | CH₂C≡CH | C(CH₃)₃ |
| A-162 | CH(CH₃)CH═CH₂ | C(CH₃)₃ |
| A-163 | CHF₂ | C(CH₃)₃ |
| A-164 | CH₂Cl | C(CH₃)₃ |
| A-165 | CH₂CH₂CN | C(CH₃)₃ |
| A-166 | CH₂CH₂Cl | C(CH₃)₃ |
| A-167 | c-C₃H₅ | C(CH₃)₃ |
| A-168 | c-C₄H₇ | C(CH₃)₃ |
| A-169 | c-C₅H₉ | C(CH₃)₃ |
| A-170 | c-C₆H₁₁ | C(CH₃)₃ |
| A-171 | CH₂—c-C₃H₅ | C(CH₃)₃ |
| A-172 | CH(CH₃)—c-C₃H₅ | C(CH₃)₃ |
| A-173 | CH₂—c-C₅H₉ | C(CH₃)₃ |
| A-174 | CH₂—c-C₆H₁₁ | C(CH₃)₃ |
| A-175 | C₆H₅ | C(CH₃)₃ |
| A-176 | CH₃ | CH₂CH(CH₃)₂ |
| A-177 | C₂H₅ | CH₂CH(CH₃)₂ |
| A-178 | CH═CH₂ | CH₂CH(CH₃)₂ |
| A-179 | CH₂CH₂CH₃ | CH₂CH(CH₃)₂ |
| A-180 | CH(CH₃)₂ | CH₂CH(CH₃)₂ |
| A-181 | CH₂CH₂CH₂CH₃ | CH₂CH(CH₃)₂ |
| A-182 | C(CH₃)₃ | CH₂CH(CH₃)₂ |
| A-183 | CH₂CH(CH₃)₂ | CH₂CH(CH₃)₂ |
| A-184 | CH(CH₃)CH₂CH₃ | CH₂CH(CH₃)₂ |
| A-185 | CH₂CH═CH₂ | CH₂CH(CH₃)₂ |
| A-186 | CH₂C≡CH | CH₂CH(CH₃)₂ |
| A-187 | CH(CH₃)CH═CH₂ | CH₂CH(CH₃)₂ |
| A-188 | CHF₂ | CH₂CH(CH₃)₂ |
| A-189 | CH₂Cl | CH₂CH(CH₃)₂ |
| A-190 | CH₂CH₂CN | CH₂CH(CH₃)₂ |
| A-191 | CH₂CH₂Cl | CH₂CH(CH₃)₂ |
| A-192 | c-C₃H₅ | CH₂CH(CH₃)₂ |
| A-193 | c-C₄H₇ | CH₂CH(CH₃)₂ |
| A-194 | c-C₅H₉ | CH₂CH(CH₃)₂ |
| A-195 | c-C₆H₁₁ | CH₂CH(CH₃)₂ |
| A-196 | CH₂—c-C₃H₅ | CH₂CH(CH₃)₂ |
| A-197 | CH(CH₃)—c-C₃H₅ | CH₂CH(CH₃)₂ |
| A-198 | CH₂—c-C₅H₉ | CH₂CH(CH₃)₂ |
| A-199 | CH₂—c-C₆H₁₁ | CH₂CH(CH₃)₂ |
| A-200 | C₆H₅ | CH₂CH(CH₃)₂ |
| A-201 | CH₃ | CH(CH₃)CH₂CH₃ |
| A-202 | C₂H₅ | CH(CH₃)CH₂CH₃ |
| A-203 | CH═CH₂ | CH(CH₃)CH₂CH₃ |
| A-204 | CH₂CH₂CH₃ | CH(CH₃)CH₂CH₃ |
| A-205 | CH(CH₃)₂ | CH(CH₃)CH₂CH₃ |
| A-206 | CH₂CH₂CH₂CH₃ | CH(CH₃)CH₂CH₃ |
| A-207 | C(CH₃)₃ | CH(CH₃)CH₂CH₃ |
| A-208 | CH₂CH(CH₃)₂ | CH(CH₃)CH₂CH₃ |
| A-209 | CH(CH₃)CH₂CH₃ | CH(CH₃)CH₂CH₃ |
| A-210 | CH₂CH═CH₂ | CH(CH₃)CH₂CH₃ |
| A-211 | CH₂C≡CH | CH(CH₃)CH₂CH₃ |
| A-212 | CH(CH₃)CH═CH₂ | CH(CH₃)CH₂CH₃ |
| A-213 | CHF₂ | CH(CH₃)CH₂CH₃ |
| A-214 | CH₂Cl | CH(CH₃)CH₂CH₃ |
| A-215 | CH₂CH₂CN | CH(CH₃)CH₂CH₃ |
| A-216 | CH₂CH₂Cl | CH(CH₃)CH₂CH₃ |
| A-217 | c-C₃H₅ | CH(CH₃)CH₂CH₃ |
| A-218 | c-C₄H₇ | CH(CH₃)CH₂CH₃ |
| A-219 | c-C₅H₉ | CH(CH₃)CH₂CH₃ |
| A-220 | c-C₆H₁₁ | CH(CH₃)CH₂CH₃ |
| A-221 | CH₂—c-C₃H₅ | CH(CH₃)CH₂CH₃ |
| A-222 | CH(CH₃)—c-C₃H₅ | CH(CH₃)CH₂CH₃ |
| A-223 | CH₂—c-C₅H₉ | CH(CH₃)CH₂CH₃ |
| A-224 | CH₂—c-C₆H₁₁ | CH(CH₃)CH₂CH₃ |
| A-225 | C₆H₅ | CH(CH₃)CH₂CH₃ |
| A-226 | CH₃ | CH₂CH═CH₂ |
| A-227 | C₂H₅ | CH₂CH═CH₂ |
| A-228 | CH═CH₂ | CH₂CH═CH₂ |
| A-229 | CH₂CH₂CH₃ | CH₂CH═CH₂ |
| A-230 | CH(CH₃)₂ | CH₂CH═CH₂ |
| A-231 | CH₂CH₂CH₂CH₃ | CH₂CH═CH₂ |
| A-232 | C(CH₃)₃ | CH₂CH═CH₂ |
| A-233 | CH₂CH(CH₃)₂ | CH₂CH═CH₂ |
| A-234 | CH(CH₃)CH₂CH₃ | CH₂CH═CH₂ |
| A-235 | CH₂CH═CH₂ | CH₂CH═CH₂ |
| A-236 | CH₂C≡CH | CH₂CH═CH₂ |
| A-237 | CH(CH₃)CH═CH₂ | CH₂CH═CH₂ |
| A-238 | CHF₂ | CH₂CH═CH₂ |
| A-239 | CH₂Cl | CH₂CH═CH₂ |
| A-240 | CH₂CH₂CN | CH₂CH═CH₂ |
| A-241 | CH₂CH₂Cl | CH₂CH═CH₂ |
| A-242 | c-C₃H₅ | CH₂CH═CH₂ |
| A-243 | c-C₄H₇ | CH₂CH═CH₂ |
| A-244 | c-C₅H₉ | CH₂CH═CH₂ |
| A-245 | c-C₆H₁₁ | CH₂CH═CH₂ |
| A-246 | CH₂—c-C₃H₅ | CH₂CH═CH₂ |
| A-247 | CH(CH₃)—c-C₃H₅ | CH₂CH═CH₂ |
| A-248 | CH₂—c-C₅H₉ | CH₂CH═CH₂ |
| A-249 | CH₂—c-C₆H₁₁ | CH₂CH═CH₂ |
| A-250 | C₆H₅ | CH₂CH═CH₂ |
| A-251 | CH₃ | CH₂C≡CH |
| A-252 | C₂H₅ | CH₂C≡CH |
| A-253 | CH═CH₂ | CH₂C≡CH |
| A-254 | CH₂CH₂CH₃ | CH₂C≡CH |
| A-255 | CH(CH₃)₂ | CH₂C≡CH |
| A-256 | CH₂CH₂CH₂CH₃ | CH₂C≡CH |
| A-257 | C(CH₃)₃ | CH₂C≡CH |
| A-258 | CH₂CH(CH₃)₂ | CH₂C≡CH |
| A-259 | CH(CH₃)CH₂CH₃ | CH₂C≡CH |
| A-260 | CH₂CH═CH₂ | CH₂C≡CH |
| A-261 | CH2C≡CH | CH₂C≡CH |
| A-262 | CH(CH₃)CH═CH₂ | CH₂C≡CH |
| A-263 | CHF₂ | CH₂C≡CH |
| A-264 | CH₂Cl | CH₂C≡CH |
| A-265 | CH₂CH₂CN | CH₂C≡CH |
| A-266 | CH₂CH₂Cl | CH₂C≡CH |
| A-267 | c-C₃H₅ | CH₂C≡CH |
| A-268 | c-C₄H₇ | CH₂C≡CH |
| A-269 | c-C₅H₉ | CH₂C≡CH |
| A-270 | c-C₆H₁₁ | CH₂C≡CH |
| A-271 | CH₂—c-C₃H₅ | CH₂C≡CH |
| A-272 | CH(CH₃)—c-C₃H₅ | CH₂C≡CH |
| A-273 | CH₂—c-C₅H₉ | CH₂C≡CH |
| A-274 | CH₂—c-C₆H₁₁ | CH₂C≡CH |
| A-275 | C₆H₅ | CH₂C≡CH |
| A-276 | CH₃ | CH(CH₃)CH═CH₂ |
| A-277 | C₂H₅ | CH(CH₃)CH═CH₂ |
| A-278 | CH═CH₂ | CH(CH₃)CH═CH₂ |
| A-279 | CH₂CH₂CH₃ | CH(CH₃)CH═CH₂ |
| A-280 | CH(CH₃)₂ | CH(CH₃)CH═CH₂ |
| A-281 | CH₂CH₂CH₂CH₃ | CH(CH₃)CH═CH₂ |
| A-282 | C(CH₃)₃ | CH(CH₃)CH═CH₂ |
| A-283 | CH₂CH(CH₃)₂ | CH(CH₃)CH═CH₂ |
| A-284 | CH(CH₃)CH₂CH₃ | CH(CH₃)CH═CH₂ |
| A-285 | CH₂CH═CH₂ | CH(CH₃)CH═CH₂ |
| A-286 | CH₂C≡CH | CH(CH₃)CH═CH₂ |
| A-287 | CH(CH₃)CH═CH₂ | CH(CH₃)CH═CH₂ |
| A-288 | CHF₂ | CH(CH₃)CH═CH₂ |
| A-289 | CH₂Cl | CH(CH₃)CH═CH₂ |
| A-290 | CH₂CH₂CN | CH(CH₃)CH═CH₂ |
| A-291 | CH₂CH₂Cl | CH(CH₃)CH═CH₂ |
| A-292 | c-C₃H₅ | CH(CH₃)CH═CH₂ |
| A-293 | c-C₄H₇ | CH(CH₃)CH═CH₂ |
| A-294 | c-C₅H₉ | CH(CH₃)CH═CH₂ |
| A-295 | c-C₆H₁₁ | CH(CH₃)CH═CH₂ |
| A-296 | CH₂—c-C₃H₅ | CH(CH₃)CH═CH₂ |
| A-297 | CH(CH₃)—c-C₃H₅ | CH(CH₃)CH═CH₂ |
| A-298 | CH₂—c-C₅H₉ | CH(CH₃)CH═CH₂ |
| A-299 | CH₂—c-C₅H₉ | CH(CH₃)CH═CH₂ |
| A-300 | C₆H₅ | CH(CH₃)CH═CH₂ |
| A-301 | CH₃ | CHF₂ |
| A-302 | C₂H₅ | CHF₂ |
| A-303 | CH═CH₂ | CHF₂ |
| A-304 | CH₂CH₂CH₃ | CHF₂ |
| A-305 | CH(CH₃)₂ | CHF₂ |
| A-306 | CH₂CH₂CH₂CH₃ | CHF₂ |
| A-307 | C(CH₃)₃ | CHF₂ |
| A-308 | CH₂CH(CH₃)₂ | CHF₂ |
| A-309 | CH(CH₃)CH₂CH₃ | CHF₂ |
| A-310 | CH₂CH═CH₂ | CHF₂ |
| A-311 | CH₂C≡CH | CHF₂ |
| A-312 | CH(CH₃)CH═CH₂ | CHF₂ |
| A-313 | CHF₂ | CHF₂ |
| A-314 | CH₂Cl | CHF₂ |
| A-315 | CH₂CH₂CN | CHF₂ |
| A-316 | CH₂CH₂Cl | CHF₂ |
| A-317 | c-C₃H₅ | CHF₂ |
| A-318 | c-C₄H₇ | CHF₂ |
| A-319 | c-C₅H₉ | CHF₂ |
| A-320 | c-C₆H₁₁ | CHF₂ |
| A-321 | CH₂—c-C₃H₅ | CHF₂ |
| A-322 | CH(CH₃)—c-C₃H₅ | CHF₂ |
| A-323 | CH₂—c-C₅H₉ | CHF₂ |
| A-324 | CH₂—c-C₆H₁₁ | CHF₂ |
| A-325 | C₆H₅ | CHF₂ |
| A-326 | CH₃ | CH₂Cl |
| A-327 | C₂H₅ | CH₂Cl |
| A-328 | CH═CH₂ | CH₂Cl |
| A-329 | CH₂CH₂CH₃ | CH₂Cl |
| A-330 | CH(CH₃)₂ | CH₂Cl |
| A-331 | CH₂CH₂CH₂CH₃ | CH₂Cl |
| A-332 | C(CH₃)₃ | CH₂Cl |
| A-333 | CH₂CH(CH₃)₂ | CH₂Cl |
| A-334 | CH(CH₃)CH₂CH₃ | CH₂Cl |
| A-335 | CH₂CH═CH₂ | CH₂Cl |
| A-336 | CH₂C≡CH | CH₂Cl |
| A-337 | CH(CH₃)CH═CH₂ | CH₂Cl |
| A-338 | CHF₂ | CH₂Cl |
| A-339 | CH₂Cl | CH₂Cl |
| A-340 | CH₂CH₂CN | CH₂Cl |
| A-341 | CH₂CH₂Cl | CH₂Cl |
| A-342 | c-C₃H₅ | CH₂Cl |
| A-343 | c-C₄H₇ | CH₂Cl |
| A-344 | c-C₅H₉ | CH₂Cl |
| A-345 | c-C₆H₁₁ | CH₂Cl |
| A-346 | CH₂—c-C₃H₅ | CH₂Cl |
| A-347 | CH(CH₃)—c-C₃H₅ | CH₂Cl |
| A-348 | CH₂—c-C₅H₉ | CH₂Cl |
| A-349 | CH₂—c-C₆H₁₁ | CH₂Cl |
| A-350 | C₆H₅ | CH₂Cl |
| A-351 | CH₃ | CH₂CH₂CN |
| A-352 | C₂H₅ | CH₂CH₂CN |
| A-353 | CH═CH₂ | CH₂CH₂CN |
| A-354 | CH₂CH₂CH₃ | CH₂CH₂CN |
| A-355 | CH(CH₃)₂ | CH₂CH₂CN |
| A-356 | CH₂CH₂CH₂CH₃ | CH₂CH₂CN |
| A-357 | C(CH₃)₃ | CH₂CH₂CN |
| A-358 | CH₂CH(CH₃)₂ | CH₂CH₂CN |
| A-359 | CH(CH₃)CH₂CH₃ | CH₂CH₂CN |
| A-360 | CH₂CH═CH₂ | CH₂CH₂CN |
| A-361 | CH₂C≡CH | CH₂CH₂CN |
| A-362 | CH(CH₃)CH═CH₂ | CH₂CH₂CN |
| A-363 | CHF₂ | CH₂CH₂CN |
| A-364 | CH₂Cl | CH₂CH₂CN |
| A-365 | CH₂CH₂CN | CH₂CH₂CN |
| A-366 | CH₂CH₂Cl | CH₂CH₂CN |
| A-367 | c-C₃H₅ | CH₂CH₂CN |
| A-368 | c-C₄H₇ | CH₂CH₂CN |
| A-369 | c-C₅H₉ | CH₂CH₂CN |
| A-370 | c-C₆H₁₁ | CH₂CH₂CN |
| A-371 | CH₂—c-C₃H₅ | CH₂CH₂CN |
| A-372 | CH(CH₃)—c-C₃H₅ | CH₂CH₂CN |
| A-373 | CH₂—c-C₅H₉ | CH₂CH₂CN |
| A-374 | CH₂—c-C₅H₉ | CH₂CH₂CN |
| A-375 | C₆H₅ | CH₂CH₂CN |
| A-376 | CH₃ | CH₂CH₂Cl |
| A-377 | C₂H₅ | CH₂CH₂Cl |
| A-378 | CH═CH₂ | CH₂CH₂Cl |
| A-379 | CH₂CH₂CH₃ | CH₂CH₂Cl |
| A-380 | CH(CH₃)₂ | CH₂CH₂Cl |
| A-381 | CH₂CH₂CH₂CH₃ | CH₂CH₂Cl |
| A-382 | C(CH₃)₃ | CH₂CH₂Cl |
| A-383 | CH₂CH(CH₃)₂ | CH₂CH₂Cl |
| A-384 | CH(CH₃)CH₂CH₃ | CH₂CH₂Cl |
| A-385 | CH₂CH═CH₂ | CH₂CH₂Cl |
| A-386 | CH₂C≡CH | CH₂CH₂Cl |
| A-387 | CH(CH₃)CH═CH₂ | CH₂CH₂Cl |
| A-388 | CHF₂ | CH₂CH₂Cl |
| A-389 | CH₂Cl | CH₂CH₂Cl |
| A-390 | CH₂CH₂CN | CH₂CH₂Cl |
| A-391 | CH₂CH₂Cl | CH₂CH₂Cl |
| A-392 | c-C₃H₅ | CH₂CH₂Cl |
| A-393 | c-C₄H₇ | CH₂CH₂Cl |
| A-394 | c-C₅H₉ | CH₂CH₂Cl |
| A-395 | c-C₆H₁₁ | CH₂CH₂Cl |
| A-396 | CH₂—c-C₃H₅ | CH₂CH₂Cl |
| A-397 | CH(CH₃)—c-C₃H₅ | CH₂CH₂Cl |
| A-398 | CH₂—c-C₅H₉ | CH₂CH₂Cl |
| A-399 | CH₂—c-C₆H₁₁ | CH₂CH₂Cl |
| A-400 | C₆H₅ | CH₂CH₂Cl |
| A-401 | CH₃ | c-C₃H₅ |
| A-402 | C₂H₅ | c-C₃H₅ |
| A-403 | CH═CH₂ | c-C₃H₅ |
| A-404 | CH₂CH₂CH₃ | c-C₃H₅ |
| A-405 | CH(CH₃)₂ | c-C₃H₅ |
| A-406 | CH₂CH₂CH₂CH₃ | c-C₃H₅ |
| A-407 | C(CH₃)₃ | c-C₃H₅ |
| A-408 | CH₂CH(CH₃)₂ | c-C₃H₅ |
| A-409 | CH(CH₃)CH₂CH₃ | c-C₃H₅ |
| A-410 | CH₂CH═CH₂ | c-C₃H₅ |
| A-411 | CH₂C≡CH | c-C₃H₅ |
| A-412 | CH(CH₃)CH═CH₂ | c-C₃H₅ |
| A-413 | CHF₂ | c-C₃H₅ |
| A-414 | CH₂Cl | c-C₃H₅ |
| A-415 | CH₂CH₂CN | c-C₃H₅ |
| A-416 | CH₂CH₂Cl | c-C₃H₅ |
| A-417 | c-C₃H₅ | c-C₃H₅ |
| A-418 | c-C₄H₇ | c-C₃H₅ |
| A-419 | c-C₅H₉ | c-C₃H₅ |
| A-420 | c-C₆H₁₁ | c-C₃H₅ |
| A-421 | CH₂—c-C₃H₅ | c-C₃H₅ |
| A-422 | CH(CH₃)—c-C₃H₅ | c-C₃H₅ |
| A-423 | CH₂—c-C₅H₉ | c-C₃H₅ |
| A-424 | CH₂—c-C₆H₁₁ | c-C₃H₅ |
| A-425 | C₆H₅ | c-C₃H₅ |
| A-426 | CH₃ | c-C₄H₇ |
| A-427 | C₂H₅ | c-C₄H₇ |
| A-428 | CH═CH₂ | c-C₄H₇ |
| A-429 | CH₂CH₂CH₃ | c-C₄H₇ |
| A-430 | CH(CH₃)₂ | c-C₄H₇ |
| A-431 | CH₂CH₂CH₂CH₃ | c-C₄H₇ |
| A-432 | C(CH₃)₃ | c-C₄H₇ |
| A-433 | CH₂CH(CH₃)₂ | c-C₄H₇ |
| A-434 | CH(CH₃)CH₂CH₃ | c-C₄H₇ |
| A-435 | CH₂CH═CH₂ | c-C₄H₇ |
| A-436 | CH₂C≡CH | c-C₄H₇ |
| A-437 | CH(CH₃)CH═CH₂ | c-C₄H₇ |
| A-438 | CHF₂ | c-C₄H₇ |
| A-439 | CH₂Cl | c-C₄H₇ |
| A-440 | CH₂CH₂CN | c-C₄H₇ |
| A-441 | CH₂CH₂Cl | c-C₄H₇ |
| A-442 | c-C₃H₅ | c-C₄H₇ |
| A-443 | c-C₄H₇ | c-C₄H₇ |
| A-444 | c-C₅H₉ | c-C₄H₇ |
| A-445 | c-C₆H₁₁ | c-C₄H₇ |
| A-446 | CH₂—c-C₃H₅ | c-C₄H₇ |
| A-447 | CH(CH₃)—c-C₃H₅ | c-C₄H₇ |
| A-448 | CH₂—c-C₅H₉ | c-C₄H₇ |
| A-449 | CH₂—c-C₆H₁₁ | c-C₄H₇ |
| A-450 | C₆H₅ | c-C₄H₇ |
| A-451 | CH₃ | c-C₅H₉ |
| A-452 | C₂H₅ | c-C₅H₉ |
| A-453 | CH═CH₂ | c-C₅H₉ |
| A-454 | CH₂CH₂CH₃ | c-C₅H₉ |
| A-455 | CH(CH₃)₂ | c-C₅H₉ |
| A-456 | CH₂CH₂CH₂CH₃ | c-C₅H₉ |
| A-457 | C(CH₃)₃ | c-C₅H₉ |
| A-458 | CH₂CH(CH₃)₂ | c-C₅H₉ |
| A-459 | CH(CH₃)CH₂CH₃ | c-C₅H₉ |
| A-460 | CH₂CH═CH₂ | c-C₅H₉ |
| A-461 | CH₂C≡CH | c-C₅H₉ |
| A-462 | CH(CH₃)CH═CH₂ | c-C₅H₉ |
| A-463 | CHF₂ | c-C₅H₉ |
| A-464 | CH₂Cl | c-C₅H₉ |
| A-465 | CH₂CH₂CN | c-C₅H₉ |
| A-466 | CH₂CH₂Cl | c-C₅H₉ |
| A-467 | c-C₃H₅ | c-C₅H₉ |
| A-468 | c-C₄H₇ | c-C₅H₉ |
| A-469 | c-C₅H₉ | c-C₅H₉ |
| A-470 | c-C₆H₁₁ | c-C₅H₉ |
| A-471 | CH₂—c-C₃H₅ | c-C₅H₉ |
| A-472 | CH(CH₃)—c-C₃H₅ | c-C₅H₉ |
| A-473 | CH₂—c-C₅H₉ | c-C₅H₉ |
| A-474 | CH₂—c-C₆H₁₁ | c-C₅H₉ |
| A-475 | C₆H₅ | c-C₅H₉ |
| A-476 | CH₃ | c-C₆H₁₁ |
| A-477 | C₂H₅ | c-C₆H₁₁ |
| A-478 | CH═CH₂ | c-C₆H₁₁ |
| A-479 | CH₂CH₂CH₃ | c-C₆H₁₁ |
| A-480 | CH(CH₃)₂ | c-C₆H₁₁ |
| A-481 | CH₂CH₂CH₂CH₃ | c-C₆H₁₁ |
| A-482 | C(CH₃)₃ | c-C₆H₁₁ |
| A-483 | CH₂CH(CH₃)₂ | c-C₆H₁₁ |
| A-484 | CH(CH₃)CH₂CH₃ | c-C₆H₁₁ |
| A-485 | CH₂CH═CH₂ | c-C₆H₁₁ |
| A-486 | CH₂C≡CH | c-C₆H₁₁ |
| A-487 | CH(CH₃)CH═CH₂ | c-C₆H₁₁ |
| A-488 | CHF₂ | c-C₆H₁₁ |
| A-489 | CH₂Cl | c-C₆H₁₁ |
| A-490 | CH₂CH₂CN | c-C₆H₁₁ |
| A-491 | CH₂CH₂Cl | c-C₆H₁₁ |
| A-492 | c-C₃H₅ | c-C₆H₁₁ |
| A-493 | c-C₄H₇ | c-C₆H₁₁ |
| A-494 | c-C₅H₉ | c-C₆H₁₁ |
| A-495 | c-C₆H₁₁ | c-C₆H₁₁ |
| A-496 | CH₂—c-C₃H₅ | c-C₆H₁₁ |
| A-497 | CH(CH₃)—c-C₃H₅ | c-C₆H₁₁ |
| A-498 | CH₂—c-C₅H₉ | c-C₆H₁₁ |
| A-499 | CH₂—c-C₆H₁₁ | c-C₆H₁₁ |
| A-500 | C₆H₅ | c-C₆H₁₁ |
| A-501 | CH₃ | CH₂—c-C₃H₅ |
| A-502 | C₂H₅ | CH₂—c-C₃H₅ |
| A-503 | CH═CH₂ | CH₂—c-C₃H₅ |
| A-504 | CH₂CH₂CH₃ | CH₂—c-C₃H₅ |
| A-505 | CH(CH₃)₂ | CH₂—c-C₃H₅ |
| A-506 | CH₂CH₂CH₂CH₃ | CH₂—c-C₃H₅ |
| A-507 | C(CH₃)₃ | CH₂—c-C₃H₅ |
| A-508 | CH₂CH(CH₃)₂ | CH₂—c-C₃H₅ |
| A-509 | CH(CH₃)CH₂CH₃ | CH₂—c-C₃H₅ |
| A-510 | CH₂CH═CH₂ | CH₂—c-C₃H₅ |
| A-511 | CH₂C≡CH | CH₂—c-C₃H₅ |
| A-512 | CH(CH₃)CH═CH₂ | CH₂—c-C₃H₅ |
| A-513 | CHF₂ | CH₂—c-C₃H₅ |
| A-514 | CH₂Cl | CH₂—c-C₃H₅ |
| A-515 | CH₂CH₂CN | CH₂—c-C₃H₅ |
| A-516 | CH₂CH₂Cl | CH₂—c-C₃H₅ |
| A-517 | c-C₃H₅ | CH₂—c-C₃H₅ |
| A-518 | c-C₄H₇ | CH₂—c-C₃H₅ |
| A-519 | c-C₅H₉ | CH₂—c-C₃H₅ |
| A-520 | c-C₆H₁₁ | CH₂—c-C₃H₅ |
| A-521 | CH₂—c-C₃H₅ | CH₂—c-C₃H₅ |
| A-522 | CH(CH₃)—c-C₃H₅ | CH₂—c-C₃H₅ |
| A-523 | CH₂—c-C₅H₉ | CH₂—c-C₃H₅ |
| A-524 | CH₂—c-C₆H₁₁ | CH₂—c-C₃H₅ |
| A-525 | C₆H₅ | CH₂—c-C₃H₅ |
| A-526 | CH₃ | CH(CH₃)—c-C₃H₅ |
| A-527 | C₂H₅ | CH(CH₃)—c-C₃H₅ |
| A-528 | CH═CH₂ | CH(CH₃)—c-C₃H₅ |
| A-529 | CH₂CH₂CH₃ | CH(CH₃)—c-C₃H₅ |
| A-530 | CH(CH₃)₂ | CH(CH₃)—c-C₃H₅ |
| A-531 | CH₂CH₂CH₂CH₃ | CH(CH₃)—c-C₃H₅ |
| A-532 | C(CH₃)₃ | CH(CH₃)—c-C₃H₅ |
| A-533 | CH₂CH(CH₃)₂ | CH(CH₃)—c-C₃H₅ |
| A-534 | CH(CH₃)CH₂CH₃ | CH(CH₃)—c-C₃H₅ |
| A-535 | CH₂CH═CH₂ | CH(CH₃)—c-C₃H₅ |
| A-536 | CH₂C≡CH | CH(CH₃)—c-C₃H₅ |
| A-537 | CH(CH₃)CH═CH₂ | CH(CH₃)—c-C₃H₅ |
| A-538 | CHF₂ | CH(CH₃)—c-C₃H₅ |
| A-539 | CH₂Cl | CH(CH₃)—c-C₃H₅ |
| A-540 | CH₂CH₂CN | CH(CH₃)—c-C₃H₅ |
| A-541 | CH₂CH₂Cl | CH(CH₃)—c-C₃H₅ |
| A-542 | c-C₃H₅ | CH(CH₃)—c-C₃H₅ |
| A-543 | c-C₄H₇ | CH(CH₃)—c-C₃H₅ |
| A-544 | c-C₅H₉ | CH(CH₃)—c-C₃H₅ |
| A-545 | c-C₆H₁₁ | CH(CH₃)—c-C₃H₅ |
| A-546 | CH₂—c-C₃H₅ | CH(CH₃)—c-C₃H₅ |
| A-547 | CH(CH₃)—c-C₃H₅ | CH(CH₃)—c-C₃H₅ |
| A-548 | CH₂—c-C₅H₉ | CH(CH₃)—c-C₃H₅ |
| A-549 | CH₂—c-C₆H₁₁ | CH(CH₃)—c-C₃H₅ |
| A-550 | C₆H₅ | CH(CH₃)—c-C₃H₅ |
| A-551 | CH₃ | CH₂—c-C₅H₉ |
| A-552 | C₂H₅ | CH₂—c-C₅H₉ |
| A-553 | CH═CH₂ | CH₂—c-C₅H₉ |
| A-554 | CH₂CH₂CH₃ | CH₂—c-C₅H₉ |
| A-555 | CH(CH₃)₂ | CH₂—c-C₅H₉ |
| A-556 | CH₂CH₂CH₂CH₃ | CH₂—c-C₅H₉ |
| A-557 | C(CH₃)₃ | CH₂—c-C₅H₉ |
| A-558 | CH₂CH(CH₃)₂ | CH₂—c-C₅H₉ |
| A-559 | CH(CH₃)CH₂CH₃ | CH₂—c-C₅H₉ |
| A-560 | CH₂CH═CH₂ | CH₂—c-C₅H₉ |
| A-561 | CH₂C≡CH | CH₂—c-C₅H₉ |
| A-562 | CH(CH₃)CH═CH₂ | CH₂—c-C₅H₉ |
| A-563 | CHF₂ | CH₂—c-C₅H₉ |
| A-564 | CH₂Cl | CH₂—c-C₅H₉ |
| A-565 | CH₂CH₂CN | CH₂—c-C₅H₉ |
| A-566 | CH₂CH₂Cl | CH₂—c-C₅H₉ |
| A-567 | c-C₃H₅ | CH₂—c-C₅H₉ |
| A-568 | c-C₄H₇ | CH₂—c-C₅H₉ |
| A-569 | c-C₅H₉ | CH₂—c-C₅H₉ |
| A-570 | c-C₆H₁₁ | CH₂—c-C₅H₉ |
| A-571 | CH₂—c-C₃H₅ | CH₂—c-C₅H₉ |
| A-572 | CH(CH₃)—c-C₃H₅ | CH₂—c-C₅H₉ |
| A-573 | CH₂—c-C₅H₉ | CH₂—c-C₅H₉ |
| A-574 | CH₂—c-C₆H₁₁ | CH₂—c-C₅H₉ |
| A-575 | C₆H₅ | CH₂—c-C₅H₉ |
| A-576 | CH₃ | CH₂—c-C₆H₁₁ |
| A-577 | C₂H₅ | CH₂—c-C₆H₁₁ |
| A-578 | CH═CH₂ | CH₂—c-C₆H₁₁ |
| A-579 | CH₂CH₂CH₃ | CH₂—c-C₆H₁₁ |
| A-580 | CH(CH₃)₂ | CH₂—c-C₆H₁₁ |
| A-581 | CH₂CH₂CH₂CH₃ | CH₂—c-C₆H₁₁ |
| A-582 | C(CH₃)₃ | CH₂—c-C₆H₁₁ |
| A-583 | CH₂CH(CH₃)₂ | CH₂—c-C₆H₁₁ |
| A-584 | CH(CH₃)CH₂CH₃ | CH₂—c-C₆H₁₁ |
| A-585 | CH₂CH═CH₂ | CH₂—c-C₆H₁₁ |
| A-586 | CH₂C≡CH | CH₂—c-C₆H₁₁ |
| A-587 | CH(CH₃)CH═CH₂ | CH₂—c-C₆H₁₁ |
| A-588 | CHF₂ | CH₂—c-C₆H₁₁ |
| A-589 | CH₂Cl | CH₂—c-C₆H₁₁ |
| A-590 | CH₂CH₂CN | CH₂—c-C₆H₁₁ |
| A-591 | CH₂CH₂Cl | CH₂—c-C₆H₁₁ |
| A-592 | c-C₃H₅ | CH₂—c-C₆H₁₁ |
| A-593 | c-C₄H₇ | CH₂—c-C₆H₁₁ |
| A-594 | c-C₅H₉ | CH₂—c-C₆H₁₁ |
| A-595 | c-C₆H₁₁ | CH₂—c-C₆H₁₁ |
| A-596 | CH₂—c-C₃H₅ | CH₂—c-C₆H₁₁ |
| A-597 | CH(CH₃)—c-C₃H₅ | CH₂—c-C₆H₁₁ |
| A-598 | CH₂—c-C₅H₉ | CH₂—c-C₆H₁₁ |
| A-599 | CH₂—c-C₆H₁₁ | CH₂—c-C₆H₁₁ |
| A-600 | C₆H₅ | CH₂—c-C₆H₁₁ |
| A-601 | CH₃ | C₆H₅ |
| A-602 | C₂H₅ | C₆H₅ |
| A-603 | CH═CH₂ | C₆H₅ |
| A-604 | CH₂CH₂CH₃ | C₆H₅ |
| A-605 | CH(CH₃)₂ | C₆H₅ |
| A-606 | CH₂CH₂CH₂CH₃ | C₆H₅ |
| A-607 | C(CH₃)₃ | C₆H₅ |
| A-608 | CH₂CH(CH₃)₂ | C₆H₅ |
| A-609 | CH(CH₃)CH₂CH₃ | C₆H₅ |
| A-610 | CH₂CH═CH₂ | C₆H₅ |
| A-611 | CH₂C≡CH | C₆H₅ |
| A-612 | CH(CH₃)CH═CH₂ | C₆H₅ |
| A-613 | CHF₂ | C₆H₅ |
| A-614 | CH₂Cl | C₆H₅ |
| A-615 | CH₂CH₂CN | C₆H₅ |
| A-616 | CH₂CH₂Cl | C₆H₅ |
| A-617 | c-C₃H₅ | C₆H₅ |
| A-618 | c-C₄H₇ | C₆H₅ |
| A-619 | c-C₅H₉ | C₆H₅ |
| A-620 | c-C₆H₁₁ | C₆H₅ |
| A-621 | CH₂—c-C₃H₅ | C₆H₅ |
| A-622 | CH(CH₃)—c-C₃H₅ | C₆H₅ |
| A-623 | CH₂—c-C₅H₉ | C₆H₅ |
| A-624 | CH₂—c-C₅H₉ | C₆H₅ |
| A-625 | C₆H₅ | C₆H₅ |
| A-626 | CH₃ | CH₂—c-C₄H₇ |
| A-627 | C₂H₅ | CH₂—c-C₄H₇ |
| A-628 | CH═CH₂ | CH₂—c-C₄H₇ |
| A-629 | CH₂CH₂CH₃ | CH₂—c-C₄H₇ |
| A-630 | CH(CH₃)₂ | CH₂—c-C₄H₇ |
| A-631 | CH₂CH₂CH₂CH₃ | CH₂—c-C₄H₇ |
| A-632 | C(CH₃)₃ | CH₂—c-C₄H₇ |
| A-633 | CH₂CH(CH₃)₂ | CH₂—c-C₄H₇ |
| A-634 | CH(CH₃)CH₂CH₃ | CH₂—c-C₄H₇ |
| A-635 | CH₂CH═CH₂ | CH₂—c-C₄H₇ |
| A-636 | CH₂C≡CH | CH₂—c-C₄H₇ |
| A-637 | CH(CH₃)CH═CH₂ | CH₂—c-C₄H₇ |
| A-638 | CHF₂ | CH₂—c-C₄H₇ |
| A-639 | CH₂Cl | CH₂—c-C₄H₇ |
| A-640 | CH₂CH₂CN | CH₂—c-C₄H₇ |
| A-641 | CH₂CH₂Cl | CH₂—c-C₄H₇ |
| A-642 | c-C₃H₅ | CH₂—c-C₄H₇ |
| A-643 | c-C₄H₇ | CH₂—c-C₄H₇ |
| A-644 | c-C₅H₉ | CH₂—c-C₄H₇ |
| A-645 | c-C₆H₁₁ | CH₂—c-C₄H₇ |
| A-646 | CH₂—c-C₃H₅ | CH₂—c-C₄H₇ |
| A-647 | CH(CH₃)—c-C₃H₅ | CH₂—c-C₄H₇ |
| A-648 | CH₂—c-C₅H₉ | CH₂—c-C₄H₇ |
| A-649 | CH₂—c-C₆H₁₁ | CH₂—c-C₄H₇ |
| A-650 | C₆H₅ | CH₂—c-C₄H₇ |
| A-651 | CH₃ | CH₂CH₂—c-C₃H₅ |
| A-652 | C₂H₅ | CH₂CH₂—c-C₃H₅ |
| A-653 | CH═CH₂ | CH₂CH₂—c-C₃H₅ |
| A-654 | CH₂CH₂CH₃ | CH₂CH₂—c-C₃H₅ |
| A-655 | CH(CH₃)₂ | CH₂CH₂—c-C₃H₅ |
| A-656 | CH₂CH₂CH₂CH₃ | CH₂CH₂—c-C₃H₅ |
| A-657 | C(CH₃)₃ | CH₂CH₂—c-C₃H₅ |
| A-658 | CH₂CH(CH₃)₂ | CH₂CH₂—c-C₃H₅ |
| A-659 | CH(CH₃)CH₂CH₃ | CH₂CH₂—c-C₃H₅ |
| A-660 | CH₂CH═CH₂ | CH₂CH₂—c-C₃H₅ |
| A-661 | CH₂C≡CH | CH₂CH₂—c-C₃H₅ |
| A-662 | CH(CH₃)CH═CH₂ | CH₂CH₂—c-C₃H₅ |
| A-663 | CHF₂ | CH₂CH₂—c-C₃H₅ |
| A-664 | CH₂Cl | CH₂CH₂—c-C₃H₅ |
| A-665 | CH₂CH₂CN | CH₂CH₂—c-C₃H₅ |
| A-666 | CH₂CH₂Cl | CH₂CH₂—c-C₃H₅ |
| A-667 | c-C₃H₅ | CH₂CH₂—c-C₃H₅ |
| A-668 | c-C₄H₇ | CH₂CH₂—c-C₃H₅ |
| A-669 | c-C₅H₉ | CH₂CH₂—c-C₃H₅ |
| A-670 | c-C₆H₁₁ | CH₂CH₂—c-C₃H₅ |
| A-671 | CH₂—c-C₃H₅ | CH₂CH₂—c-C₃H₅ |
| A-672 | CH(CH₃)—c-C₃H₅ | CH₂CH₂—c-C₃H₅ |
| A-673 | CH₂—c-C₅H₉ | CH₂CH₂—c-C₃H₅ |
| A-674 | CH₂—c-C₆H₁₁ | CH₂CH₂—c-C₃H₅ |
| A-675 | C₆H₅ | CH₂CH₂—c-C₃H₅ |
| A-676 | CH₃ | CH₂(CH₂)₃CH₃ |
| A-677 | C₂H₅ | CH₂(CH₂)₃CH₃ |
| A-678 | CH═CH₂ | CH₂(CH₂)₃CH₃ |
| A-679 | CH₂CH₂CH₃ | CH₂(CH₂)₃CH₃ |
| A-680 | CH(CH₃)₂ | CH₂(CH₂)₃CH₃ |
| A-681 | CH₂CH₂CH₂CH₃ | CH₂(CH₂)₃CH₃ |
| A-682 | C(CH₃)₃ | CH₂(CH₂)₃CH₃ |
| A-683 | CH₂CH(CH₃)₂ | CH₂(CH₂)₃CH₃ |
| A-684 | CH(CH₃)CH₂CH₃ | CH₂(CH₂)₃CH₃ |
| A-685 | CH₂CH═CH₂ | CH₂(CH₂)₃CH₃ |
| A-686 | CH₂C≡CH | CH₂(CH₂)₃CH₃ |
| A-687 | CH(CH₃)CH═CH₂ | CH₂(CH₂)₃CH₃ |
| A-688 | CHF₂ | CH₂(CH₂)₃CH₃ |
| A-689 | CH₂Cl | CH₂(CH₂)₃CH₃ |
| A-690 | CH₂CH₂CN | CH₂(CH₂)₃CH₃ |
| A-691 | CH₂CH₂Cl | CH₂(CH₂)₃CH₃ |
| A-692 | c-C₃H₅ | CH₂(CH₂)₃CH₃ |
| A-693 | c-C₄H₇ | CH₂(CH₂)₃CH₃ |
| A-694 | c-C₅H₉ | CH₂(CH₂)₃CH₃ |
| A-695 | c-C₆H₁₁ | CH₂(CH₂)₃CH₃ |
| A-696 | CH₂—c-C₃H₅ | CH₂(CH₂)₃CH₃ |
| A-697 | CH(CH₃)—c-C₃H₅ | CH₂(CH₂)₃CH₃ |
| A-698 | CH₂—c-C₅H₉ | CH₂(CH₂)₃CH₃ |
| A-699 | CH₂—c-C₆H₁₁ | CH₂(CH₂)₃CH₃ |
| A-700 | C₆H₅ | CH₂(CH₂)₃CH₃ |
| A-701 | CH₃ | CH(CH₃)CH(CH₃)₂ |
| A-702 | C₂H₅ | CH(CH₃)CH(CH₃)₂ |
| A-703 | CH═CH₂ | CH(CH₃)CH(CH₃)₂ |
| A-704 | CH₂CH₂CH₃ | CH(CH₃)CH(CH₃)₂ |
| A-705 | CH(CH₃)₂ | CH(CH₃)CH(CH₃)₂ |
| A-706 | CH₂CH₂CH₂CH₃ | CH(CH₃)CH(CH₃)₂ |
| A-707 | C(CH₃)₃ | CH(CH₃)CH(CH₃)₂ |
| A-708 | CH₂CH(CH₃)₂ | CH(CH₃)CH(CH₃)₂ |
| A-709 | CH(CH₃)CH₂CH₃ | CH(CH₃)CH(CH₃)₂ |
| A-710 | CH₂CH═CH₂ | CH(CH₃)CH(CH₃)₂ |
| A-711 | CH₂C≡CH | CH(CH₃)CH(CH₃)₂ |
| A-712 | CH(CH₃)CH═CH₂ | CH(CH₃)CH(CH₃)₂ |
| A-713 | CHF₂ | CH(CH₃)CH(CH₃)₂ |
| A-714 | CH₂Cl | CH(CH₃)CH(CH₃)₂ |
| A-715 | CH₂CH₂CN | CH(CH₃)CH(CH₃)₂ |
| A-716 | CH₂CH₂Cl | CH(CH₃)CH(CH₃)₂ |
| A-717 | c-C₃H₅ | CH(CH₃)CH(CH₃)₂ |
| A-718 | c-C₄H₇ | CH(CH₃)CH(CH₃)₂ |
| A-719 | c-C₅H₉ | CH(CH₃)CH(CH₃)₂ |
| A-720 | c-C₆H₁₁ | CH(CH₃)CH(CH₃)₂ |
| A-721 | CH₂—c-C₃H₅ | CH(CH₃)CH(CH₃)₂ |
| A-722 | CH(CH₃)—c-C₃H₅ | CH(CH₃)CH(CH₃)₂ |
| A-723 | CH₂—c-C₅H₉ | CH(CH₃)CH(CH₃)₂ |
| A-724 | CH₂—c-C₆H₁₁ | CH(CH₃)CH(CH₃)₂ |
| A-725 | C₆H₅ | CH(CH₃)CH(CH₃)₂ |
| A-726 | CH₃ | CH₂(CH₂)₄CH₃ |
| A-727 | C₂H₅ | CH₂(CH₂)₄CH₃ |
| A-728 | C(CH₃)₃ | CH₂(CH₂)₄CH₃ |
| A-729 | CH₂(CH₂)₄CH₃ | CH₂(CH₂)₄CH₃ |
| A-730 | CH₃ | 2-EtHex |
| A-731 | C₂H₅ | 2-EtHex |
| A-732 | C(CH₃)₃ | 2-EtHex |
| A-733 | 2-EtHex | 2-EtHex |
| A-734 | CH₃ | CH₂CH₂OH |
| A-735 | C₂H₅ | CH₂CH₂OH |
| A-736 | C(CH₃)₃ | CH₂CH₂OH |
| A-737 | CH₂CH₂CH₂CH₃ | CH₂CH₂OH |
| A-738 | CH₂(CH₂)₃CH₃ | CH₂CH₂OH |
| A-739 | CH₂CH₂OH | CH₂CH₂OH |
| A-740 | CH₂—c-C₄H₇ | CH₂—c-C₄H₇ |
| A-741 | CH₂CH₂—c-C₃H₅ | CH₂CH₂—c-C₃H₅ |
| A-742 | CH(CH₃)CH(CH₃)₂ | CH(CH₃)CH(CH₃)₂ |
| A-743 | CH₂(CH₂)₃CH₃ | CH₂(CH₂)₃CH₃ |

| | |
|---|---|
| A-744 | (CH₂)₄ |
| A-745 | CH₂CH₂SCH₂ |

c-C₃H₅: cyclopropyl; c-C₄H₇: cyclobutyl; c-C₅H₉: cyclopentyl; c-C₆H₁₁: cyclohexyl;
CH₂-c-C₃H₅: cyclopropylmethyl; CH(CH₃)-c-C₃H₅: 1-cyclopropylethyl;
CH₂-c-C₅H₉: cyclopentylmethyl; CH₂-c-C₅H₉: cyclopentylmethyl; C₆H₅: phenyl;
CH₂CH₂-c-C₃H₅: 2-cyclopropylethyl; CH₂-c-C₄H₇: 2-cyclobutylmethyl; 2-EtHex:

### CH₂CH(C₂H₅)(CH₂)₃CH₃

A group of especially preferred compounds of formula I are compounds I-1 to I-41 of formula IA-1 which are listed in the table C in the example section.

In one embodiment, a compound selected from compounds I-11, I-16, I-21, I-26, I-31 is the compound I in the mixtures according to the invention, which are defined in accordance with Table C of the example section:

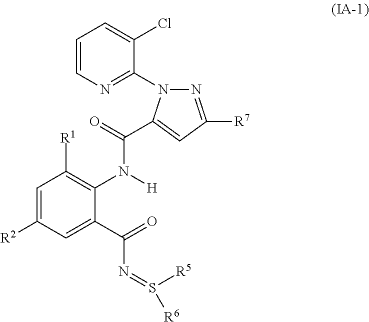

TABLE C′

| | R¹ | R² | R⁷ | R⁵ | R⁶ |
|---|---|---|---|---|---|
| I-11 | Me | Cl | CF₃ | C₂H₅ | C₂H₅ |
| I-16 | Cl | Cl | CF₃ | C₂H₅ | C₂H₅ |
| I-21 | Me | Cl | CF₃ | CH(CH₃)₂ | CH(CH₃)₂ |
| I-26 | Cl | Cl | CF₃ | CH(CH₃)₂ | CH(CH₃)₂ |
| I-31 | Br | Br | CF₃ | C₂H₅ | C₂H₅ |

In one embodiment, I-11 is the compound I in the mixtures according to the invention.

In one embodiment, I-16 is the compound I in the mixtures according to the invention.

In one embodiment, I-21 is the compound I in the mixtures according to the invention.

In one embodiment, I-26 is the compound I in the mixtures according to the invention.

In one embodiment, I-31 is the compound I in the mixtures according to the invention.

Active Compounds II Selected from Group M

With respect to their use in the pesticidal mixtures of the present invention, particular preference is given to the compounds II as listed in the paragraphs below. With regard to compounds I in the mixtures, the compounds I-1 to I-41 as defined in Table C in the Example Section at the end of the description, are preferred.

In one embodiment, the mixture according to the invention is a mixture of the compounds of formula I with Acetylcholine esterase (AChE) inhibitors, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

In one embodiment, the mixture according to the invention is a mixture of the compounds of formula I with an organophosphate, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, a compound II selected from group II-M.2 (GABA-gated chloride channel antagonists) as defined above is preferred, in particular group II-M.2B (fiproles), especially preferred ethiprole and fipronil.

In one embodiment, the mixture of a compound II selected from group II-M.2 (GABA-gated chloride channel antagonists) is with a compound selected from compounds I-11, I-16, I-21, I-26, I-31 according to Table C/C′.

Mixtures of compounds of formula I as individualized herein, e.g. in Table C, with fipronil as compound II are particularly preferred.

In one embodiment, the mixture of fipronil is with a compound selected from compounds I-11, I-16, I-21, I-26, I-31.

With regard to the use in a pesticidal mixture of the present invention, a compound II selected from group II-M.3 (Sodium channel modulators) as defined above is preferred, in particular group II-M.3A (pyrethroids), especially preferred alpha-cypermethrin and cyhalothrin.

Mixtures of compounds of formula I as individualized herein, e.g. in Table C, with alpha-cypermethrin as compound II are particularly preferred.

Mixtures of compounds of formula I as individualized herein, e.g. in Table C, with cyhalothrin as compound II are particularly preferred.

With regard to the use in a pesticidal mixture of the present invention, a compound II selected from group II-M.4A (Neonicotinoids) as defined above is preferred, in particular clothianidin, dinotefuran, imidacloprid, thiacloprid, or thiamethoxam.

In one embodiment, the mixture according to the invention is a mixture of the compounds of formula I with a neonicotinoid, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

In one embodiment, the mixture according to the invention is a mixture of the compounds of formula I with thiamethoxam, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. Mixtures of compounds of formula I as individualized herein, e.g. in Table C, with thiamethoxam as compound II are especially preferred.

In one embodiment, the mixture according to the invention is a mixture of the compounds of formula I with clothianidin, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. Mixtures of compounds of formula I as individualized herein, e.g. in Table C, with clothianidin as compound II are also preferred.

In one embodiment, the mixture according to the invention is a mixture of the compounds of formula I with dinotefuran, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. Mixtures of compounds of formula I as individualized herein, e.g. in Table C, with dinotefuran as compound II are also preferred.

In one embodiment, the mixture according to the invention is a mixture of the compounds of formula I with imidacloprid, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. Mixtures of compounds of formula I as individualized herein, e.g. in Table C, with imidacloprid as compound II are also preferred.

In one embodiment, the mixture according to the invention is a mixture of the compounds of formula I with thiacloprid, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. Mixtures of compounds of formula I as individualized herein, e.g. in Table C, with thiacloprid as compound II are also preferred.

Mixtures of compounds of formula I with sulfoxaflor as compound II are also preferred. In one embodiment, the mixture according to the invention is a mixture of the compounds of formula I with sulfoxaflor, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.5 (Nicotinic acetylcholine receptor allosteric activators) and is preferably spinosad or spinetoram. In one embodiment, the mixture according to the invention is a mixture of the compounds of formula I with Nicotinic acetylcholine receptor allosteric activators, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.6 (Chloride channel activators) and is preferably an avermectin. In one embodiment, the mixture according to the invention is a mixture of the compounds of formula I with a chloride channel activator, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

Mixtures of compounds of formula I as individualized herein, e.g. in Table C, with abamectin as compound II are especially preferred. In one embodiment, the mixture according to the invention is a mixture of the compounds of formula I with abamectin, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.9 (Selective homopteran feeding blockers) and is preferably pymetrozine or flonicamid. Mixtures of compounds of formula I as individualized herein, e.g. in Table C, with pymetrozine as compound II are especially preferred.

Mixtures of compounds of formula I as individualized herein, e.g. in Table C, with flonicamid as compound II are especially preferred. In one embodiment, the mixture according to the invention is a mixture of the compounds of formula I with a selective homopteran feeding blocker, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.13 (Uncouplers of oxidative phosphorylation via disruption of the proton gradient) and is preferably chlorfenapyr. In one embodiment, the mixture according to the invention is a mixture of the compounds of formula I with an uncoupler of oxidative phosphorylation via disruption of the proton gradient, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

Mixtures of compounds of formula I as individualized herein, e.g. in Table C, with chlorfenapyr as compound II are especially preferred. In one embodiment, the mixture according to the invention is a mixture of the compounds of formula I with chlorfenapyr, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.16 (Inhibitors of the chitin biosynthesis type 1) and is preferably buprofezin. In one embodiment, the mixture according to the invention is a mixture of the compounds of formula I with an inhibitor of the chitin biosynthesis type 1, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

In one embodiment, the mixture according to the invention is a mixture of the compounds of formula I with buprofezin, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.22 (Voltage-dependent sodium channel blockers) and is preferably metaflumizone. In one embodiment, the mixture according to the invention is a mixture of the compounds of formula I with a voltage-dependent sodium channel blocker, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. In one embodiment, the mixture according to the invention is a mixture of the compounds of formula I with metaflumizone, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.23 (Inhibitors of the of acetyl CoA carboxylase) and is preferably a Tetronic or Tetramic acid derivative, spirodiclofen, spiromesifen or spirotetramat.

Mixtures of compounds of formula I as individualized herein, e.g. in Table C, with Tetronic Acid as compound II are preferred. Mixtures of compounds of formula I as individualized herein, e.g. in Table C, with Tetramic Acid as compound II are also preferred. Mixtures of compounds of formula I as individualized herein, e.g. in Table C, with Tetramic Acid as compound II are also preferred.

In one embodiment, the mixture according to the invention is a mixture of the compounds of formula I with an Inhibitor of the of acetyl CoA carboxylase, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. In one embodiment, the mixture according to the invention is a mixture of the compounds of formula I with spirotetramat, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is selected from group II-M.26 (Ryanodine receptor-modulators) and is preferably chlorantraniliprole or cyantraniliprole.

Mixtures of compounds of formula I as individualized herein, e.g. in Table C, with chlorantraniliprole as compound II are especially preferred.

Mixtures of compounds of formula I as individualized herein, e.g. in Table C, with cyantraniliprole as compound II are especially preferred.

In one embodiment, the mixture according to the invention is a mixture of the compounds of formula I with a ryanodine receptor-modulators, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. In one embodiment, the mixture according to the invention is a mixture of the compounds of formula I with chlorantraniliprole, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. In one embodiment, the mixture according to the invention is a mixture of the compounds of formula I with cyantraniliprole, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is sulfoxaflor. Mixtures of compounds of formula I as individualized herein, e.g. in Table C, with sulfoxaflor as compound II are especially preferred.

In one embodiment, the mixture according to the invention is a mixture of the compounds of formula I with an Inhibitor of the of acetyl CoA carboxylase, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′. In one embodiment, the mixture according to the invention is a mixture of the compounds of formula I with spirotetramat, more preferably a compound of formula IA, also preferably a compound of formula IB, also preferably a compound of formula IC, also preferably a compound of formula ID; more preferably a compound selected from the compounds I-1 to I-41 as defined in Table C; more preferably a compound selected from compounds I-11, I-16, I-21, I-26, I-31 according to Table C/C′.

With regard to the use in a pesticidal mixture of the present invention, in an embodiment of the invention, the compound II is a neonicotinoid. Mixtures of compounds of formula I as individualized herein, e.g. in Table C, in particular a compound selected from I-11, I-16, I-17, I-21, I-26, I-31, I-36, I-41, with a neonicotinoid as compound II are especially preferred.

With regard to the use in a pesticidal mixture of the present invention, in an embodiment of the invention, the compound II is dinotefuran. Mixtures of compounds of formula I as individualized herein, e.g. in Table C, in particular a compound selected from I-11, I-16, I-17, I-21, I-26, I-31, I-36, I-41, with dinotefuran as compound II are preferred.

In another embodiment of the invention, the compound II is compound II-M.X.2. Mixtures of compounds of formula I as individualized herein, e.g. in Table C, with compound II-M.X.2 as compound II are especially preferred.

Compound II-M.X.2 is cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester:

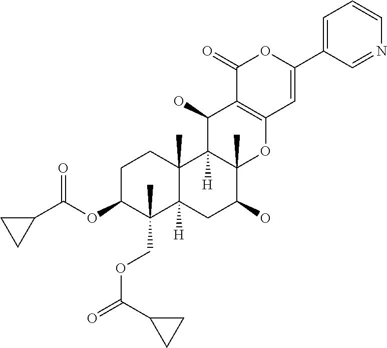

Especially preferred mixtures according to the invention are listed in the following table M, wherein the compounds I-1 to I-41 are as defined in Table C in the Example Section at the end of the description:

TABLE M

| Mixture | Comp. I | Compound II |
|---|---|---|
| M.1 | I-1 | fipronil |
| M.2 | I-2 | fipronil |
| M.3 | I-3 | fipronil |
| M.4 | I-4 | fipronil |
| M.5 | I-5 | fipronil |
| M.6 | I-6 | fipronil |
| M.7 | I-7 | fipronil |
| M.8 | I-8 | fipronil |
| M.9 | I-9 | fipronil |
| M.10 | I-10 | fipronil |
| M.11 | I-11 | fipronil |
| M.12 | I-12 | fipronil |
| M.13 | I-13 | fipronil |
| M.14 | I-14 | fipronil |
| M.15 | I-15 | fipronil |
| M.16 | I-16 | fipronil |
| M.17 | I-17 | fipronil |
| M.18 | I-18 | fipronil |
| M.19 | I-19 | fipronil |
| M.20 | I-20 | fipronil |
| M.21 | I-21 | fipronil |
| M.22 | I-22 | fipronil |
| M.23 | I-23 | fipronil |
| M.24 | I-24 | fipronil |
| M.25 | I-25 | fipronil |
| M.26 | I-26 | fipronil |
| M.27 | I-27 | fipronil |
| M.28 | I-28 | fipronil |
| M.29 | I-29 | fipronil |
| M.30 | I-30 | fipronil |
| M.31 | I-31 | fipronil |
| M.32 | I-32 | fipronil |
| M.33 | I-33 | fipronil |
| M.34 | I-34 | fipronil |
| M.35 | I-35 | fipronil |
| M.36 | I-36 | fipronil |
| M.37 | I-37 | fipronil |
| M.38 | I-38 | fipronil |
| M.39 | I-39 | fipronil |
| M.40 | I-40 | fipronil |
| M.41 | I-41 | fipronil |
| M.42 | I-1 | thiamethoxam |
| M.43 | I-2 | thiamethoxam |
| M.44 | I-3 | thiamethoxam |
| M.45 | I-4 | thiamethoxam |
| M.46 | I-5 | thiamethoxam |
| M.47 | I-6 | thiamethoxam |
| M.48 | I-7 | thiamethoxam |
| M.49 | I-8 | thiamethoxam |
| M.50 | I-9 | thiamethoxam |
| M.51 | I-10 | thiamethoxam |
| M.52 | I-11 | thiamethoxam |
| M.53 | I-12 | thiamethoxam |
| M.54 | I-13 | thiamethoxam |
| M.55 | I-14 | thiamethoxam |
| M.56 | I-15 | thiamethoxam |
| M.57 | I-16 | thiamethoxam |
| M.58 | I-17 | thiamethoxam |
| M.59 | I-18 | thiamethoxam |
| M.60 | I-19 | thiamethoxam |
| M.61 | I-20 | thiamethoxam |
| M.62 | I-21 | thiamethoxam |
| M.63 | I-22 | thiamethoxam |
| M.64 | I-23 | thiamethoxam |
| M.65 | I-24 | thiamethoxam |
| M.66 | I-25 | thiamethoxam |
| M.67 | I-26 | thiamethoxam |
| M.68 | I-27 | thiamethoxam |
| M.69 | I-28 | thiamethoxam |
| M.70 | I-29 | thiamethoxam |
| M.71 | I-30 | thiamethoxam |
| M.72 | I-31 | thiamethoxam |
| M.73 | I-32 | thiamethoxam |
| M.74 | I-33 | thiamethoxam |
| M.75 | I-34 | thiamethoxam |
| M.76 | I-35 | thiamethoxam |
| M.77 | I-36 | thiamethoxam |
| M.78 | I-37 | thiamethoxam |
| M.79 | I-38 | thiamethoxam |
| M.80 | I-39 | thiamethoxam |
| M.81 | I-40 | thiamethoxam |
| M.82 | I-41 | thiamethoxam |
| M.83 | I-1 | abamectin |
| M.84 | I-2 | abamectin |
| M.85 | I-3 | abamectin |
| M.86 | I-4 | abamectin |
| M.87 | I-5 | abamectin |
| M.88 | I-6 | abamectin |
| M.89 | I-7 | abamectin |
| M.90 | I-8 | abamectin |
| M.91 | I-9 | abamectin |
| M.92 | I-10 | abamectin |
| M.93 | I-11 | abamectin |
| M.94 | I-12 | abamectin |
| M.95 | I-13 | abamectin |
| M.96 | I-14 | abamectin |
| M.97 | I-15 | abamectin |
| M.98 | I-16 | abamectin |
| M.99 | I-17 | abamectin |
| M.100 | I-18 | abamectin |
| M.101 | I-19 | abamectin |
| M.102 | I-20 | abamectin |
| M.103 | I-21 | abamectin |
| M.104 | I-22 | abamectin |
| M.105 | I-23 | abamectin |
| M.106 | I-24 | abamectin |
| M.107 | I-25 | abamectin |
| M.108 | I-26 | abamectin |
| M.109 | I-27 | abamectin |
| M.110 | I-28 | abamectin |
| M.111 | I-29 | abamectin |
| M.112 | I-30 | abamectin |
| M.113 | I-31 | abamectin |
| M.114 | I-32 | abamectin |
| M.115 | I-33 | abamectin |
| M.116 | I-34 | abamectin |
| M.117 | I-35 | abamectin |
| M.118 | I-36 | abamectin |
| M.119 | I-37 | abamectin |
| M.120 | I-38 | abamectin |
| M.121 | I-39 | abamectin |
| M.122 | I-40 | abamectin |
| M.123 | I-41 | abamectin |
| M.124 | I-1 | imidacloprid |
| M.125 | I-2 | imidacloprid |
| M.126 | I-3 | imidacloprid |
| M.127 | I-4 | imidacloprid |
| M.128 | I-5 | imidacloprid |
| M.129 | I-6 | imidacloprid |
| M.130 | I-7 | imidacloprid |
| M.131 | I-8 | imidacloprid |
| M.132 | I-9 | imidacloprid |
| M.133 | I-10 | imidacloprid |
| M.134 | I-11 | imidacloprid |
| M.135 | I-12 | imidacloprid |
| M.136 | I-13 | imidacloprid |
| M.137 | I-14 | imidacloprid |
| M.138 | I-15 | imidacloprid |
| M.139 | I-16 | imidacloprid |
| M.140 | I-17 | imidacloprid |
| M.141 | I-18 | imidacloprid |
| M.142 | I-19 | imidacloprid |
| M.143 | I-20 | imidacloprid |
| M.144 | I-21 | imidacloprid |
| M.145 | I-22 | imidacloprid |
| M.146 | I-23 | imidacloprid |
| M.147 | I-24 | imidacloprid |
| M.148 | I-25 | imidacloprid |
| M.149 | I-26 | imidacloprid |
| M.150 | I-27 | imidacloprid |
| M.151 | I-28 | imidacloprid |
| M.152 | I-29 | imidacloprid |
| M.153 | I-30 | imidacloprid |
| M.154 | I-31 | imidacloprid |
| M.155 | I-32 | imidacloprid |
| M.156 | I-33 | imidacloprid |
| M.157 | I-34 | imidacloprid |
| M.158 | I-35 | imidacloprid |
| M.159 | I-36 | imidacloprid |
| M.160 | I-37 | imidacloprid |
| M.161 | I-38 | imidacloprid |
| M.162 | I-39 | imidacloprid |
| M.163 | I-40 | imidacloprid |
| M.164 | I-41 | imidacloprid |
| M.165 | I-1 | cyhalothrin |
| M.166 | I-2 | cyhalothrin |
| M.167 | I-3 | cyhalothrin |
| M.168 | I-4 | cyhalothrin |
| M.169 | I-5 | cyhalothrin |
| M.170 | I-6 | cyhalothrin |
| M.171 | I-7 | cyhalothrin |
| M.172 | I-8 | cyhalothrin |
| M.173 | I-9 | cyhalothrin |
| M.174 | I-10 | cyhalothrin |
| M.175 | I-11 | cyhalothrin |
| M.176 | I-12 | cyhalothrin |
| M.177 | I-13 | cyhalothrin |
| M.178 | I-14 | cyhalothrin |
| M.179 | I-15 | cyhalothrin |
| M.180 | I-16 | cyhalothrin |
| M.181 | I-17 | cyhalothrin |
| M.182 | I-18 | cyhalothrin |
| M.183 | I-19 | cyhalothrin |
| M.184 | I-20 | cyhalothrin |
| M.185 | I-21 | cyhalothrin |
| M.186 | I-22 | cyhalothrin |
| M.187 | I-23 | cyhalothrin |
| M.188 | I-24 | cyhalothrin |
| M.189 | I-25 | cyhalothrin |
| M.190 | I-26 | cyhalothrin |
| M.191 | I-27 | cyhalothrin |
| M.192 | I-28 | cyhalothrin |
| M.193 | I-29 | cyhalothrin |
| M.194 | I-30 | cyhalothrin |
| M.195 | I-31 | cyhalothrin |
| M.196 | I-32 | cyhalothrin |
| M.197 | I-33 | cyhalothrin |
| M.198 | I-34 | cyhalothrin |
| M.199 | I-35 | cyhalothrin |
| M.200 | I-36 | cyhalothrin |
| M.201 | I-37 | cyhalothrin |
| M.202 | I-38 | cyhalothrin |
| M.203 | I-39 | cyhalothrin |
| M.204 | I-40 | cyhalothrin |
| M.205 | I-41 | cyhalothrin |
| M.206 | I-1 | alpha-cypermethrin |
| M.207 | I-2 | alpha-cypermethrin |
| M.208 | I-3 | alpha-cypermethrin |
| M.209 | I-4 | alpha-cypermethrin |
| M.210 | I-5 | alpha-cypermethrin |
| M.211 | I-6 | alpha-cypermethrin |
| M.212 | I-7 | alpha-cypermethrin |
| M.213 | I-8 | alpha-cypermethrin |
| M.214 | I-9 | alpha-cypermethrin |
| M.215 | I-10 | alpha-cypermethrin |
| M.216 | I-11 | alpha-cypermethrin |
| M.217 | I-12 | alpha-cypermethrin |
| M.218 | I-13 | alpha-cypermethrin |
| M.219 | I-14 | alpha-cypermethrin |
| M.220 | I-15 | alpha-cypermethrin |
| M.221 | I-16 | alpha-cypermethrin |
| M.222 | I-17 | alpha-cypermethrin |
| M.223 | I-18 | alpha-cypermethrin |
| M.224 | I-19 | alpha-cypermethrin |
| M.225 | I-20 | alpha-cypermethrin |
| M.226 | I-21 | alpha-cypermethrin |
| M.227 | I-22 | alpha-cypermethrin |
| M.228 | I-23 | alpha-cypermethrin |
| M.229 | I-24 | alpha-cypermethrin |
| M.230 | I-25 | alpha-cypermethrin |
| M.231 | I-26 | alpha-cypermethrin |
| M.232 | I-27 | alpha-cypermethrin |
| M.233 | I-28 | alpha-cypermethrin |
| M.234 | I-29 | alpha-cypermethrin |
| M.235 | I-30 | alpha-cypermethrin |
| M.236 | I-31 | alpha-cypermethrin |
| M.237 | I-32 | alpha-cypermethrin |
| M.238 | I-33 | alpha-cypermethrin |
| M.239 | I-34 | alpha-cypermethrin |
| M.240 | I-35 | alpha-cypermethrin |
| M.241 | I-36 | alpha-cypermethrin |
| M.242 | I-37 | alpha-cypermethrin |
| M.243 | I-38 | alpha-cypermethrin |
| M.244 | I-39 | alpha-cypermethrin |
| M.245 | I-40 | alpha-cypermethrin |
| M.246 | I-41 | alpha-cypermethrin |
| M.247 | I-1 | Pymetrozine |
| M.248 | I-2 | Pymetrozine |
| M.249 | I-3 | Pymetrozine |
| M.250 | I-4 | Pymetrozine |
| M.251 | I-5 | Pymetrozine |
| M.252 | I-6 | Pymetrozine |
| M.253 | I-7 | Pymetrozine |
| M.254 | I-8 | Pymetrozine |
| M.255 | I-9 | Pymetrozine |
| M.256 | I-10 | Pymetrozine |
| M.257 | I-11 | Pymetrozine |
| M.258 | I-12 | Pymetrozine |
| M.259 | I-13 | Pymetrozine |
| M.260 | I-14 | Pymetrozine |
| M.261 | I-15 | Pymetrozine |
| M.262 | I-16 | Pymetrozine |
| M.263 | I-17 | Pymetrozine |
| M.264 | I-18 | Pymetrozine |
| M.265 | I-19 | Pymetrozine |
| M.266 | I-20 | Pymetrozine |
| M.267 | I-21 | Pymetrozine |
| M.268 | I-22 | Pymetrozine |
| M.269 | I-23 | Pymetrozine |
| M.270 | I-24 | Pymetrozine |
| M.271 | I-25 | Pymetrozine |
| M.272 | I-26 | Pymetrozine |
| M.273 | I-27 | Pymetrozine |
| M.274 | I-28 | Pymetrozine |
| M.275 | I-29 | Pymetrozine |
| M.276 | I-30 | Pymetrozine |
| M.277 | I-31 | Pymetrozine |
| M.278 | I-32 | Pymetrozine |
| M.279 | I-33 | Pymetrozine |
| M.280 | I-34 | Pymetrozine |
| M.281 | I-35 | Pymetrozine |
| M.282 | I-36 | Pymetrozine |
| M.283 | I-37 | Pymetrozine |
| M.284 | I-38 | Pymetrozine |
| M.285 | I-39 | Pymetrozine |
| M.286 | I-40 | Pymetrozine |
| M.287 | I-41 | Pymetrozine |
| M.288 | I-1 | Flonicamid |
| M.289 | I-2 | Flonicamid |
| M.290 | I-3 | Flonicamid |
| M.291 | I-4 | Flonicamid |
| M.292 | I-5 | Flonicamid |
| M.293 | I-6 | Flonicamid |
| M.294 | I-7 | Flonicamid |
| M.295 | I-8 | Flonicamid |
| M.296 | I-9 | Flonicamid |
| M.297 | I-10 | Flonicamid |
| M.298 | I-11 | Flonicamid |
| M.299 | I-12 | Flonicamid |
| M.300 | I-13 | Flonicamid |
| M.301 | I-14 | Flonicamid |
| M.302 | I-15 | Flonicamid |
| M.303 | I-16 | Flonicamid |
| M.304 | I-17 | Flonicamid |
| M.305 | I-18 | Flonicamid |
| M.306 | I-19 | Flonicamid |
| M.307 | I-20 | Flonicamid |
| M.308 | I-21 | Flonicamid |
| M.309 | I-22 | Flonicamid |
| M.310 | I-23 | Flonicamid |
| M.311 | I-24 | Flonicamid |
| M.312 | I-25 | Flonicamid |
| M.313 | I-26 | Flonicamid |
| M.314 | I-27 | Flonicamid |
| M.315 | I-28 | Flonicamid |
| M.316 | I-29 | Flonicamid |
| M.317 | I-30 | Flonicamid |
| M.318 | I-31 | Flonicamid |
| M.319 | I-32 | Flonicamid |
| M.320 | I-33 | Flonicamid |
| M.321 | I-34 | Flonicamid |
| M.322 | I-35 | Flonicamid |
| M.323 | I-36 | Flonicamid |
| M.324 | I-37 | Flonicamid |
| M.325 | I-38 | Flonicamid |
| M.326 | I-39 | Flonicamid |
| M.327 | I-40 | Flonicamid |
| M.328 | I-41 | Flonicamid |
| M.329 | I-1 | Spirotetramat |
| M.330 | I-2 | Spirotetramat |
| M.331 | I-3 | Spirotetramat |
| M.332 | I-4 | Spirotetramat |
| M.333 | I-5 | Spirotetramat |
| M.334 | I-6 | Spirotetramat |
| M.335 | I-7 | Spirotetramat |
| M.336 | I-8 | Spirotetramat |
| M.337 | I-9 | Spirotetramat |
| M.338 | I-10 | Spirotetramat |
| M.339 | I-11 | Spirotetramat |
| M.340 | I-12 | Spirotetramat |
| M.341 | I-13 | Spirotetramat |
| M.342 | I-14 | Spirotetramat |
| M.343 | I-15 | Spirotetramat |
| M.344 | I-16 | Spirotetramat |
| M.345 | I-17 | Spirotetramat |
| M.346 | I-18 | Spirotetramat |
| M.347 | I-19 | Spirotetramat |
| M.348 | I-20 | Spirotetramat |
| M.349 | I-21 | Spirotetramat |
| M.350 | I-22 | Spirotetramat |
| M.351 | I-23 | Spirotetramat |
| M.352 | I-24 | Spirotetramat |
| M.353 | I-25 | Spirotetramat |
| M.354 | I-26 | Spirotetramat |
| M.355 | I-27 | Spirotetramat |
| M.356 | I-28 | Spirotetramat |
| M.357 | I-29 | Spirotetramat |
| M.358 | I-30 | Spirotetramat |
| M.359 | I-31 | Spirotetramat |
| M.360 | I-32 | Spirotetramat |
| M.361 | I-33 | Spirotetramat |
| M.362 | I-34 | Spirotetramat |
| M.363 | I-35 | Spirotetramat |
| M.364 | I-36 | Spirotetramat |
| M.365 | I-37 | Spirotetramat |
| M.366 | I-38 | Spirotetramat |
| M.367 | I-39 | Spirotetramat |
| M.368 | I-40 | Spirotetramat |
| M.369 | I-41 | Spirotetramat |
| M.370 | I-1 | Buprofezin |
| M.371 | I-2 | Buprofezin |
| M.372 | I-3 | Buprofezin |
| M.373 | I-4 | Buprofezin |
| M.374 | I-5 | Buprofezin |
| M.375 | I-6 | Buprofezin |
| M.376 | I-7 | Buprofezin |
| M.377 | I-8 | Buprofezin |
| M.378 | I-9 | Buprofezin |
| M.379 | I-10 | Buprofezin |
| M.380 | I-11 | Buprofezin |
| M.381 | I-12 | Buprofezin |
| M.382 | I-13 | Buprofezin |
| M.383 | I-14 | Buprofezin |
| M.384 | I-15 | Buprofezin |
| M.385 | I-16 | Buprofezin |
| M.386 | I-17 | Buprofezin |
| M.387 | I-18 | Buprofezin |
| M.388 | I-19 | Buprofezin |
| M.389 | I-20 | Buprofezin |
| M.390 | I-21 | Buprofezin |
| M.391 | I-22 | Buprofezin |
| M.392 | I-23 | Buprofezin |
| M.393 | I-24 | Buprofezin |
| M.394 | I-25 | Buprofezin |
| M.395 | I-26 | Buprofezin |
| M.396 | I-27 | Buprofezin |
| M.397 | I-28 | Buprofezin |
| M.398 | I-29 | Buprofezin |
| M.399 | I-30 | Buprofezin |
| M.400 | I-31 | Buprofezin |
| M.401 | I-32 | Buprofezin |
| M.402 | I-33 | Buprofezin |
| M.403 | I-34 | Buprofezin |
| M.404 | I-35 | Buprofezin |
| M.405 | I-36 | Buprofezin |
| M.406 | I-37 | Buprofezin |
| M.407 | I-38 | Buprofezin |
| M.408 | I-39 | Buprofezin |
| M.409 | I-40 | Buprofezin |
| M.410 | I-41 | Buprofezin |
| M.411 | I-1 | Chlorfenapyr |
| M.412 | I-2 | Chlorfenapyr |
| M.413 | I-3 | Chlorfenapyr |
| M.414 | I-4 | Chlorfenapyr |
| M.415 | I-5 | Chlorfenapyr |
| M.416 | I-6 | Chlorfenapyr |
| M.417 | I-7 | Chlorfenapyr |
| M.418 | I-8 | Chlorfenapyr |
| M.419 | I-9 | Chlorfenapyr |
| M.420 | I-10 | Chlorfenapyr |
| M.421 | I-11 | Chlorfenapyr |
| M.422 | I-12 | Chlorfenapyr |
| M.423 | I-13 | Chlorfenapyr |
| M.424 | I-14 | Chlorfenapyr |
| M.425 | I-15 | Chlorfenapyr |
| M.426 | I-16 | Chlorfenapyr |
| M.427 | I-17 | Chlorfenapyr |
| M.428 | I-18 | Chlorfenapyr |
| M.429 | I-19 | Chlorfenapyr |
| M.430 | I-20 | Chlorfenapyr |
| M.431 | I-21 | Chlorfenapyr |
| M.432 | I-22 | Chlorfenapyr |
| M.433 | I-23 | Chlorfenapyr |
| M.434 | I-24 | Chlorfenapyr |
| M.435 | I-25 | Chlorfenapyr |
| M.436 | I-26 | Chlorfenapyr |
| M.437 | I-27 | Chlorfenapyr |
| M.438 | I-28 | Chlorfenapyr |
| M.439 | I-29 | Chlorfenapyr |
| M.440 | I-30 | Chlorfenapyr |
| M.441 | I-31 | Chlorfenapyr |
| M.442 | I-32 | Chlorfenapyr |
| M.443 | I-33 | Chlorfenapyr |
| M.444 | I-34 | Chlorfenapyr |
| M.445 | I-35 | Chlorfenapyr |
| M.446 | I-36 | Chlorfenapyr |
| M.447 | I-37 | Chlorfenapyr |
| M.448 | I-38 | Chlorfenapyr |
| M.449 | I-39 | Chlorfenapyr |
| M.450 | I-40 | Chlorfenapyr |
| M.451 | I-41 | Chlorfenapyr |
| M.452 | I-1 | Compound II-M.X.2 |
| M.453 | I-2 | Compound II-M.X.2 |
| M.454 | I-3 | Compound II-M.X.2 |
| M.455 | I-4 | Compound II-M.X.2 |
| M.456 | I-5 | Compound II-M.X.2 |
| M.457 | I-6 | Compound II-M.X.2 |
| M.458 | I-7 | Compound II-M.X.2 |
| M.459 | I-8 | Compound II-M.X.2 |
| M.460 | I-9 | Compound II-M.X.2 |
| M.461 | I-10 | Compound II-M.X.2 |
| M.462 | I-11 | Compound II-M.X.2 |
| M.463 | I-12 | Compound II-M.X.2 |
| M.464 | I-13 | Compound II-M.X.2 |
| M.465 | I-14 | Compound II-M.X.2 |
| M.466 | I-15 | Compound II-M.X.2 |
| M.467 | I-16 | Compound II-M.X.2 |
| M.468 | I-17 | Compound II-M.X.2 |
| M.469 | I-18 | Compound II-M.X.2 |
| M.470 | I-19 | Compound II-M.X.2 |
| M.471 | I-20 | Compound II-M.X.2 |
| M.472 | I-21 | Compound II-M.X.2 |
| M.473 | I-22 | Compound II-M.X.2 |
| M.474 | I-23 | Compound II-M.X.2 |
| M.475 | I-24 | Compound II-M.X.2 |
| M.476 | I-25 | Compound II-M.X.2 |
| M.477 | I-26 | Compound II-M.X.2 |
| M.478 | I-27 | Compound II-M.X.2 |
| M.479 | I-28 | Compound II-M.X.2 |
| M.480 | I-29 | Compound II-M.X.2 |
| M.481 | I-30 | Compound II-M.X.2 |
| M.482 | I-31 | Compound II-M.X.2 |
| M.483 | I-32 | Compound II-M.X.2 |
| M.484 | I-33 | Compound II-M.X.2 |
| M.485 | I-34 | Compound II-M.X.2 |
| M.486 | I-35 | Compound II-M.X.2 |
| M.487 | I-36 | Compound II-M.X.2 |
| M.488 | I-37 | Compound II-M.X.2 |
| M.489 | I-38 | Compound II-M.X.2 |
| M.490 | I-39 | Compound II-M.X.2 |
| M.491 | I-40 | Compound II-M.X.2 |
| M.492 | I-41 | Compound II-M.X.2 |
| M.493 | I-1 | Dinotefuran |
| M.494 | I-2 | Dinotefuran |
| M.495 | I-3 | Dinotefuran |
| M.496 | I-4 | Dinotefuran |
| M.497 | I-5 | Dinotefuran |
| M.498 | I-6 | Dinotefuran |
| M.499 | I-7 | Dinotefuran |
| M.500 | I-8 | Dinotefuran |
| M.501 | I-9 | Dinotefuran |
| M.502 | I-10 | Dinotefuran |
| M.503 | I-11 | Dinotefuran |
| M.504 | I-12 | Dinotefuran |
| M.505 | I-13 | Dinotefuran |
| M.506 | I-14 | Dinotefuran |
| M.507 | I-15 | Dinotefuran |
| M.508 | I-16 | Dinotefuran |
| M.509 | I-17 | Dinotefuran |
| M.510 | I-18 | Dinotefuran |
| M.511 | I-19 | Dinotefuran |
| M.512 | I-20 | Dinotefuran |
| M.513 | I-21 | Dinotefuran |
| M.514 | I-22 | Dinotefuran |
| M.515 | I-23 | Dinotefuran |
| M.516 | I-24 | Dinotefuran |
| M.517 | I-25 | Dinotefuran |
| M.518 | I-26 | Dinotefuran |
| M.519 | I-27 | Dinotefuran |
| M.520 | I-28 | Dinotefuran |
| M.521 | I-29 | Dinotefuran |
| M.522 | I-30 | Dinotefuran |
| M.523 | I-31 | Dinotefuran |
| M.524 | I-32 | Dinotefuran |
| M.525 | I-33 | Dinotefuran |
| M.526 | I-34 | Dinotefuran |
| M.527 | I-35 | Dinotefuran |
| M.528 | I-36 | Dinotefuran |
| M.529 | I-37 | Dinotefuran |
| M.530 | I-38 | Dinotefuran |
| M.531 | I-39 | Dinotefuran |
| M.532 | I-40 | Dinotefuran |
| M.533 | I-41 | Dinotefuran |
| M.534 | I-1 | sulfoxaflor |
| M.535 | I-2 | sulfoxaflor |
| M.536 | I-3 | sulfoxaflor |
| M.537 | I-4 | sulfoxaflor |
| M.538 | I-5 | sulfoxaflor |
| M.539 | I-6 | sulfoxaflor |
| M.540 | I-7 | sulfoxaflor |
| M.541 | I-8 | sulfoxaflor |
| M.542 | I-9 | sulfoxaflor |
| M.543 | I-10 | sulfoxaflor |
| M.544 | I-11 | sulfoxaflor |
| M.545 | I-12 | sulfoxaflor |
| M.546 | I-13 | sulfoxaflor |
| M.547 | I-14 | sulfoxaflor |
| M.548 | I-15 | sulfoxaflor |
| M.549 | I-16 | sulfoxaflor |
| M.550 | I-17 | sulfoxaflor |
| M.551 | I-18 | sulfoxaflor |
| M.552 | I-19 | sulfoxaflor |
| M.553 | I-20 | sulfoxaflor |
| M.554 | I-21 | sulfoxaflor |
| M.555 | I-22 | sulfoxaflor |
| M.556 | I-23 | sulfoxaflor |
| M.557 | I-24 | sulfoxaflor |
| M.558 | I-25 | sulfoxaflor |
| M.559 | I-26 | sulfoxaflor |
| M.560 | I-27 | sulfoxaflor |
| M.561 | I-28 | sulfoxaflor |
| M.562 | I-29 | sulfoxaflor |
| M.563 | I-30 | sulfoxaflor |
| M.564 | I-31 | sulfoxaflor |
| M.565 | I-32 | sulfoxaflor |
| M.566 | I-33 | sulfoxaflor |
| M.567 | I-34 | sulfoxaflor |
| M.568 | I-35 | sulfoxaflor |
| M.569 | I-36 | sulfoxaflor |
| M.570 | I-37 | sulfoxaflor |
| M.571 | I-38 | sulfoxaflor |
| M.572 | I-39 | sulfoxaflor |
| M.573 | I-40 | sulfoxaflor |
| M.574 | I-41 | sulfoxaflor |
| M.575 | I-1 | metaflumizone |
| M.576 | I-2 | metaflumizone |
| M.577 | I-3 | metaflumizone |
| M.578 | I-4 | metaflumizone |
| M.579 | I-5 | metaflumizone |
| M.580 | I-6 | metaflumizone |
| M.581 | I-7 | metaflumizone |
| M.582 | I-8 | metaflumizone |
| M.583 | I-9 | metaflumizone |
| M.584 | I-10 | metaflumizone |
| M.585 | I-11 | metaflumizone |
| M.586 | I-12 | metaflumizone |
| M.587 | I-13 | metaflumizone |
| M.588 | I-14 | metaflumizone |
| M.589 | I-15 | metaflumizone |
| M.590 | I-16 | metaflumizone |
| M.591 | I-17 | metaflumizone |
| M.592 | I-18 | metaflumizone |
| M.593 | I-19 | metaflumizone |
| M.594 | I-20 | metaflumizone |
| M.595 | I-21 | metaflumizone |
| M.596 | I-22 | metaflumizone |
| M.597 | I-23 | metaflumizone |
| M.598 | I-24 | metaflumizone |
| M.599 | I-25 | metaflumizone |
| M.600 | I-26 | metaflumizone |
| M.601 | I-27 | metaflumizone |
| M.602 | I-28 | metaflumizone |
| M.603 | I-29 | metaflumizone |
| M.604 | I-30 | metaflumizone |
| M.605 | I-31 | metaflumizone |
| M.606 | I-32 | metaflumizone |
| M.607 | I-33 | metaflumizone |
| M.608 | I-34 | metaflumizone |
| M.609 | I-35 | metaflumizone |
| M.610 | I-36 | metaflumizone |
| M.611 | I-37 | metaflumizone |
| M.612 | I-38 | metaflumizone |
| M.613 | I-39 | metaflumizone |
| M.614 | I-40 | metaflumizone |
| M.615 | I-41 | metaflumizone |
| M.616 | I-1 | indoxacarb |
| M.617 | I-2 | indoxacarb |
| M.618 | I-3 | indoxacarb |
| M.619 | I-4 | indoxacarb |
| M.620 | I-5 | indoxacarb |
| M.621 | I-6 | indoxacarb |
| M.622 | I-7 | indoxacarb |
| M.623 | I-8 | indoxacarb |
| M.624 | I-9 | indoxacarb |
| M.625 | I-10 | indoxacarb |
| M.626 | I-11 | indoxacarb |
| M.627 | I-12 | indoxacarb |
| M.628 | I-13 | indoxacarb |
| M.629 | I-14 | indoxacarb |
| M.630 | I-15 | indoxacarb |
| M.631 | I-16 | indoxacarb |
| M.632 | I-17 | indoxacarb |
| M.633 | I-18 | indoxacarb |
| M.634 | I-19 | indoxacarb |
| M.635 | I-20 | indoxacarb |
| M.636 | I-21 | indoxacarb |
| M.637 | I-22 | indoxacarb |
| M.638 | I-23 | indoxacarb |
| M.639 | I-24 | indoxacarb |
| M.640 | I-25 | indoxacarb |
| M.641 | I-26 | indoxacarb |
| M.642 | I-27 | indoxacarb |
| M.643 | I-28 | indoxacarb |
| M.644 | I-29 | indoxacarb |
| M.645 | I-30 | indoxacarb |
| M.646 | I-31 | indoxacarb |
| M.647 | I-32 | indoxacarb |
| M.648 | I-33 | indoxacarb |
| M.649 | I-34 | indoxacarb |
| M.650 | I-35 | indoxacarb |
| M.651 | I-36 | indoxacarb |
| M.652 | I-37 | indoxacarb |
| M.653 | I-38 | indoxacarb |
| M.654 | I-39 | indoxacarb |
| M.655 | I-40 | indoxacarb |
| M.656 | I-41 | indoxacarb |
| M.657 | I-1 | clothianidin |
| M.658 | I-2 | clothianidin |
| M.659 | I-3 | clothianidin |
| M.660 | I-4 | clothianidin |
| M.661 | I-5 | clothianidin |
| M.662 | I-6 | clothianidin |
| M.663 | I-7 | clothianidin |
| M.664 | I-8 | clothianidin |
| M.665 | I-9 | clothianidin |
| M.666 | I-10 | clothianidin |
| M.667 | I-11 | clothianidin |
| M.668 | I-12 | clothianidin |
| M.669 | I-13 | clothianidin |
| M.670 | I-14 | clothianidin |
| M.671 | I-15 | clothianidin |
| M.672 | I-16 | clothianidin |
| M.673 | I-17 | clothianidin |
| M.674 | I-18 | clothianidin |
| M.675 | I-19 | clothianidin |
| M.676 | I-20 | clothianidin |
| M.677 | I-21 | clothianidin |
| M.678 | I-22 | clothianidin |
| M.679 | I-23 | clothianidin |
| M.680 | I-24 | clothianidin |
| M.681 | I-25 | clothianidin |
| M.682 | I-26 | clothianidin |
| M.683 | I-27 | clothianidin |
| M.684 | I-28 | clothianidin |
| M.685 | I-29 | clothianidin |
| M.686 | I-30 | clothianidin |
| M.687 | I-31 | clothianidin |
| M.688 | I-32 | clothianidin |
| M.689 | I-33 | clothianidin |
| M.690 | I-34 | clothianidin |
| M.691 | I-35 | clothianidin |
| M.692 | I-36 | clothianidin |
| M.693 | I-37 | clothianidin |
| M.694 | I-38 | clothianidin |
| M.695 | I-39 | clothianidin |
| M.696 | I-40 | clothianidin |
| M.697 | I-41 | clothianidin |
| M.698 | I-1 | bifenthrin |
| M.699 | I-2 | bifenthrin |
| M.700 | I-3 | bifenthrin |
| M.701 | I-4 | bifenthrin |
| M.702 | I-5 | bifenthrin |
| M.703 | I-6 | bifenthrin |
| M.704 | I-7 | bifenthrin |
| M.705 | I-8 | bifenthrin |
| M.706 | I-9 | bifenthrin |
| M.707 | I-10 | bifenthrin |
| M.708 | I-11 | bifenthrin |
| M.709 | I-12 | bifenthrin |
| M.710 | I-13 | bifenthrin |
| M.711 | I-14 | bifenthrin |
| M.712 | I-15 | bifenthrin |
| M.713 | I-16 | bifenthrin |
| M.714 | I-17 | bifenthrin |
| M.715 | I-18 | bifenthrin |
| M.716 | I-19 | bifenthrin |
| M.717 | I-20 | bifenthrin |
| M.718 | I-21 | bifenthrin |
| M.719 | I-22 | bifenthrin |
| M.720 | I-23 | bifenthrin |
| M.721 | I-24 | bifenthrin |
| M.722 | I-25 | bifenthrin |
| M.723 | I-26 | bifenthrin |
| M.724 | I-27 | bifenthrin |
| M.725 | I-28 | bifenthrin |
| M.726 | I-29 | bifenthrin |
| M.727 | I-30 | bifenthrin |
| M.728 | I-31 | bifenthrin |
| M.729 | I-32 | bifenthrin |
| M.730 | I-33 | bifenthrin |
| M.731 | I-34 | bifenthrin |
| M.732 | I-35 | bifenthrin |
| M.733 | I-36 | bifenthrin |
| M.734 | I-37 | bifenthrin |
| M.735 | I-38 | bifenthrin |
| M.736 | I-39 | bifenthrin |
| M.737 | I-40 | bifenthrin |
| M.738 | I-41 | bifenthrin |
| M.739 | I-1 | acetamiprid |
| M.740 | I-2 | acetamiprid |
| M.741 | I-3 | acetamiprid |
| M.742 | I-4 | acetamiprid |
| M.743 | I-5 | acetamiprid |
| M.744 | I-6 | acetamiprid |
| M.745 | I-7 | acetamiprid |
| M.746 | I-8 | acetamiprid |
| M.747 | I-9 | acetamiprid |
| M.748 | I-10 | acetamiprid |
| M.749 | I-11 | acetamiprid |
| M.750 | I-12 | acetamiprid |
| M.751 | I-13 | acetamiprid |
| M.752 | I-14 | acetamiprid |
| M.753 | I-15 | acetamiprid |
| M.754 | I-16 | acetamiprid |
| M.755 | I-17 | acetamiprid |
| M.756 | I-18 | acetamiprid |
| M.757 | I-19 | acetamiprid |
| M.758 | I-20 | acetamiprid |
| M.759 | I-21 | acetamiprid |
| M.760 | I-22 | acetamiprid |
| M.761 | I-23 | acetamiprid |
| M.762 | I-24 | acetamiprid |
| M.763 | I-25 | acetamiprid |
| M.764 | I-26 | acetamiprid |
| M.765 | I-27 | acetamiprid |
| M.766 | I-28 | acetamiprid |
| M.767 | I-29 | acetamiprid |
| M.768 | I-30 | acetamiprid |
| M.769 | I-31 | acetamiprid |
| M.770 | I-32 | acetamiprid |
| M.771 | I-33 | acetamiprid |
| M.772 | I-34 | acetamiprid |
| M.773 | I-35 | acetamiprid |
| M.774 | I-36 | acetamiprid |
| M.775 | I-37 | acetamiprid |
| M.776 | I-38 | acetamiprid |
| M.777 | I-39 | acetamiprid |
| M.778 | I-40 | acetamiprid |
| M.779 | I-41 | acetamiprid |

Compound II-M.X.2 is cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a, 12b-trimethyl-11-oxo-9-(3-pyridinyl)-2H,11H-naphtho[2,1-b]pyrano[3,4-e]pyran-3,6-diyl]ester:

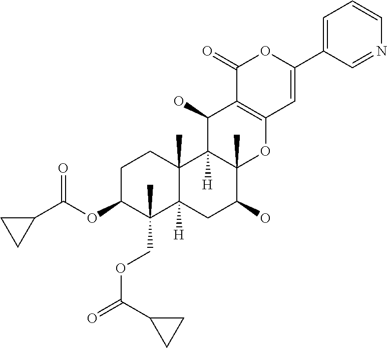

In one embodiment, the mixtures according to the invention are as described herein, with the proviso that they are NOT mixtures comprising:

A) a biopesticide, in particular as described herein in group II-M.Y and F.XIII, and
B) a compound selected from N[4,6-dichloro-2-[(diethyl-lambda-4-sulfanylidene)carbamoyl]-phenyl]-2-(3-chloro-2 pyridyl)-5-(trifluoromethyl)pyr [symbol] azole-3-carboxamide; N-[4-chloro-2-[(diethyl-lambda-4-sulfanylidene)carbamoyl]-6 methyl-phenyl]-2-(3-chloro-2-pyridyl)-5-(triflu [symbol] oromethyl)pyrazole-3-carboxamide; N-[4-chloro-2-[(di-2-propyl-lambda-4-sulfanyli [symbol] dene)carbamoyl]-6-methyl-phenyl]-2(3-chloro-2-pyridyl)-5-(trifluoromethyl)pyrazole-3-carboxamide; N-[4,6-dichloro-2[(di-2-propyl-lambda-4-sulfanylidene)carbamoyl]-phenyl]-2-(3-chloro-2-pyridyl)-5(trifluoromethyl)pyrazole-3-carboxamide; N-[4,6-di [symbol] chloro-2-[(diethyl-lambda-4 sulfanylidene)carbamoyl]-phenyl]-2-(3-chloro-2-pyridyl)-5-(difluoromethyl)pyr [symbol] azole-3-carboxamide; N-[4,6-dibromo-2-[(di-2-propyl-lambda-4 sulfanylidene)carba [symbol] moyl]-phenyl]-2-(3-chloro-2-pyridyl)-5-(trifluoromethyl)pyr [symbol] azole-3-carboxamide; N[4-chloro-2-[(di-2-propyl-lambda-4-sulfanylidene)carba [symbol] moyl]-6-cyano-phenyl]-2(3-chloro-2-pyridyl)-5-(trifluoromethyl)pyrazole-3-carbox [symbol] amide; N-[4,6-dibromo-2[(diethyl-lambda-4-sulfanylidene)carbamoyl]-phenyl]-2(3 chloro-2-pyridyl)-5 (tri [symbol] fluoromethyl)pyrazole-3-carboxamide [compound I]; and
C) a triazole compound selected from:
C-a) triazole compounds as described in EP13175404.6,
C-b) a compound of formula T:

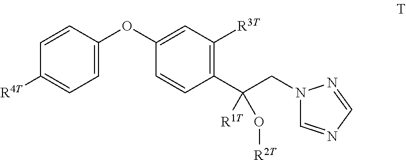

wherein
R^{1T} is (C₁-C₄)-alkyl, (C₃-C₆)-cycloalkyl or (C₂-C₄)-alkinyl;
R^{2T} is hydrogen, (C₁-C₃)-alkyl, (C₂-C₄)-alkenyl or (C₂-C₄)-alkynyl;
R^{3T} is Cl or CF₃; and
R^{4T} is Cl or F;
   C-c) a strobilurin-type compound as described as compound I in EP13172462.7;
   C-d) a strobilurin-type compound as described as compound I in EP13172461.9;

Furthermore, in one sub-embodiment, the mixtures according to the invention are as described herein, with the proviso that they are NOT mixtures as described in EP 13160219.5 or EP13160196.5, comprising:
a biopesticide which is Bacillus subtilis strain FB17, or a cell-free extract thereof or at least one me-tabolite thereof, and/or a mutant of Bacillus subtilis FB17 having all the identifying characteristics thereof or extract of the mutant;
a compound selected from the group of N[4,6-dichloro-2-[(diethyl-lambda-4-sulfanylidene)carbamoyl]-phenyl]-2-(3-chloro-2 pyridyl)-5-(trifluoromethyl)pyr [symbol] azole-3-carboxamide; N-[4-chloro-2-[(diethyl-lambda-4-sulfanylidene)carbamoyl]-6 methyl-phenyl]-2-(3-chloro-2-pyridyl)-5-(triflu [symbol] oromethyl)pyrazole-3-carboxamide; N-[4-chloro-2-[(di-2-propyl-lambda-4-sulfanyli [symbol] dene)carbamoyl]-6-methyl-phenyl]-2(3-chloro-2-pyridyl)-5-(trifluoromethyl)pyrazole-3-carboxamide; N-[4,6-dichloro-2[(di-2-propyl-lambda-4-sulfanylidene)carbamoyl]-phenyl]-2-(3-chloro-2-pyridyl)-5(trifluoromethyl)pyrazole-3-carboxamide; N-[4,6-di-chloro-2-[(diethyl-lambda-4 sulfanylidene)carbamoyl]-phenyl]-2-(3-chloro-2-pyridyl)-5-(difluoromethyl)pyr [symbol] azole-3-carboxamide; N-[4,6-dibromo-2-[(di-2-propyl-lambda-4 sulfanylidene)carba [symbol] moyl]-phenyl]-2-(3-chloro-2-pyridyl)-5-(trifluoromethyl)pyr [symbol] azole-3-carboxamide; N[4-chloro-2-[(di-2-propyl-lambda-4-sulfanylidene)carba [symbol] moyl]-6-cyano-phenyl]-2(3-chloro-2-pyridyl)-5-(trifluoromethyl)pyrazole-3-carbox [symbol] amide; N-[4,6-dibromo-2[(diethyl-lambda-4-sulfanylidene)carbamoyl]-phenyl]-2(3 chloro-2-pyridyl)-5 (tri [symbol] fluoromethyl)pyrazole-3-carboxamide [compound I].
   Pests The mixtures according to the invention are in particular suitable for efficiently controlling arthropodal pests such as arachnids, myriapedes and insects as well as nematodes. The mixtures according to the invention are especially suitable for efficiently combating the following pests:
   insects from the order of the lepidopterans (Lepidoptera), for example Acronicta major, Adoxophyes orana, Aedia leucomelas, Agrotis spp. such as Agrotis fucosa, Agrotis segetum, Agrotis ipsilon; Alabama argillacea, Anticarsia gemmatalis, Anticarsia spp., Argyresthia conjugella, Autographa gamma, Barathra brassicae, Bucculatrix thurberiella, Bupalus piniarius, Cacoecia murinana, Cacoecia podana, Capua reticulana, Carpocapsa pomonella, Cheimatobia brumata, Chilo spp. such as Chilo suppressalis; Choristoneura fumiferana, Choristoneura occidentalis, Cirphis unipuncta, Clysia ambiguella, Cnaphalocerus spp., Cydia pomonella, Dendrolimus pini, Diaphania nitidalis, Diatraea grandiosella, Earias insulana, Elasmopalpus lignosellus, Ephestia cautella, Ephestia kuehniella, Eupoecilia ambiguella, Euproctis chrysorrhoea, Euxoa spp., Evetria bouliana, Feltia spp. such as Feltia subterranean; Galleria mellonella, Grapholitha funebrana, Grapholitha molesta, Helicoverpa spp. such as Helicoverpa armigera, Helicoverpa zea; Heliothis spp. such as Heliothis armigera, Heliothis virescens, Heliothis zea; Hellula undalis, Hibernia defoliaria, Hofmannophila pseudospretella, Homona magnanima, Hyphantria cunea, Hyponomeuta padella, Hyponomeuta malinellus, Keiferia lycopersicella, Lambdina fiscellaria, Laphygma spp. such as Laphygma exigua; Leucoptera coffeella, Leucoptera scitella, Lithocolletis blancardella, Lithophane antennata, Lobesia botrana, Loxagrotis albicosta, Loxostege sticticalis, Lymantria spp. such as Lymantria dispar, Lymantria monacha; Lyonetia clerkella, Malacosoma neustria, Mamestra spp. such as Mamestra brassicae; Mocis repanda, Mythimna separata, Orgyia pseudotsugata, Oria spp., Ostrinia spp. such as Ostrinia nubilalis; Oulema oryzae, Panolis flammea, Pectinophora spp. such as Pectinophora gossypiella; Peridroma saucia, Phalera bucephala, Phthorimaea spp. such as Phthorimaea operculella; Phyllocnistis citrella, Pieris spp. such as Pieris brassicae, Pieris rapae; Plathypena scabra, Plutella maculipennis, Plutella xylostella, Prodenia spp., Pseudaletia spp., Pseudoplusia includens, Pyrausta nubilalis, Rhyacionia frustrana, Scrobipalpula absoluta, Sitotroga cerealella, Sparganothis pilleriana, Spodoptera spp. such as Spodoptera frugiperda, Spodoptera littoralis, Spodoptera litura; Thaumatopoea pityocampa, Thermesia gemmatalis, Tinea pellionella, Tineola bisselliella, Tortrix viridana, Trichoplusia spp. such as Trichoplusia ni; Tuta absoluta, and Zeiraphera canadensis,
   beetles (Coleoptera), for example Acanthoscehdes obtectus, Adoretus spp., Agelastica alni, Agrilus sinuatus, Agriotes spp. such as Agriotes fuscicollis, Agriotes lineatus, Agriotes obscurus; Amphimallus solstitialis, Anisandrus dispar, Anobium punctatum, Anomala rufocuprea, Anoplophora spp. such as Anoplophora glabripennis; Anthonomus spp. such as Anthonomus grandis, Anthonomus pomorum; Anthrenus spp., Aphthona euphoridae, Apogonia spp., Athous haemorrhoidalis, Atomaria spp. such as Atomaria linearis; Attagenus spp., Aulacophora femoralis, Blastophagus piniperda, Blitophaga undata, Bruchidius obtectus, Bruchus spp. such as Bruchus lentis, Bruchus pisorum, Bruchus rufimanus; Byctiscus betulae, Callosobruchus chinensis, Cassida nebulosa, Cerotoma trifurcata, Cetonia aurata, Ceuthorhynchus spp. such as Ceuthorrhynchus assimilis, Ceuthorrhynchus napi; Chaetocnema tibialis, Cleonus mendicus, Conoderus spp. such as Conoderus vespertinus; Cosmopolites spp., Costelytra zealandica, Crioceris asparagi, Cryptorhynchus lapathi, Ctenicera ssp. such as Ctenicera destructor; Curculio spp., Dectes texanus, Dermestes spp., Diabrotica spp. such as Diabrotica 12-punctata Diabrotica speciosa, Diabrotica Iongicornis, Diabrotica semipunctata, Diabrotica virgifera; Epilachna spp. such as Epilachna varivestis, Epilachna vigintioctomaculata; Epitrix spp. such as Epitrix hirtipennis; Eutinobothrus brasiliensis, Faustinus cubae, Gibbium psylloides, Heteronychus arator, Hylamorpha elegans, Hylobius abietis, Hylotrupes bajulus, Hypera brunneipennis, Hypera postica, Hypothenemus spp., Ips typographus, Lachnosterna consanguinea, Lema bilineata, Lema melanopus, Leptinotarsa spp. such as Leptinotarsa decemlineata; Limonius californicus, Lissorhoptrus oryzophilus, Lissorhoptrus oryzophilus, Lixus spp., Lyctus spp. such as Lyctus bruneus; Melanotus communis, Meligethes spp. such as Meligethes aeneus; Melolontha hippocastani, Melolontha melolontha, Migdolus spp., Monochamus spp. such as Monochamus alternatus; Naupactus xanthographus, Niptus hololeucus, Oryctes rhinoceros, Oryzaephilus surinamensis, Otiorrhynchus sulcatus, Otiorrhynchus ovatus, Otiorrhynchus sulcatus, Oulema oryzae, Oxycetonia jucunda, Phaedon cochleariae, Phyllobius pyri, Phyllopertha horticola, Phyllophaga spp., Phyllotreta spp. such as Phyllotreta chrysocephala, Phyllotreta nemorum, Phyllotreta striolata; Phyllophaga spp., Phyllopertha horticola, Popillia japonica, Premnotrypes spp., Psylliodes chrysocephala, Ptinus spp., Rhizobius ventralis, Rhizopertha dominica, Sitona lineatus, Sitophilus spp. such as Sitophilus granaria, Sitophilus zeamais; Sphenophorus spp. such as Sphenophorus levis; Stemechus spp. such as Stemechus subsignatus; Symphyletes spp., Tenebrio molitor, Tribolium spp. such as Tribolium castaneum; Trogoderma spp., Tychius spp., Xylotrechus spp., and Zabrus spp. such as Zabrus tenebrioides,
   flies, mosquitoes (Diptera), e.g. Aedes spp. such as Aedes aegypti, Aedes albopictus, Aedes vexans; Anastrepha ludens, Anopheles spp. such as Anopheles albimanus, Anopheles crucians, Anopheles freeborni, Anopheles gambiae, Anopheles leucosphyrus, Anopheles maculipennis, Anopheles minimus, Anopheles quadrimaculatus, Anopheles sinensis; Bibio hortulanus, Calliphora erythrocephala, Calliphora vicina, Cerafitis capitata, Ceratitis capitata, Chrysomyia spp. such as Chrysomya bezziana, Chrysomya hominivorax, Chrysomya macellaria; Chrysops atlanticus, Chrysops discalis, Chrysops silacea, Cochliomyia spp. such as Cochliomyia hominivorax; Contarinia spp. such as Contarinia sorghicola; Cordylobia anthropophaga, Culex spp. such as Culex nigripalpus, Culex pipiens, Culex quinquefasciatus, Culex tarsalis, Culex tritaeniorhynchus; Culicoides furens, Culiseta inornata, Culiseta melanura, Cuterebra spp., Dacus cucurbitae, Dacus oleae, Dasineura brassicae, Delia spp. such as Delia antique, Delia coarctata, Delia platura, Delia radicum; Dermatobia hominis, Drosophila spp., Fannia spp. such as Fannia canicularis; Gastraphilus spp. such as Gasterophilus intestinalis; Geomyza Tripunctata, Glossina fuscipes, Glossina morsitans, Glossina palpalis, Glossina tachinoides, Haematobia irritans, Haplodiplosis equestris, Hippelates spp., Hylemyia spp. such as Hylemyia platura; Hypoderma spp. such as Hypoderma lineata; Hyppobosca spp., Leptoconops torrens, Liriomyza spp. such as Liriomyza sativae, Liriomyza trifolii; Lucilia spp. such as Lucilia caprina, Lucilia cuprina, Lucilia sericata; Lycoria pectoralis, Mansonia titillanus, Mayetiola spp. such as Mayetiola destructor; Musca spp. such as Musca autumnalis, Musca domestica; Muscina stabulans, Oestrus spp. such as Oestrus ovis; Opomyza florum, Oscinella spp. such as Oscinella frit; Pegomya hysocyami, Phlebotomus argentipes, Phorbia spp. such as Phorbia antiqua, Phorbia brassicae, Phorbia coarctata; Prosimulium mixtum, Psila rosae, Psorophora columbiae, Psorophora discolor, Rhagoletis cerasi, Rhagoletis pomonella, Sarcophaga spp. such as Sarcophaga haemorrhoidalis; Simulium vittatum, Stomoxys spp. such as Stomoxys calcitrans; Tabanus spp. such as Tabanus atratus, Tabanus bovinus, Tabanus lineola, Tabanus similis; Tannia spp., Tipula oleracea, Tipula paludosa, and Wohlfahrtia spp.,
   thrips (Thysanoptera), e.g. Baliothrips biformis, Dichromothrips corbetti, Dichromothrips ssp., Enneothrips flavens, Frankliniella spp. such as Frankliniella fusca, Frankliniella occidentalis, Frankliniella tritici; Heliothrips spp., Hercinothrips femoralis, Kakothrips spp., Rhipiphorothrips cruentatus, Scirtothrips spp. such as Scirtothrips citri; Taeniothrips cardamoni, Thrips spp. such as Thrips oryzae, Thrips palmi, Thrips tabaci;
   termites (Isoptera), e.g. Calotermes flavicollis, Coptotermes formosanus, Heterotermes aureus, Heterotermes Iongiceps, Heterotermes tenuis, Leucotermes flavipes, Odontotermes spp., Reticulitermes spp. such as Reticulitermes speratus, Reticulitermes flavipes, Reticulitermes grassei, Reticulitermes lucifugus, Reticulitermes santonensis, Reticulitermes virginicus; Termes natalensis,
   cockroaches (Blattaria-Blattodea), e.g. Acheta domesticus, Blatta orientalis, Blattella asahinae, Blattella germanica, Gryllotalpa spp., Leucophaea maderae, Locusta spp., Melanoplus spp., Periplaneta americana, Periplaneta australasiae, Periplaneta brunnea, Periplaneta fuligginosa, Periplaneta japonica,
   bugs, aphids, leafhoppers, whiteflies, scale insects, cicadas (Hemiptera), e.g. Acrosternum spp. such as Acrosternum hilare; Acyrthosipon spp. such as Acyrthosiphon onobrychis, Acyrthosiphon pisum; Adelges laricis, Aeneolamia spp., Agonoscena spp., Aleurodes spp., Aleurolobus barodensis, Aleurothrixus spp., Amrasca spp., Anasa tristis, Antestiopsis spp., Anuraphis cardui, Aonidiella spp., Aphanostigma piri, Aphidula nasturtii, Aphis spp. such as Aphis fabae, Aphis forbesi, Aphis gossypii, Aphis grossulariae, Aphis pomi, Aphis sambuci, Aphis schneideri, Aphis spiraecola; Arboridia apicalis, Arilus critatus, Aspidiella spp., Aspidiotus spp., Atanus spp., Aulacorthum solani, Bemisia spp. such as Bemisia argentifolii, Bemisia tabaci; Blissus spp. such as Blissus leucopterus; Brachycaudus cardui, Brachycaudus helichrysi, Brachycaudus persicae, Brachycaudus prunicola, Brachycolus spp., Brevicoryne brassicae, Calligypona marginata, Calocoris spp., Campylomma livida, Capitophorus horni, Carneocephala fulgida, Cavelerius spp., Ceraplastes spp., Ceratovacuna lanigera, Cercopidae, Cerosipha gossypii, Chaetosiphon fragaefolii, Chionaspis tegalensis, Chlorita onukii, Chromaphis juglandicola, Chrysomphalus ficus, Cicadulina mbila, Cimex spp. such as Cimex hemipterus, Cimex lectularius; Coccomytilus halli, Coccus spp., Creontiades dilutus, Cryptomyzus ribis, Cryptomyzus ribis, Cyrtopeltis notatus, Dalbulus spp., Dasynus piperis, Dialeurades spp., Diaphorina spp., Diaspis spp., Dichelops furcatus, Diconocoris hewetti, Doralis spp., Dreyfusia nordmannianae, Dreyfusia piceae, Drosicha spp., Dysaphis spp. such as Dysaphis plantaginea, Dysaphis pyri, Dysaphis radicola; Dysaulacorthum pseudosolani, Dysdercus spp. such as Dysdercus cingulatus, Dysdercus intermedius; Dysmicoccus spp., Empoasca spp. such as Empoasca fabae, Empoasca solana; Eriosoma spp., Erythroneura spp., Eurygaster spp. such as Eurygaster integriceps; Euscelis bilobatus, Euschistus spp. such as Euschistuos heros, Euschistus impictiventris, Euschistus servus; Geococcus coffeae, Halyomorpha spp. such as Halyomorpha halys; Heliopeltis spp., Homalodisca coagulata, Horcias nobilellus, Hyalopterus pruni, Hyperomyzus lactucae, Icerya spp., Idiocerus spp., Idioscopus spp., Laodelphax striatellus, Lecanium spp., Lepidosaphes spp., Leptocorisa spp., Leptoglossus phyllopus, Lipaphis erysimi, Lygus spp. such as Lygus hesperus, Lygus lineolaris, Lygus pratensis; Macropes excavatus, Macrosiphum spp. such as Macrosiphum rosae, Macrosiphum avenae, Macrosiphum euphorbiae; Mahanarva fimbriolata, Megacopta cribraria, Megoura viciae, Melanaphis pyrarius, Melanaphis sacchari, Metcafiella spp., Metopolophium dirhodum, Miridae spp., Monellia costalis, Monelliopsis pecanis, Myzus spp. such as Myzus ascalonicus, Myzus cerasi, Myzus persicae, Myzus varians; Nasonovia ribis-nigri, Nephotettix spp. such as Nephotettix malayanus, Nephotettix nigropictus, Nephotettix parvus, Nephotettix virescens; Nezara spp. such as Nezara viridula; Nilaparvata lugens, Oebalus spp., Oncometopia spp., Orthezia praelonga, Parabemisia myricae, Paratrioza spp., Parlatoria spp., Pemphigus spp. such as Pemphigus bursarius; Pentomidae, Peregrinus maidis, Perkinsiella saccharicida, Phenacoccus spp., Phloeomyzus passerinii, Phorodon humuli, Phylloxera spp., Piesma quadrata, Piezodorus spp. such as Piezodorus guildinii, Pinnaspis aspidistrae, Planococcus spp., Protopulvinaria pyriformis, Psallus seriatus, Pseudacysta persea, Pseudaulacaspis pentagona, Pseudococcus spp. such as Pseudococcus comstocki; Psylla spp. such as Psylla mali, Psylla piri; Pteromalus spp., Pyrilla spp., Quadraspidiotus spp., Quesada gigas, Rastrococcus spp., Reduvius senilis, Rhodnius spp., Rhopalomyzus ascalonicus, Rhopalosiphum spp. such as Rhopalosiphum pseudobrassicas, Rhopalosiphum insertum, Rhopalosiphum maidis, Rhopalosiphum padi; Sagatodes spp., Sahlbergella singularis, Saissetia spp., Sappaphis mala, Sappaphis mali, Scaphoides titanus, Schizaphis graminum, Schizoneura lanuginosa, Scotinophora spp., Selenaspidus articulatus, Sitobion avenae, Sogata spp., Sogatella furcifera, Solubea insularis, Stephanitis nashi, Stictocephala festina, Tenalaphara malayensis, Thyanta spp. such as Thyanta perditor; Tibraca spp., Tinocallis caryaefoliae, Tomaspis spp., Toxoptera spp. such as Toxoptera aurantii; Trialeurodes spp. such as Trialeurodes vaporariorum; Triatoma spp., Trioza spp., Typhlocyba spp., Unaspis spp. such as Unaspis yanonensis; and Viteus vitifolii,
   ants, bees, wasps, sawflies (Hymenoptera), e.g. Athalia rosae, Atta capiguara, Atta cephalotes, Atta cephalotes, Atta laevigata, Atta robusta, Atta sexdens, Atta texana, Bombus spp., Camponotus floridanus, Crematogaster spp., Dasymutilla occidentalis, Diprion spp., Dolichovespula maculata, Hoplocampa spp. such as Hoplocampa minuta, Hoplocampa testudinea; Lasius spp. such as Lasius niger, Linepithema humile, Monomorium pharaonis, Paravespula germanica, Paravespula pennsylvanica, Paravespula vulgaris, Pheidole megacephala, Pogonomyrmex barbatus, Pogonomyrmex californicus, Polistes rubiginosa, Solenopsis geminata, Solenopsis invicta, Solenopsis richteri, Solenopsis xyloni, Vespa spp. such as Vespa crabro, and Vespula squamosa,
   crickets, grasshoppers, locusts (Orthoptera), e.g. Acheta domestica, Calliptamus italicus, Chortoicetes terminifera, Dociostaurus maroccanus, Gryllotalpa africana, Gryllotalpa gryllotalpa, Hieroglyphus daganensis, Kraussaria angulifera, Locusta migratoria, Locustana pardalina, Melanoplus bivittatus, Melanoplus femurrubrum, Melanoplus mexicanus, Melanoplus sanguinipes, Melanoplus spretus, Nomadacris septemfasciata, Oedaleus senegalensis, Schistocerca americana, Schistocerca gregaria, Tachycines asynamorus, and Zonozerus variegatus,
   arachnids (Arachnida), such as acari, e.g. of the families Argasidae, Ixodidae and Sarcoptidae, such as Amblyomma spp. (e.g. Amblyomma americanum, Amblyomma variegatum, Amblyomma maculatum), Argas spp. (e.g. Argas persicus), Boophilus spp. (e.g. Boophilus annulatus, Boophilus decoloratus, Boophilus microplus), Dermacentor silvarum, Dermacentor andersoni, Dermacentor variabilis, Hyalomma spp. (e.g. Hyalomma truncatum), Ixodes spp. (e.g. Ixodes ricinus, Ixodes rubicundus, Ixodes scapularis, Ixodes holocyclus, Ixodes pacificus), Ornithodorus spp. (e.g. Ornithodorus moubata, Ornithodorus hermsi, Ornithodorus turicata), Ornithonyssus bacoti, Otobius megnini, Dermanyssus gallinae, Psoroptes spp. (e.g. Psoroptes ovis), Rhipicephalus spp. (e.g. Rhipicephalus sanguineus, Rhipicephalus appendiculatus, Rhipicephalus evertsi), Rhizoglyphus spp., Sarcoptes spp. (e.g. Sarcoptes scabiei), and Eriophyidae spp. such as Acaria sheldoni, Aculops spp. (e.g. Aculops pelekassi) Aculus spp. (e.g. Aculus schlechtendali), Epitrimerus pyri, Phyllocoptruta oleivora and Eriophyes spp. (e.g. Eriophyes sheldoni); Tarsonemidae spp. such as Hemitarsonemus spp., Phytonemus pallidus and Polyphagotarsonemus latus, Stenotarsonemus spp.; Tenuipalpidae spp. such as Brevipalpus spp. (e.g. Brevipalpus phoenicis); Tetranychidae spp. such as Eotetranychus spp., Eutetranychus spp., Oligonychus spp., Tetranychus cinnabarinus, Tetranychus kanzawai, Tetranychus pacificus, Tetranychus telarius and Tetranychus urticae; Bryobia praetiosa, Panonychus spp. (e.g. Panonychus ulmi, Panonychus citri), Metatetranychus spp. and Oligonychus spp. (e.g. Oligonychus pratensis), Vasates lycopersici; Araneida, e.g. Latrodectus mactans, and Loxosceles reclusa. And Acarus siro, Chorioptes spp., Scorpio maurus
   fleas (Siphonaptera), e.g. Ceratophyllus spp., Ctenocephalides felis, Ctenocephalides canis, Xenopsylla cheopis, Pulex irritans, Tunga penetrans, and Nosopsyllus fasciatus,
   silverfish, firebrat (Thysanura), e.g. Lepisma saccharina and Thermobia domestica,
   centipedes (Chilopoda), e.g. Geophilus spp., Scutigera spp. such as Scutigera coleoptrata;
   millipedes (Diplopoda), e.g. Blaniulus guttulatus, Narceus spp.,
   Earwigs (Dermaptera), e.g. forficula auricularia,
   lice (Phthiraptera), e.g. Damalinia spp., Pediculus spp. such as Pediculus humanus capitis, Pediculus humanus corporis; Pthirus pubis, Haematopinus spp. such as Haematopinus eurysternus, Haematopinus suis; Linognathus spp. such as Linognathus vituli; Bovicola bovis, Menopon gallinae, Menacanthus stramineus and Solenopotes capillatus, Trichodectes spp.,
   springtails (Collembola), e.g. Onychiurus ssp. such as Onychiurus armatus,

They are also suitable for controlling nematodes: plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species such as Aphelenchoides besseyi; Sting nematodes, Belonolaimus longicaudatus and other Belonolaimus species; Pine nematodes, Bursaphelenchus lignicolus Mamiya et Kiyohara, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus brachyurus, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus, Rotylenchus reniformis and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species such as Tylenchulus semipenetrans; Dagger nematodes, Xiphinema species; and other plant parasitic nematode species.

Examples of further pest species which may be controlled by compounds of formula (I) include: from the class of the Bivalva, for example, Dreissena spp.; from the class of the Gastropoda, for example, Arion spp., Biomphalaria spp., Bulinus spp., Deroceras spp., Galba spp., Lymnaea spp., Oncomelania spp., Succinea spp.; from the class of the helminths, for example, Ancylostoma duodenale, Ancylostoma ceylanicum, Acylostoma braziliensis, Ancylostoma spp., Ascaris lumbricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp. such as Haemonchus contortus; Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercora lis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti; from the order of the Isopoda, for example, Armadillidium vulgare, Oniscus asellus, Porcellio scaber; from the order of the Symphyla, for example, Scutigerella immaculata.

Further examples of pest species which may be controlled by compounds of formula (I) include: Anisoplia austriaca, Apamea spp., Austroasca viridigrisea, Baliothrips biformis, Caenorhabditis elegans, Cephus spp., Ceutorhynchus napi, Chaetocnema aridula, Chilo auricilius, Chilo indicus, Chilo polychrysus, Chortiocetes terminifera, Cnaphalocroci medinalis, Cnaphalocrosis spp., Colias eurytheme, Collops spp., Cornitermes cumulans, Creontiades spp., Cyclocephala spp., Dalbulus maidis, Deraceras reticulatum, Diatrea saccharalis, Dichelops furcatus, Dicladispa armigera, Diloboderus spp. such as Diloboderus abderus; Edessa spp., Epinotia spp., Formicidae, Geocoris spp., Globitermes sulfureus, Gryllotalpidae, Halotydeus destructor, Hipnodes bicolor, Hydrellia philippina, Julus spp., Laodelphax spp., Leptocorsia acuta, Leptocorsia oratorius, Liogenys fuscus, Lucillia spp., Lyogenys fuscus, Mahanarva spp., Maladera matrida, Marasmia spp., Mastotermes spp., Mealybugs, Megascelis ssp, Metamasius hemipterus, Microtheca spp., Mocis latipes, Murgantia spp., Mythemina separata, Neocapritermes opacus, Neocapritermes parvus, Neomegalotomus spp., Neotermes spp., Nymphula depunctalis, Oebalus pugnax, Orseolia spp. such as Orseolia oryzae; Oxycaraenus hyalinipennis, Plusia spp., Pomacea canaliculata, Procornitermes ssp., Procornitermes triacifer, Psylloides spp., Rachiplusia spp., Rhodopholus spp., Scaptocoris castanea, Scaptocoris spp., Scirpophaga spp. such as Scirpophaga incertulas, Scirpophaga innotata; Scotinophara spp. such as Scotinophara coarctata; Sesamia spp. such as Sesamia inferens, Sogaella frucifera, Solenapsis geminata, Spissistilus spp., Stalk borer, Stenchaetothrips biformis, Steneotarsonemus spinki, Sylepta derogata, Telehin licus, Trichostrongylus spp.

Mixtures of the present invention are particularly useful for controlling insects, preferably sucking or piercing insects such as insects from the genera Thysanoptera, Diptera and Hemiptera, and chewing-biting pests such as insects from the genera of Lepidoptera and Coleoptera, in particular the following species: Thysanoptera: Frankliniella fusca, Frankliniella occidentalis, Frankliniella tritici, Scirtothrips citri, Thrips oryzae, Thrips palmi and Thrips tabaci,
Diptera, e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca autumnalis, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga spp., Simulium vittatum, Stomoxys calcitrans, Tabanus bovinus, Tabanus atratus, Tabanus lineola, and Tabanus similis, Tipula oleracea, and Tipula paludosa;
Hemiptera, in particular aphids: Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii.
Lepidoptera, in particular: Agrotis ipsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis.

Mixtures of the present invention are particularly useful for controlling insects from the order of Coleoptera, in particular Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Otiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria.

Mixtures of the present invention are particularly useful for controlling insects of the orders Lepidoptera, Coleoptera, Hemiptera and Thysanoptera.

The mixtures of the present invention are especially suitable for efficiently combating pests like insects from the order of the lepidopterans (Lepidoptera), beetles (Coleoptera), flies and mosquitoes (Diptera), thrips (Thysanoptera), termites (Isoptera), bugs, aphids, leafhoppers, whiteflies, scale insects, cicadas (Hemiptera), ants, bees, wasps, sawflies (Hymenoptera), crickets, grasshoppers, locusts (Orthoptera), and also Arachnoidea, such as arachnids (Acarina).

In a preferred embodiment, the mixtures according to the invention, especially the mixtures as individualized herein, especially the mixtures according to table M as shown above, have the following application types:

TABLE AP-T

| Appl. | | |
|---|---|---|
| type | Crop | Pest |
| AP-T-1 | Soybeans | Spodoptera |
| | | littoralis |
| AP-T-2 | Soybeans | Anticarsia |
| | | gemmatalis |
| AP-T-3 | Soybeans | Spodoptera |
| | | exigua |
| AP-T-4 | Soybeans | Stinkbug |
| AP-T-5 | Soybeans | Helicoverpa sp. |
| AP-T-6 | Soybeans | Spodoptera |
| | | eridania |
| AP-T-7 | Corn | Spodoptera |
| | | Frugiperta |
| AP-T-8 | Corn | Spodoptera |
| | | exigua |
| AP-T-9 | Rice | Sesamia inferens |
| AP-T-10 | Rice | Cnaphalocerus |
| | | medinalis |
| AP-T-11 | Rice | Chilo |
| | | suppressalis |
| AP-T-12 | Rice | Leptocorisa |
| | | oratorius |
| AP-T-13 | Rice | Brown plant |
| | | hopper |
| AP-T-14 | Cotton | Spodoptera |
| | | littoralis |
| AP-T-15 | Cotton | Thrips spp. |
| AP-T-16 | Cotton | Spodoptera |
| | | eridania |
| AP-T-17 | Cotton | Helicoverpa sp. |
| AP-T-18 | Canola | Pollen beetle |
| AP-T-19 | SPC | Tuta Absoluta |
| AP-T-20 | SPC | Fruit Borer |
| AP-T-21 | SPC | Spodoptera |
| | | littoralis |
| AP-T-22 | SPC | Plusia gamma |
| AP-T-23 | SPC | Plutella xylostella |
| AP-T-24 | SPC | Frankliniella |
| | | occidentalis |
| AP-T-25 | SPC | Trichoplusia ni |
| AP-T-26 | SPC | Pieris rapae |
| AP-T-27 | SPC | Spodoptera sp. |
| AP-T-28 | SPC | Crocidolomia |
| | | pavonana |
| AP-T-29 | SPC | Pyrausta |
| | | furnacalis |
| AP-T-30 | SPC | Liromyza trifolii |
| AP-T-31 | SPC | Cydia pomonella |
| AP-T-32 | SPC | Epitrix sp. |
| AP-T-33 | SPC | Leptinotarsa |
| | | decemlineata |
| AP-T-34 | SPC | Bemisia tabaci |
| AP-T-35 | SPC | Thrips tabaci |
| AP-T-36 | SPC | Spodoptera |
| | | eridania |
| AP-T-37 | SPC | Lobesia botrana |
| AP-T-38 | SPC | Altica chapybea |
| AP-T-39 | SPC | Phyllocnistis |
| | | citrella |
| AP-T-40 | SPC-FV | Tuta Absoluta |
| AP-T-41 | SPC-FV | Fruit Borer |
| AP-T-42 | SPC-FV | Spodoptera |
| | | littoralis |
| AP-T-43 | SPC-FV | Plusia gamma |
| AP-T-44 | SPC-FV | Plutella xylostella |
| AP-T-45 | SPC-FV | Frankliniella |
| | | occidentalis |
| AP-T-46 | SPC-FV | Trichoplusia ni |
| AP-T-47 | SPC-FV | Pieris rapae |
| AP-T-48 | SPC-FV | Spodoptera sp. |
| AP-T-49 | SPC-FV | Crocidolomia |
| | | pavonana |
| AP-T-50 | SPC-FV | Pyrausta |
| | | furnacalis |
| AP-T-51 | SPC-FV | Liromyza trifolii |
| AP-T-52 | SPC-FV | Cydia pomonella |
| AP-T-53 | SPC-FV | Epitrix sp. |
| AP-T-54 | SPC-FV | Leptinotarsa |
| | | decemlineata |
| AP-T-55 | SPC-FV | Bemisia tabaci |
| AP-T-56 | SPC-FV | Thrips tabaci |
| AP-T-57 | SPC-FV | Spodoptera |
| | | eridania |
| AP-T-58 | SPC-FV | Lobesia botrana |
| AP-T-59 | SPC-FV | Altica chapybea |
| AP-T-60 | SPC-FV | Phyllocnistis |
| | | citrella |
| AP-T-61 | Tomato | Tuta Absoluta |
| AP-T-62 | Tomato | Fruit Borer |
| AP-T-63 | Tomato | Spodoptera |
| | | littoralis |
| AP-T-64 | Tomato | Plusia gamma |
| AP-T-65 | Tomato | Plutella xylostella |
| AP-T-66 | Tomato | Frankliniella |
| | | occidentalis |
| AP-T-67 | Tomato | Trichoplusia ni |
| AP-T-68 | Tomato | Pieris rapae |
| AP-T-69 | Tomato | Spodoptera sp. |
| AP-T-70 | Tomato | Crocidolomia |
| | | pavonana |
| AP-T-71 | Tomato | Pyrausta |
| | | furnacalis |
| AP-T-72 | Tomato | Liromyza trifolii |
| AP-T-73 | Tomato | Cydia pomonella |
| AP-T-74 | Tomato | Epitrix sp. |
| AP-T-75 | Tomato | Leptinotarsa |
| | | decemlineata |
| AP-T-76 | Tomato | Bemisia tabaci |
| AP-T-77 | Tomato | Thrips tabaci |
| AP-T-78 | Tomato | Spodoptera |
| | | eridania |
| AP-T-79 | Tomato | Lobesia botrana |
| AP-T-80 | Tomato | Altica chapybea |
| AP-T-81 | Tomato | Phyllocnistis |
| | | citrella |
| AP-T-82 | Pepper | Tuta Absoluta |
| AP-T-83 | Pepper | Fruit Borer |
| AP-T-84 | Pepper | Spodoptera |
| | | littoralis |
| AP-T-85 | Pepper | Plusia gamma |
| AP-T-86 | Pepper | Plutella xylostella |
| AP-T-87 | Pepper | Frankliniella |
| | | occidentalis |
| AP-T-88 | Pepper | Trichoplusia ni |
| AP-T-89 | Pepper | Pieris rapae |
| AP-T-90 | Pepper | Spodoptera sp. |
| AP-T-91 | Pepper | Crocidolomia |
| | | pavonana |
| AP-T-92 | Pepper | Pyrausta |
| | | furnacalis |
| AP-T-93 | Pepper | Liromyza trifolii |
| AP-T-94 | Pepper | Cydia pomonella |
| AP-T-95 | Pepper | Epitrix sp. |
| AP-T-96 | Pepper | Leptinotarsa |
| | | decemlineata |
| AP-T-97 | Pepper | Bemisia tabaci |
| AP-T-98 | Pepper | Thrips tabaci |
| AP-T-99 | Pepper | Spodoptera |
| | | eridania |
| AP-T-100 | Pepper | Lobesia botrana |
| AP-T-101 | Pepper | Altica chapybea |
| AP-T-102 | Pepper | Phyllocnistis |
| | | citrella |
| AP-T-103 | Eggplant | Tuta Absoluta |
| AP-T-104 | Eggplant | Fruit Borer |
| AP-T-105 | Eggplant | Spodoptera |
| | | littoralis |
| AP-T-106 | Eggplant | Plusia gamma |
| AP-T-107 | Eggplant | Plutella xylostella |
| AP-T-108 | Eggplant | Frankliniella |
| | | occidentalis |
| AP-T-109 | Eggplant | Trichoplusia ni |
| AP-T-110 | Eggplant | Pieris rapae |
| AP-T-111 | Eggplant | Spodoptera sp. |
| AP-T-112 | Eggplant | Crocidolomia |
| | | pavonana |
| AP-T-113 | Eggplant | Pyrausta |
| | | furnacalis |
| AP-T-114 | Eggplant | Liromyza trifolii |
| AP-T-115 | Eggplant | Cydia pomonella |
| AP-T-116 | Eggplant | Epitrix sp. |
| AP-T-117 | Eggplant | Leptinotarsa |
| | | decemlineata |
| AP-T-118 | Eggplant | Bemisia tabaci |
| AP-T-119 | Eggplant | Thrips tabaci |
| AP-T-120 | Eggplant | Spodoptera |
| | | eridania |
| AP-T-121 | Eggplant | Lobesia botrana |
| AP-T-122 | Eggplant | Altica chapybea |
| AP-T-123 | Eggplant | Phyllocnistis |
| | | citrella |
| AP-T-124 | SPC-LV | Tuta Absoluta |
| AP-T-125 | SPC-LV | Fruit Borer |
| AP-T-126 | SPC-LV | Spodoptera |
| | | littoralis |
| AP-T-127 | SPC-LV | Plusia gamma |
| AP-T-128 | SPC-LV | Plutella xylostella |
| AP-T-129 | SPC-LV | Frankliniella |
| | | occidentalis |
| AP-T-130 | SPC-LV | Trichoplusia ni |
| AP-T-131 | SPC-LV | Pieris rapae |
| AP-T-132 | SPC-LV | Spodoptera sp. |
| AP-T-133 | SPC-LV | Crocidolomia |
| | | pavonana |
| AP-T-134 | SPC-LV | Pyrausta |
| | | furnacalis |
| AP-T-135 | SPC-LV | Liromyza trifolii |
| AP-T-136 | SPC-LV | Cydia pomonella |
| AP-T-137 | SPC-LV | Epitrix sp. |
| AP-T-138 | SPC-LV | Leptinotarsa |
| | | decemlineata |
| AP-T-139 | SPC-LV | Bemisia tabaci |
| AP-T-140 | SPC-LV | Thrips tabaci |
| AP-T-141 | SPC-LV | Spodoptera |
| | | eridania |
| AP-T-142 | SPC-LV | Lobesia botrana |
| AP-T-143 | SPC-LV | Altica chapybea |
| AP-T-144 | SPC-LV | Phyllocnistis |
| | | citrella |
| AP-T-145 | Cabbage | Tuta Absoluta |
| AP-T-146 | Cabbage | Fruit Borer |
| AP-T-147 | Cabbage | Spodoptera |
| | | littoralis |
| AP-T-148 | Cabbage | Plusia gamma |
| AP-T-149 | Cabbage | Plutella xylostella |
| AP-T-150 | Cabbage | Frankliniella |
| | | occidentalis |
| AP-T-151 | Cabbage | Trichoplusia ni |
| AP-T-152 | Cabbage | Pieris rapae |
| AP-T-153 | Cabbage | Spodoptera sp. |
| AP-T-154 | Cabbage | Crocidolomia |
| | | pavonana |
| AP-T-155 | Cabbage | Pyrausta |
| | | furnacalis |
| AP-T-156 | Cabbage | Liromyza trifolii |
| AP-T-157 | Cabbage | Cydia pomonella |
| AP-T-158 | Cabbage | Epitrix sp. |
| AP-T-159 | Cabbage | Leptinotarsa |
| | | decemlineata |
| AP-T-160 | Cabbage | Bemisia tabaci |
| AP-T-161 | Cabbage | Thrips tabaci |
| AP-T-162 | Cabbage | Spodoptera |
| | | eridania |
| AP-T-163 | Cabbage | Lobesia botrana |
| AP-T-164 | Cabbage | Altica chapybea |
| AP-T-165 | Cabbage | Phyllocnistis |
| | | citrella |
| AP-T-166 | Lettuce | Tuta Absoluta |
| AP-T-167 | Lettuce | Fruit Borer |
| AP-T-168 | Lettuce | Spodoptera |
| | | littoralis |
| AP-T-169 | Lettuce | Plusia gamma |
| AP-T-170 | Lettuce | Plutella xylostella |
| AP-T-171 | Lettuce | Frankliniella |
| | | occidentalis |
| AP-T-172 | Lettuce | Trichoplusia ni |
| AP-T-173 | Lettuce | Pieris rapae |
| AP-T-174 | Lettuce | Spodoptera sp. |
| AP-T-175 | Lettuce | Crocidolomia |
| | | pavonana |
| AP-T-176 | Lettuce | Pyrausta |
| | | furnacalis |
| AP-T-177 | Lettuce | Liromyza trifolii |
| AP-T-178 | Lettuce | Cydia pomonella |
| AP-T-179 | Lettuce | Epitrix sp. |
| AP-T-180 | Lettuce | Leptinotarsa |
| | | decemlineata |
| AP-T-181 | Lettuce | Bemisia tabaci |
| AP-T-182 | Lettuce | Thrips tabaci |
| AP-T-183 | Lettuce | Spodoptera |
| | | eridania |
| AP-T-184 | Lettuce | Lobesia botrana |
| AP-T-185 | Lettuce | Altica chapybea |
| AP-T-186 | Lettuce | Phyllocnistis |
| | | citrella |
| AP-T-187 | SPC-T | Tuta Absoluta |
| AP-T-188 | SPC-T | Fruit Borer |
| AP-T-189 | SPC-T | Spodoptera |
| | | littoralis |
| AP-T-190 | SPC-T | Plusia gamma |
| AP-T-191 | SPC-T | Plutella xylostella |
| AP-T-192 | SPC-T | Frankliniella |
| | | occidentalis |
| AP-T-193 | SPC-T | Trichoplusia ni |
| AP-T-194 | SPC-T | Pieris rapae |
| AP-T-195 | SPC-T | Spodoptera sp. |
| AP-T-196 | SPC-T | Crocidolomia |
| | | pavonana |
| AP-T-197 | SPC-T | Pyrausta |
| | | furnacalis |
| AP-T-198 | SPC-T | Liromyza trifolii |
| AP-T-199 | SPC-T | Cydia pomonella |
| AP-T-200 | SPC-T | Epitrix sp. |
| AP-T-201 | SPC-T | Leptinotarsa |
| | | decemlineata |
| AP-T-202 | SPC-T | Bemisia tabaci |
| AP-T-203 | SPC-T | Thrips tabaci |
| AP-T-204 | SPC-T | Spodoptera |
| | | eridania |
| AP-T-205 | SPC-T | Lobesia botrana |
| AP-T-206 | SPC-T | Altica chapybea |
| AP-T-207 | SPC-T | Phyllocnistis |
| | | citrella |
| AP-T-208 | Potatoes | Tuta Absoluta |
| AP-T-209 | Potatoes | Fruit Borer |
| AP-T-210 | Potatoes | Spodoptera |
| | | littoralis |
| AP-T-211 | Potatoes | Plusia gamma |
| AP-T-212 | Potatoes | Plutella xylostella |
| AP-T-213 | Potatoes | Frankliniella |
| | | occidentalis |
| AP-T-214 | Potatoes | Trichoplusia ni |
| AP-T-215 | Potatoes | Pieris rapae |
| AP-T-216 | Potatoes | Spodoptera sp. |
| AP-T-217 | Potatoes | Crocidolomia |
| | | pavonana |
| AP-T-218 | Potatoes | Pyrausta |
| | | furnacalis |
| AP-T-219 | Potatoes | Liromyza trifolii |
| AP-T-220 | Potatoes | Cydia pomonella |
| AP-T-221 | Potatoes | Epitrix sp. |
| AP-T-222 | Potatoes | Leptinotarsa |
| | | decemlineata |
| AP-T-223 | Potatoes | Bemisia tabaci |
| AP-T-224 | Potatoes | Thrips tabaci |
| AP-T-225 | Potatoes | Spodoptera |
| | | eridania |
| AP-T-226 | Potatoes | Lobesia botrana |
| AP-T-227 | Potatoes | Altica chapybea |
| AP-T-228 | Potatoes | Phyllocnistis |
| | | citrella |
| AP-T-229 | Potatoes | wireworm |
| AP-T-230 | Onions | Tuta Absoluta |
| AP-T-231 | Onions | Fruit Borer |
| AP-T-232 | Onions | Spodoptera |
| | | littoralis |
| AP-T-233 | Onions | Plusia gamma |
| AP-T-234 | Onions | Plutella xylostella |
| AP-T-235 | Onions | Frankliniella |
| | | occidentalis |
| AP-T-236 | Onions | Trichoplusia ni |
| AP-T-237 | Onions | Pieris rapae |
| AP-T-238 | Onions | Spodoptera sp. |
| AP-T-239 | Onions | Crocidolomia |
| | | pavonana |
| AP-T-240 | Onions | Pyrausta |
| | | furnacalis |
| AP-T-241 | Onions | Liromyza trifolii |
| AP-T-242 | Onions | Cydia pomonella |
| AP-T-243 | Onions | Epitrix sp. |
| AP-T-244 | Onions | Leptinotarsa |
| | | decemlineata |
| AP-T-245 | Onions | Bemisia tabaci |
| AP-T-246 | Onions | Thrips tabaci |
| AP-T-247 | Onions | Spodoptera |
| | | eridania |
| AP-T-248 | Onions | Lobesia botrana |
| AP-T-249 | Onions | Altica chapybea |
| AP-T-250 | Onions | Phyllocnistis |
| | | citrella |
| AP-T-251 | ST | Agrotis ipsilon |
| AP-T-252 | ST | Spodoptera |
| | | frugiperta |
| AP-T-253 | ST | Phyllotreta sp. |
| AP-T-254 | ST | Stem Girdler |
| AP-T-255 | ST | Agriotes sp. |
| AP-T-256 | ST | Delia platura |

(Abbreviations: SPC = specialty crops; SPC-FV = fruiting vegetable; SPC-LV = leafy vegetable; SPC-T: tubers; ST = seed treatment)

### Formulations

The mixtures according to the present invention can be converted into the customary formulations, for example solutions, emulsions, suspensions, dusts, powders, pastes and granules. The use form depends on the particular intended purpose; in each case, it should ensure a fine and even distribution of the compounds of the mixtures according to the invention.

Therefore the invention also relates to agrochemical compositions comprising an auxiliary and a mixture according to the invention, i.e. a mixture of at least one compound I of formula I and of at least one compound II according to the present invention.

An agrochemical composition comprises a pesticidally effective amount of a pesticidal mixture. The term “effective amount” denotes an amount of the composition or of the mixture, which is sufficient for controlling harmful pests on cultivated plants or in the protection of materials and which does not result in a substantial damage to the treated plants. Such an amount can vary in a broad range and is dependent on various factors, such as the animal pests species to be controlled, the treated cultivated plant or material, the climatic conditions and the specific mixture used.

The mixtures according to the present invention can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Examples for suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl [symbol] naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides.

Examples of esters are fatty acid esters, glycerol esters or monoglycerides. Examples of sugar-based surfactants are sorbitans, ethoxylated sorbitans, sucrose and glucose esters or alkyl-polyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide.

Suitable polyelectrolytes are polyacids or polybases. Examples of polyacids are alkali salts of polyacrylic acid or polyacid comb polymers. Examples of polybases are polyvinylamines or polyethyleneamines. Suitable adjuvants are compounds, which have a neglectable or even no pesticidal activity themselves, and which improve the biological performance of the compound I or II or the mixture according to the invention on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for composition types and their preparation are:

### i) Water-Soluble Concentrates (SL, LS)

10-60 wt % of a compound I or II or a mixture according to the invention and 5-15 wt % wetting agent (e.g. alcohol alkoxylates) are dissolved in water and/or in a water-soluble solvent (e.g. alcohols) up to 100 wt %. The active substance dissolves upon dilution with water.

### ii) Dispersible Concentrates (DC)

5-25 wt % of a compound I or II or a mixture according to the invention and 1-10 wt % dispersant (e. g. polyvinylpyrrolidone) are dissolved in up to 100 wt % organic solvent (e.g. cyclohexanone). Dilution with water gives a dispersion.

iii) Emulsifiable Concentrates (EC)

15-70 wt % of a compound I or II or a mixture according to the invention and 5-10 wt % emulsifiers (e.g. calcium dodecylbenzenesulfonate and castor oil ethoxylate) are dissolved in up to 100 wt % water-insoluble organic solvent (e.g. aromatic hydrocarbon). Dilution with water gives an emulsion.

### iv) Emulsions (EW, EO, ES)

5-40 wt % of a compound I or II or a mixture according to the invention and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into up to 100 wt % water by means of an emulsifying machine and made into a homogeneous emulsion. Dilution with water gives an emulsion.

### v) Suspensions (SC, OD, FS)

In an agitated ball mill, 20-60 wt % of a compound I or II or a mixture according to the invention are comminuted with addition of 2-10 wt % dispersants and wetting agents (e.g. sodium lignosulfonate and alcohol ethoxylate), 0.1-2 wt % thickener (e.g. xanthan gum) and up to 100 wt % water to give a fine active substance suspension. Dilution with water gives a stable suspension of the active substance. For FS type composition up to 40 wt % binder (e.g. polyvinylalcohol) is added.

### vi) Water-Dispersible Granules and Water-Soluble Granules (WG, SG)

50-80 wt % of a compound I or II or a mixture according to the invention are ground finely with addition of up to 100 wt % dispersants and wetting agents (e.g. sodium lignosulfonate and alcohol ethoxylate) and prepared as water-dispersible or water-soluble granules by means of technical appliances (e. g. extrusion, spray tower, fluidized bed). Dilution with water gives a stable dispersion or solution of the active substance.

vii) Water-Dispersible Powders and Water-Soluble Powders (WP, SP, WS)

50-80 wt % of a compound I or II or a mixture according to the invention are ground in a rotor-stator mill with addition of 1-5 wt % dispersants (e.g. sodium lignosulfonate), 1-3 wt % wetting agents (e.g. alcohol ethoxylate) and up to 100 wt % solid carrier, e.g. silica gel. Dilution with water gives a stable dispersion or solution of the active substance.

viii) Gel (GW, GF)

In an agitated ball mill, 5-25 wt % of a compound I or II or a mixture according to the invention are comminuted with addition of 3-10 wt % dispersants (e.g. sodium lignosulfonate), 1-5 wt % thickener (e.g. carboxymethylcellulose) and up to 100 wt % water to give a fine suspension of the active substance. Dilution with water gives a stable suspension of the active substance.

### ix) Microemulsion (ME)

5-20 wt % of a compound I or II or a mixture according to the invention are added to 5-30 wt % organic solvent blend (e.g. fatty acid dimethylamide and cyclohexanone), 10-25 wt % surfactant blend (e.g. alkohol ethoxylate and arylphenol ethoxylate), and water up to 100%. This mixture is stirred for 1 h to produce spontaneously a thermodynamically stable microemulsion.

### x) Microcapsules (CS)

An oil phase comprising 5-50 wt % of a compound I or II or a mixture according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of a polyurea microcapsules. The monomers amount to 1-10 wt %. The wt % relate to the total CS composition.

### xi) Dustable Powders (DP, DS)

1-10 wt % of a compound I or II or a mixture according to the invention are ground finely and mixed intimately with up to 100 wt % solid carrier, e.g. finely divided kaolin.

xii) Granules (GR, FG)

0.5-30 wt % of a compound I or II or a mixture according to the invention is ground finely and associated with up to 100 wt % solid carrier (e.g. silicate). Granulation is achieved by extrusion, spray-drying or the fluidized bed.

xiii) Ultra-Low Volume Liquids (UL)

1-50 wt % of a compound I or II or a mixture according to the invention are dissolved in up to 100 wt % organic solvent, e.g. aromatic hydrocarbon.

The compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

In one embodiment, a suspoconcentration (SC) is preferred for the application in crop protection. In one sub-embodiment thereof, the SC agrochemical composition comprises between 50 to 500 g/L (grams per Litre), or between 100 and 250 g/L, or 100 g/L or 150 g/L or 200 g/L or 250 g/L.

In a further embodiment, the granules according to formulation type xii are especially preferred for the application in rice.

Water-soluble concentrates (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating compound I or II or a mixture according to the invention and compositions thereof, respectively, on to plant propagation material, especially seeds include dressing, coating, pelleting, dusting, soaking and in-furrow application methods of the propagation material. Preferably, compound I or the compositions thereof, respectively, are applied on to the plant propagation material by a method such that germination is not induced, e. g. by seed dressing, pelleting, coating and dusting.

When employed in plant protection, the amounts of active substances applied are, depending on the kind of effect desired, from 0.001 to 2 kg per ha, preferably from 0.001 to 1 kg per ha, more preferably from 0.005 to 0.9 kg per ha, in particular from 0.005 to 0.5 kg per ha.

In treatment of plant propagation materials such as seeds, e. g. by dusting, coating or drenching seed, amounts of active substance of from 0.1 to 1000 g, preferably from 0.1 to 300 g, more preferably from 0.1 to 100 g and most preferably from 0.25 to 100 g, per 100 kilogram of plant propagation material (preferably seed) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and other pesticides (e.g. herbicides, insecticides, fungicides, growth regulators, safeners, biopesticides) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

Biopesticides are typically created by growing and concentrating naturally occurring organisms and/or their metabolites including bacteria and other microbes, fungi, viruses, nematodes, proteins, etc. They are often considered to be important components of integrated pest management (IPM) programmes, and have received much practical attention as substitutes to synthetic chemical plant protection products (PPPs).

Biopesticides fall into two major classes, microbial and biochemical pesticides:

(1) Microbial pesticides consist of bacteria, fungi or viruses (and often include the metabolites that bacteria and fungi produce). Entomopathogenic nematodes are also classed as microbial pesticides, even though they are multi-cellular.
(2) Biochemical pesticides are naturally occurring substances that control pests or provide other crop protection uses as defined below, but are relatively non-toxic to mammals.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e. g. components comprising compounds I and/or active substances, e.g. from the groups M or F, may be mixed by the user in a spray tank and further auxiliaries and additives may be added, if appropriate.

In a further embodiment, either individual components of the composition according to the invention or partially premixed components, e. g. components comprising compounds I and/or active substances from the group M or F, can be applied jointly (e.g. after tank mix) or consecutively.

### Further Active Ingredients

Another aspect of the present invention is when preparing the mixtures, it is preferred to employ the mixture according to the invention or pure active compounds I and II, to which further active compounds, e.g. against harmful fungi or having herbicidal activity, or growth-regulating agents or fertilizers can be added.

Compositions of this invention may further contain other active ingredients than those listed above. For example fungicides, herbicides, fertilizers such as ammonium nitrate, urea, potash, and superphosphate, phytotoxicants and plant growth regulators and safeners. These additional ingredients may be used sequentially or in combination with the above-described compositions, if appropriate also added only immediately prior to use (tank mix). For example, the plant(s) may be sprayed with a composition of this invention either before or after being treated with other active ingredients.

The further active ingredients may be selected from the group M as defined for of compounds II herein, or from the following list F of active substances, in conjunction with which the mixtures according to the invention can be used, which is intended to illustrate the possible combinations but does not limit them:

### F.I) Respiration Inhibitors

F.I-1) Inhibitors of complex III at Qo site (e.g. strobilurins)
strobilurins: azoxystrobin, coumethoxystrobin, coumoxystrobin, dimoxystrobin, enestroburin, fluoxastrobin, kresoxim-methyl, mandestrobin, metominostrobin, orysastrobin, picoxystrobin, pyraclostrobin, pyrametostrobin, pyraoxystrobin, pyribencarb, triclopyricarb/chlorodincarb, trifloxystrobin, 2-[2-(2,5-dimethyl-phenoxymethyl)-phenyl]-3-methoxy-acrylic acid methyl ester and 2(2-(3-(2,6-dichlorophenyl)-1-methyl-allylideneaminooxymethyl)-phenyl)-2-methoxyimino-N methyl-acetamide;
oxazolidinediones and imidazolinones: famoxadone, fenamidone;
F.I-2) Inhibitors of complex II (e.g. carboxamides):
carboxanilides: benodanil, benzovindiflupyr, bixafen, boscalid, carboxin, fenfuram, fenhexamid, fluopyram, flutolanil, furametpyr, isofetamid, isopyrazam, isotianil, mepronil, oxycarboxin, penflufen, penthiopyrad, sedaxane, tecloftalam, thifluzamide, tiadinil, 2-amino-4 methyl-thiazole-5-carboxanilide, N-(3′,4′,5′ trifluorobiphenyl-2 yl)-3-difluoromethyl-1-methyl-1H-pyrazole-4 carboxamide(fluxapyroxad), N-(4′-trifluoromethylthiobiphenyl-2-yl)-3 difluoromethyl-1-methyl-1H pyrazole-4-carboxamide, N-(2-(1,3,3-trimethyl-butyl)-phenyl)-1,3-dimethyl-5 fluoro-1H-pyrazole-4 carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 3-(difluoromethyl)-1,5-dimethyl-N-(1,1,3-trimethylindan-4-yl)pyrazole-4-carboxamide, 3-(trifluorometh [symbol] yl)-1,5-dimethyl-N-(1,1,3-trimethylindan-4-yl) [symbol] pyrazole-4-carboxamide, 1,3,5-tri-methyl-N-(1,1,3-trimethylindan-4-yl)pyrazole-4-carboxamide, N-(7-fluoro-1,1,3-trimethyl-indan-4-yl)-1,3-dimethyl-pyrazole-4-carbox [symbol] amide, N-[2-(2,4-dichlorophenyl)-2-methoxy-1-methyl-ethyl]-3-(difluoromethyl)-1-methyl-pyrazole-4-carboxamide;
F.I-3) Inhibitors of complex III at Qi site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate, 3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate;
F.I-4) Other respiration inhibitors (complex I, uncouplers)
diflumetorim; (5,8-difluoro [symbol] quinazolin-4-yl)-{2-[2-fluoro-4-(4-trifluoromethylpyridin-2-yloxy)-phenyl]-ethyl}-amine; tecnazen; ametoctradin; silthiofam;
nitrophenyl derivates: binapacryl, dinobuton, dinocap, fluazinam, ferimzone; nitrthal-isopropyl, and including organometal compounds: fentin salts, such as fentin-acetate, fentin chloride or fentin hydroxide;
F.II) Sterol biosynthesis inhibitors (SBI fungicides)
F.II-1) C14 demethylase inhibitors (DMI fungicides, e.g. triazoles, imidazoles) triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole, 1-[rel-(2S;3R)-3-(2-chloro-phenyl)-2-(2,4-difluorophenyl)-oxiranylmethyl]-5-thiocyanato-1H-[1,2,4]triazole, 2-[rel-(2S;3R)-3-(2-chlorophenyl)-2-(2,4-difluorophenyl)-oxiranylmethyl]-2H-[1,2,4]triazole-3-thiol, 2-[2-chloro-4-(4-chlorophenoxyl)phenyl]-1-(1,2,4-triazol-1-yl)pentan-2-ol, 1-[4-(4-chlorophenoxy)-2-(trifluoromethyl)phenyl]-1-cyclopropyl-2-(1,2,4-triazol-1-yl)ethanol, 2-[4-(4-chlorophenoxy)-2-(trifluoromethyl)phenyl]-1-(1,2,4-triazol-1-yl)butan-2-ol, 2-[2-chloro-4-(4-chlorophenoxyl)phenyl]-1-(1,2,4-triazol-1-yl)butan-2-ol, 2-[4-(4-chlorophenoxy)-2-(trifluoromethyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)propan-2-ol, 2-[2-chloro-4-(4-chlorophenoxyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)pentan-2-ol, 2-[4-(4-fluorophenoxy)-2-(trifluoromethyl)phenyl]-1-(1,2,4-triazol-1-yl)propan-2-ol;
imidazoles: imazalil, pefurazoate, oxpoconazole, prochloraz, triflumizole;
pyrimidines, pyridines and piperazines: fenarimol, nuarimol, pyrifenox, triforine, [3-(4-chloro-2-fluoro-phenyl)-5-(2,4-difluorophenyl)isoxazol-4-yl]-(3-pyridyl)methanol;
F.II-2) Delta 14-reductase inhibitors (Amines, e.g. morpholines, piperidines)
morpholines: aldimorph, dodemorph, dodemorph-acetate, fenpropimorph, tridemorph;
piperidines: fenpropidin, piperalin;
spiroketalamines: spiroxamine;
F.II-3) Inhibitors of 3-keto reductase: hydroxyanilides: fenhexamid;
F.III) Nucleic acid synthesis inhibitors
F.III-1) RNA, DNA synthesis
phenylamides or acyl amino acid fungicides: benalaxyl, benalaxyl-M, kiralaxyl, metalaxyl, metalaxyl-M (mefenoxam), ofurace, oxadixyl;
isoxazoles and iosothiazolones: hymexazole, octhilinone;
F.III-2) DNA topisomerase inhibitors: oxolinic acid;
F.III-3) Nucleotide metabolism (e.g. adenosin-deaminase)
hydroxy(2-amino)-pyrimidines: bupirimate;
F.IV) Inhibitors of cell division and or cytoskeleton
F.IV-1) Tubulin inhibitors: benzimidazoles and thiophanates: benomyl, carbendazim,
fuberidazole, thiabendazole, thiophanate-methyl;
triazolopyrimidines: 5-chloro-7 (4-methylpiperidin-1-yl)-6-(2,4,6-trifluorophenyl)-[1,2,4]triazolo[1,5 a]pyrimidine
F.IV-2) Other cell division inhibitors
benzamides and phenyl acetamides: diethofencarb, ethaboxam, pencycuron, fluopicolide, zoxamide;
F.IV-3) Actin inhibitors: benzophenones: metrafenone; pyriofenone;
F.V) Inhibitors of amino acid and protein synthesis
F.V-1) Methionine synthesis inhibitors (anilino-pyrimidines)
anilino-pyrimidines: cyprodinil, mepanipyrim, nitrapyrin, pyrimethanil;
F.V-2) Protein synthesis inhibitors (anilino-pyrimidines)
antibiotics: blasticidin-S, kasugamycin, kasugamycin hydrochloride-hydrate, mildiomycin, streptomycin, oxytetracyclin, polyoxine, validamycin A;
F.VI) Signal transduction inhibitors
F.VI-1) MAP/Histidine kinase inhibitors (e.g. anilino-pyrimidines)
dicarboximides: fluoroimid, iprodione, procymidone, vinclozolin;
phenylpyrroles: fenpiclonil, fludioxonil;
F.VI-2) G protein inhibitors: quinolines: quinoxyfen;
F.VII) Lipid and membrane synthesis inhibitors
F.VII-1) Phospholipid biosynthesis inhibitors
organophosphorus compounds: edifenphos, iprobenfos, pyrazophos;
dithiolanes: isoprothiolane;
F.VII-2) Lipid peroxidation
aromatic hydrocarbons: dicloran, quintozene, tecnazene, tolclofos-methyl, biphenyl, chloroneb, etridiazole;
F.VII-3) Carboxyl acid amides (CAA fungicides)
cinnamic or mandelic acid amides: dimethomorph, flumorph, mandiproamid, pyrimorph;
valinamide carbamates: benthiavalicarb, iprovalicarb, pyribencarb, valifenalate and N-(1-(1-(4-cyano-phenyl)ethanesulfonyl)-but-2-yl) carbamic acid-(4-fluorophenyl) ester;
F.VII-4) Compounds affecting cell membrane permeability and fatty acids
carbamates: propamocarb, propamocarb-hydrochlorid;
F.VII-5) fatty acid amide hydrolase inhibitors: 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone;
F.VIII) Inhibitors with Multi Site Action
F.VIII-1) Inorganic active substances: Bordeaux mixture, copper acetate, copper hydroxide, copper oxychloride, basic copper sulfate, sulfur;
F.VIII-2) Thio- and dithiocarbamates: ferbam, mancozeb, maneb, metam, methasulphocarb, metiram, propineb, thiram, zineb, ziram;
F.VIII-3) Organochlorine compounds (e.g. phthalimides, sulfamides, chloronitriles):
anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;
F.VIII-4) Guanidines: guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]dithiino[2,3-c:5,6-c′]dipyrrole-1,3,5,7(2H,6H)-tetraone;
F.VIII-5) Ahtraquinones: dithianon;
F.IX) Cell wall synthesis inhibitors
F.IX-1) Inhibitors of glucan synthesis: validamycin, polyoxin B;
F.IX-2) Melanin synthesis inhibitors: pyroquilon, tricyclazole, carpropamide, dicyclomet, fenoxanil;
F.X) Plant defence inducers
F.X-1) Salicylic acid pathway: acibenzolar-S-methyl;
F.X-2) Others: probenazole, isotianil, tiadinil, prohexadione-calcium;
phosphonates: fosetyl, fosetyl-aluminum, phosphorous acid and its salts;
F.XI) Unknown mode of action:
bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxathiapiprolin, tolprocarb, 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, 2-[3,5-bis(difluoromethyl)-1H-pyrazol-1-yl]-1-[4-(4-{5-[2-fluoro-6-(prop-2-yn-1-yl-oxy)phenyl]-4,5-dihydro-1,2-oxazol-3-yl}-1,3-thi [symbol] azol-2-yl)piperidin-1-yl]ethanone, 2[3,5-bis(difluoromethyl)-1H-pyrazol-1-yl]-1-[4-(4-{5-[2-chloro-6-(prop-2-yn-1-yl-oxy)phenyl]-4,5-dihydro-1,2-oxazol-3-yl}-1,3-thiazol-2 yl)piperidin-1-yl]ethanone, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N methyl formamidine, N′(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2 methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-chloro-phenyl)-2,3-dimethyl-isoxazolidin-3 yl]-pyridine, pyrisoxazole, 5-amino-2-isopropyl-3-oxo-4-ortho-tolyl-2,3-dihydro-pyrazole-1 carbothioic acid S-allyl ester, N-(6-methoxy-pyridin-3-yl)cyclopropanecarboxylic acid amide, 5-chloro-1 (4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide, ethyl (Z) 3 amino-2-cyano-3-phenyl-prop-2-enoate, tert-butyl N-[6-[[(Z)-[(1-methyltetrazol-5-yl)-phenyl-methylene]amino]oxymethyl]-2-pyridyl]carbamate (picarbutrazox), pentyl N-[6-[[(Z)-[(1-methyltetrazol-5-yl)-phenyl-methylene]amino]oxymethyl]-2-pyridyl]carbamate, 2-[2-[(7,8-difluoro-2-methyl-3-quinolyl)oxy]-6-fluoro-phenyl]propan-2-ol, 2-[2-fluoro-6-[(8-fluoro-2-methyl-3-quinolyl)oxy]phenyl]propan-2-ol, 3-(5-fluoro-3,3,4,4-tetramethyl-3,4-dihydroiso [symbol] quinolin-1-yl)quinoline, 3-(4,4-difluoro-3,3-dimethyl-3,4-dihydroisoquinolin-1-yl) [symbol] quinoline, 3-(4,4,5-trifluoro-3,3-dimethyl-3,4-dihydroisoquinolin-1-yl)quinoline;
F.XII) Growth regulators:
abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N 6 benzyladenine, paclobutrazol, prohexadione (prohexadione-calcium), prohydrojasmon, thidiazuron, triapenthenol, tributyl phosphorotrithioate, 2,3,5 tri iodobenzoic acid, trinexapac-ethyl and uniconazole;

### F.XIII) Biopesticides

F.XIII-1) Microbial pesticides with fungicidal, bactericidal, viricidal and/or plant defense activator activity: Ampelomyces quisqualis, Aspergillus flavus, Aureobasidium pullulans, Bacillus amyloliquefaciens, B. mojavensis, B. pumilus, B. simplex, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Fusarium oxysporum, Clonostachys rosea f. catenulate (also named Gliocladium catenulatum), Gliocladium roseum, Metschnikowia fructicola, Microdochium dimerum, Paenibacillus polymyxa, Pantoea agglomerans, Phlebiopsis gigantea, Pseudozyma flocculosa, Pythium oligandrum, Sphaerodes mycoparasitica, Streptomyces lydicus, S. violaceusniger, Talaromyces flavus, Trichoderma asperellum, T. atroviride, T. fertile, T. gamsii, T. harmatum; mixture of T. harzianum and T. viride; mixture of T. polysporum and T. harzianum; T. stromaticum, T. virens (also named Gliocladium virens), T. viride, Typhula phacorrhiza, Ulocladium oudema, U. oudemansii, Verticillium dahlia, zucchini yellow mosaic virus (avirulent strain);
F.XIII-2) Biochemical pesticides with fungicidal, bactericidal, viricidal and/or plant defense activator activity: chitosan (hydrolysate), jasmonic acid or salts or derivatives thereof, laminarin, Menhaden fish oil, natamycin, Plum pox virus coat protein, Reynoutria sachlinensis extract, salicylic acid, tea tree oil;
F.XIII-3) Microbial pesticides with plant stress reducing, plant growth regulator, plant growth promoting and/or yield enhancing activity: Azospirillum amazonense A. brasilense, A. lipoferum, A. irakense, A. halopraeferens, Bradyrhizobium sp., B. japonicum, Glomus intraradices, Mesorhizobium sp., Paenibacillus alvei, Penicillium bilaiae, Rhizobium leguminosarum bv. phaseolii, R. I. trifolii, R. I. bv. viciae, Sinorhizobium meliloti;
F.XIII-4) Biochemical pesticides with plant stress reducing, plant growth regulator and/or plant yield enhancing activity: abscisic acid, aluminium silicate (kaolin), 3-decen-2-one, homobrassinlide, humates, lysophosphatidyl ethanolamine, polymeric polyhydroxy acid, Ascophyllum nodosum (Norwegian kelp, Brown kelp) extract and Ecklonia maxima (kelp) extract.

The commercially available compounds II of the group F listed above may be found in The Pesticide Manual, 15th Edition, C. D. S. Tomlin, British Crop Protection Council (2011) among other publications. Their preparation and their activity against harmful fungi is known (cf.: http://www.alanwood.net/pesticides/); these substances are commercially available. The compounds described by IUPAC nomenclature, their preparation and their fungicidal activity are also known (cf. Can. J. Plant Sci. 48(6), 587-94, 1968; EP A 141 317; EP-A 152 031; EP-A 226 917; EP A 243 970; EP A 256 503; EP-A 428 941; EP-A 532 022; EP-A 1 028 125; EP-A 1 035 122; EP A 1 201 648; EP A 1 122 244, JP 2002316902; DE 19650197; DE 10021412; DE 102005009458; U.S. Pat. No. 3,296,272; U.S. Pat. No. 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 11/028657).

The biopesticides of group F.XIII are disclosed above in the paragraphs about biopesticides from group II-M.Y.

### Applications

Due to their excellent activity, the mixtures according to the invention may be used for controlling invertebrate pests.

The compounds I and the one or more compound(s) II can be applied simultaneously, that is jointly or separately, or in succession, that is immediately one after another and thereby creating the mixture “in-situ” on the desired location, as e.g. the plant, the sequence, in the case of separate application, generally not having any effect on the result of the control measures.

The compounds I and the one or more compound(s) II are usually applied in a weight ratio of from 5000:1 to 1:5000, preferably from 1000:1 to 1:1000, preferably from 625:1 to 1:625, preferably 500:1 to 1:100, preferably from 100:1 to 1:100 preferably from 20:1 to 1:50, preferably from 20:1 to 1:20, preferably from 10:1 to 1:10, in particular from 5:1 to 1:20, in particular from 5:1 to 1:10, in particular from 5:1 to 1:5.

Depending on the desired effect, the application rates of the mixtures according to the invention are from 5 g/ha to 2000 g/ha, preferably from 0.5 g/ha to 1000 g/ha, preferably from 1 to 750 g/ha, in particular from 5 to 500 g/ha.

The mixtures according to the invention are effective through both contact and ingestion.

The mixtures according to the invention can be applied to any and all developmental stages, such as egg, larva, pupa, and adult. The pests may be controlled by contacting the target pest, its food supply, habitat, breeding ground or its locus with a pesticidally effective amount of the inventive mixtures or of compositions comprising the mixtures.

According to a preferred embodiment, the mixtures according to the invention are used in crop protection, especially for the protection of living plants.

According to another specific embodiment of the invention, the mixtures according to the present invention are employed via soil application. Soil application is especially favorable for use against ants, termites, crickets, or cockroaches.

According to another embodiment of the invention, for use against non crop pests such as ants, termites, wasps, flies, mosquitoes, crickets, locusts, or cockroaches the mixtures according to the present invention are prepared into a bait preparation.

The bait can be a liquid, a solid or a semisolid preparation (e.g. a gel).

The animal pest (also referred to as “invertebrate pest”), i.e. the insects, arachnids and nematodes, the plant, soil or water in which the plant is growing can be contacted with the mixtures according to the invention or composition(s) comprising them by any application method known in the art. As such, “contacting” includes both direct contact (applying the compounds/compositions directly on the animal pest or plant—typically to the foliage, stem or roots of the plant) and indirect contact (applying the compounds/mixtures/compositions to the locus of the animal pest or plant).

The mixtures according to the invention or the pesticidal compositions comprising them may be used to protect growing plants and crops from attack or infestation by animal pests, especially insects, acaridae or arachnids by contacting the plant/crop with a pesticidally effective amount of the mixtures according to the invention. The term “crop” refers both to growing and harvested crops.

The mixtures according to the invention and the compositions comprising them are particularly important in the control of a multitude of insects on various cultivated plants, such as cereal, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

Particularly preferred is the application of the mixtures according to the invention and the compositions comprising them on rice. Particularly preferred is the application of the mixtures according to the invention and the compositions comprising them on soybeans. Particularly preferred is the application of the mixtures according to the invention and the compositions comprising them on corn.

Also preferred is the application of the mixtures according to the invention, especially the mixtures as individualized herein, e.g. in Table AP-T, on specialty crops like fruits and vegetables. In one embodiment thereof, the application is on fruiting vegetables, and especially on tomato, on pepper or on eggplant.

In another embodiment thereof, the application is on leafy vegetables, and especially on cabbage or on lettuce.

In still another embodiment thereof, the application is on tubers (tuber vegetables), and especially on potato or on onion.

The mixtures according to the invention are employed as such or in form of compositions by treating the insects or the plants, plant propagation materials, such as seeds, soil, surfaces, materials or rooms to be protected from insecticidal attack with an insecticidally effective amount of the active compounds. The application can be carried out both before and after the infection of the plants, plant propagation materials, such as seeds, soil, surfaces, materials or rooms by the insects.

The present invention also includes a method of combating animal pests which comprises contacting the animal pests, their habitat, breeding ground, food supply, cultivated plants, seed, soil, area, material or environment in which the animal pests are growing or may grow, or the materials, plants, seeds, soils, surfaces or spaces to be protected from animal attack or infestation with a pesticidally effective amount of a mixture of at least one active compound I and at least one active compound II.

Moreover, animal pests may be controlled by contacting the target pest, its food supply, habitat, breeding ground or its locus with a pesticidally effective amount of a mixture according to the invention. As such, the application may be carried out before or after the infection of the locus, growing crops, or harvested crops by the pest.

The mixtures according to the invention can also be applied preventively to places at which occurrence of the pests is expected.

The mixtures according to the invention may be also used to protect growing plants from attack or infestation by pests by contacting the plant with a pesticidally effective amount of mixtures according to the invention. As such, “contacting” includes both direct contact (applying the compounds/compositions directly on the pest and/or plant—typically to the foliage, stem or roots of the plant) and indirect contact (applying the mixtures according to the invention/compositions to the locus of the pest and/or plant).

“Locus” means a habitat, breeding ground, plant, seed, soil, area, material or environment in which a pest or parasite is growing or may grow.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “cultivated plants” is to be understood as including plants which have been modified by breeding, mutagenesis or genetic engineering. Genetically modified plants are plants, the genetic material of which has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transtional modification of protein(s) (oligo- or polypeptides) for example by glycosylation or polymer additions such as prenylated, acetylated or farnesylated moieties or PEG moieties (e.g. as disclosed in Biotechnol Prog. 2001 July-August; 17(4):720-8., Protein Eng Des Sel. 2004 January; 17(1):57-66, Nat Protoc. 2007; 2(5): 1225-35., Curr Opin Chem Biol. 2006 October; 10(5):487-91. Epub 2006 August 28., Biomaterials. 2001 March; 22(5):405-17, Bioconjug Chem. 2005 January-February; 16(1):113-21).

The term “cultivated plants” is to be understood also including plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e. g. WO 92/00377); glutamine synthetase (GS) inhibitors, such as glufosinate (see e. g. EP-A-0242236, EP-A-242246) or oxynil herbicides (see e. g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e. g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” is to be understood also including plants that are by the use of recombinant DNA techniques capable to synthesize one or more insecticidal proteins, especially those known from the bacterial genus Bacillus, particularly from Bacillus thuringiensis, such as ä-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are dis-closed, for example, in EP-A 374 753, WO 93/007278, WO 95/34656, EP-A 427 529, EP-A 451 878, WO 03/018810 und WO 03/052073.

The methods for producing such genetically modified plants are generally known to the person skilled in the art and are described, for example, in the publications mentioned above. These insecticidal proteins contained in the genetically modified plants impart to the plants producing these proteins protection from harmful pests from certain taxonomic groups of arthropods, particularly to beetles (Coleoptera), flies (Diptera), and butterflies and moths (Lepidoptera) and to plant parasitic nematodes (Nematoda).

The term “cultivated plants” is to be understood also including plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lyso-zym (e. g. potato cultivars capable of synthesizing these proteins with increased resistance against bacteria such as Erwinia amylvora). The methods for producing such genetically modified plants are generally known to the person skilled in the art and are described, for example, in the publications mentioned above.

The term “cultivated plants” is to be understood also including plants that are by the use of recombinant DNA techniques capable to synthesize one or more proteins to increase the productivity (e. g. bio mass production, grain yield, starch content, oil content or protein content), tolerance to drought, salinity or other growth-limiting environ-mental factors or tolerance to pests and fungal, bacterial or viral pathogens of those plants.

The term “cultivated plants” is to be understood also including plants that contain by the use of recombinant DNA techniques a modified amount of substances of content or new substances of content, specifically to improve human or animal nutrition, for example oil crops that produce health-promoting long-chain omega-3 fatty acids or unsaturated omega-9 fatty acids (e. g. Nexera® rape).

The term “cultivated plants” is to be understood also including plants that contain by the use of recombinant DNA techniques a modified amount of substances of content or new substances of content, specifically to improve raw material production, for example potatoes that produce increased amounts of amylopectin (e. g. Amflora® potato).

In general, “pesticidally effective amount” means the amount of active ingredients or mixture according to the invention needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the compositions will also vary according to the prevailing conditions such as desired pesticidal effect and duration, weather, target species, locus, mode of application, and the like.

In the case of foliar treatment, the quantity of active ingredient ranges from 0.0001 to 500 g per 100 m², preferably from 0.001 to 20 g per 100 m², or from 1 to 100 g per hectare, preferably from 10 to 50 g per hectare, or from 12 to 50 g per hectare, or from 10 to 30 g per hectare, or from 20 to 40 g per hectare, or from 10 to 20 g per hectare, or from 20 to 30 g per hectare, or from 30 to 40 g per hectare, or from 40 to 50 g per hectare.

In the case of soil treatment or of application to the pests dwelling place or nest, the quantity of active ingredient ranges from 0.0001 to 500 g per 100 m², preferably from 0.001 to 20 g per 100 m².

Customary application rates in the protection of materials are, for example, from 0.01 g to 1000 g of active compounds per m² treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of at least one repellent and/or insecticide.

The mixtures according to the invention are effective through both contact (via soil, glass, wall, bed net, carpet, plant parts or animal parts), and ingestion (bait, or plant part).

The mixtures according to the invention may also be applied against non-crop insect pests, such as ants, termites, wasps, flies, mosquitos, crickets, or cockroaches. For use against said non-crop pests, the mixtures according to the invention are preferably used in a bait composition.

The bait can be a liquid, a solid or a semisolid preparation (e.g. a gel). Solid baits can be formed into various shapes and forms suitable to the respective application e.g. granules, blocks, sticks, disks. Liquid baits can be filled into various devices to ensure proper application, e.g. open containers, spray devices, droplet sources, or evaporation sources. Gels can be based on aqueous or oily matrices and can be formulated to particular necessities in terms of stickyness, moisture retention or aging characteristics.

The bait employed in the composition is a product, which is sufficiently attractive to incite insects such as ants, termites, wasps, flies, mosquitos, crickets etc. or cockroaches to eat it.

The attractiveness can be manipulated by using feeding stimulants or sex pheromones. Food stimulants are chosen, for example, but not exclusively, from animal and/or plant proteins (meat-, fish- or blood meal, insect parts, egg yolk), from fats and oils of animal and/or plant origin, or mono-, oligo- or polyorganosaccharides, especially from sucrose, lactose, fructose, dextrose, glucose, starch, pectin or even molasses or honey. Fresh or decaying parts of fruits, crops, plants, animals, insects or specific parts thereof can also serve as a feeding stimulant.

Sex pheromones are known to be more insect specific. Specific pheromones are described in the literature and are known to those skilled in the art.

For use in bait compositions, the typical content of active ingredients is from 0.001 weight % to 15 weight %, desirably from 0.001 weight % to 5% weight % of active compounds.

Formulations of compounds of formula I or compounds II or mixtures according to the invention as aerosols (e.g in spray cans), oil sprays or pump sprays are highly suitable for the non-professional user for controlling pests such as flies, fleas, ticks, mosquitos or cockroaches. Aerosol recipes are preferably composed of the active compound(s), solvents such as lower alcohols (e.g. methanol, ethanol, propanol, butanol), ketones (e.g. acetone, methyl ethyl ketone), paraffin hydrocarbons (e.g. kerosenes) having boiling ranges of approximately 50 to 250° C., dimethylformamide, N-methylpyrrolidone, dimethyl sulfoxide, aromatic hydrocarbons such as toluene, xylene, water, furthermore auxiliaries such as emulsifiers such as sorbitol monooleate, oleyl ethoxylate having 3-7 mol of ethylene oxide, fatty alcohol ethoxylate, perfume oils such as ethereal oils, esters of medium fatty acids with lower alcohols, aromatic carbonyl compounds, if appropriate stabilizers such as sodium benzoate, amphoteric surfactants, lower epoxides, triethyl orthoformate and, if required, propellants such as propane, butane, nitrogen, compressed air, dimethyl ether, carbon dioxide, nitrous oxide, or mixtures of these gases.

The oil spray formulations differ from the aerosol recipes in that no propellants are used.

For use in spray compositions, the content of active ingredient is from 0.001 to 80 weights %, preferably from 0.01 to 50 weight % and most preferably from 0.01 to 15 weight %.

The mixtures according to the invention respective their compositions can also be used in mosquito and fumigating coils, smoke cartridges, vaporizer plates or long-term vaporizers and also in moth papers, moth pads or other heat-independent vaporizer systems.

Methods to control infectious diseases transmitted by insects (e.g. malaria, dengue and yellow fever, lymphatic filariasis, and leishmaniasis) with mixtures according to the invention and their respective compositions also comprise treating surfaces of huts and houses, air spraying and impregnation of curtains, tents, clothing items, bed nets, tsetse-fly trap or the like. Insecticidal compositions for application to fibers, fabric, knitgoods, nonwovens, netting material or foils and tarpaulins preferably comprise a mixture including the insecticide, optionally a repellent and at least one binder. Suitable repellents for example are N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, Methylneodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella). Suitable binders are selected for example from polymers and copolymers of vinyl esters of aliphatic acids (such as such as vinyl acetate and vinyl versatate), acrylic and methacrylic esters of alcohols, such as butyl acrylate, 2-ethylhexylacrylate, and methyl acrylate, mono- and di-ethylenically unsaturated hydrocarbons, such as styrene, and aliphatic diens, such as butadiene.

The impregnation of curtains and bednets is done in general by dipping the textile material into emulsions or dispersions of the insecticide or spraying them onto the nets.

The mixtures according to the invention and their compositions can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities). The mixtures according to the invention are applied not only to the surrounding soil surface or into the under-floor soil in order to protect wooden materials but it can also be applied to lumbered articles such as surfaces of the under-floor concrete, alcove posts, beams, plywoods, furniture, etc., wooden articles such as particle boards, half boards, etc. and vinyl articles such as coated electric wires, vinyl sheets, heat insulating material such as styrene foams, etc. In case of application against ants doing harm to crops or human beings, the ant controller of the present invention is applied to the crops or the surrounding soil, or is directly applied to the nest of ants or the like.

### Seed Treatment

The mixtures according to the invention are also suitable for the treatment of seeds in order to protect the seed from insect pest, in particular from soil-living insect pests and the resulting plant's roots and shoots against soil pests and foliar insects.

The mixtures according to the invention are particularly useful for the protection of the seed from soil pests and the resulting plant's roots and shoots against soil pests and foliar insects.

The protection of the resulting plant's roots and shoots is preferred. More preferred is the protection of resulting plant's shoots from piercing and sucking insects, wherein the protection from aphids is most preferred.

The present invention therefore comprises a method for the protection of seeds from insects, in particular from soil insects and of the seedlings' roots and shoots from insects, in particular from soil and foliar insects, said method comprising contacting the seeds before sowing and/or after pregermination with a mixtures according to the invention. Particularly preferred is a method, wherein the plant's roots and shoots are protected, more preferably a method, wherein the plants shoots are protected from piercing and sucking insects, most preferably a method, wherein the plants shoots are protected from aphids. Also preferred ist a method, wherein the plant's roots and shoots are protected from chewing and biting insects, most preferably a method, wherein the plants shoots and roots are protected from Lepidoptera and/or Coleoptera, most preferably wherein the plant shoots and roots are protected from rice leaf beetle.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

The term seed treatment comprises all suitable seed treatment techniques known in the art, such as seed dressing, seed coating, seed dusting, seed soaking and seed pelleting.

The present invention also comprises seeds coated with or containing the active mixtures according to the invention.

The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re)planted, it may absorb the active ingredient.

Suitable seed is seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

Particularly preferred is the application of the mixtures according to the invention and the compositions comprising them on rice.

In addition, the active mixtures according to the invention may also be used for the treatment of seeds from plants, which tolerate the action of herbicides or fungicides or insecticides owing to breeding, including genetic engineering methods.

For example, the active mixtures according to the invention can be employed in treatment of seeds from plants, which are resistant to herbicides from the group consisting of the sulfonylureas, imidazolinones, glufosinate-ammonium or glyphosate-isopropylammonium and analogous active substances (see for example, EP-A 242 236, EP-A 242 246) (WO 92/00377) (EP-A 257 993, U.S. Pat. No. 5,013,659) or in transgenic crop plants, for example cotton, with the capability of producing Bacillus thuringiensis toxins (Bt toxins) which make the plants resistant to certain pests (EP-A 142 924, EP-A 193 259),

Furthermore, the active mixtures according to the invention can be used also for the treatment of seeds from plants, which have modified characteristics in comparison with existing plants consist, which can be generated for example by traditional breeding methods and/or the generation of mutants, or by recombinant procedures). For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The seed treatment application of the active compounds is carried out by spraying or by dusting the seeds before sowing of the plants and before emergence of the plants.

Compositions which are especially useful for seed treatment are e.g.:

A Soluble concentrates (SL, LS)

### D Emulsions (EW, EO, ES)

### E Suspensions (SC, OD, FS)

F Water-dispersible granules and water-soluble granules (WG, SG)
G Water-dispersible powders and water-soluble powders (WP, SP, WS)

### H Gel-Formulations (GF)

I Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

In a preferred embodiment a FS formulation is used for seed treatment. Typcially, a FS formulation may comprise 1-800 g/l of active ingredient, 1-200 g/I Surfactant, 0 to 200 g/I antifreezing agent, 0 to 400 g/l of binder, 0 to 200 g/l of a pigment and up to 1 liter of a solvent, preferably water.

Especially preferred FS formulations of compounds of formula I, compounds II or the mixtures according to the invention, for seed treatment usually comprise from 0.1 to 80% by weight (1 to 800 g/l) of the active ingredient, from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

Seed Treatment formulations may additionally also comprise binders and optionally colorants. Binders can be added to improve the adhesion of the active materials on the seeds after treatment. Suitable binders are homo- and copolymers from alkylene oxides like ethylene oxide or propylene oxide, polyvinylacetate, polyvinylalcohols, polyvinylpyrrolidones, and copolymers thereof, ethylene-vinyl acetate copolymers, acrylic homo- and copolymers, polyethyleneamines, polyethyleneamides and polyethyleneimines, polysaccharides like celluloses, tylose and starch, polyolefin homo- and copolymers like olefin/maleic anhydride copolymers, polyurethanes, polyesters, polystyrene homo and copolymers

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of a gelling agent is carrageen (Satiagel®)

In the treatment of seed, the application rates of the compounds I are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed.

The invention therefore also relates to seed comprising a compound of the formula I, or an agriculturally useful salt of I, as defined herein. The amount of the compound I or the agriculturally useful salt thereof will in general vary from 0.1 g to 10 kg per 100 kg of seed, preferably from 1 g to 5 kg per 100 kg of seed, in particular from 1 g to 1000 g per 100 kg of seed. For specific crops such as lettuce the rate can be higher.

### Animal Health

The mixtures according to the invention are in particular also suitable for being used for combating parasites in and on animals.

An object of the present invention is therefore also to provide new methods to control parasites in and on animals. Another object of the invention is to provide safer pesticides for animals.

Another object of the invention is further to provide pesticides for animals that may be used in lower doses than existing pesticides. And another object of the invention is to provide pesticides for animals, which provide a long residual control of the parasites.

The invention also relates to compositions comprising a parasiticidally effective amount of the mixtures according to the invention and an acceptable carrier, for combating parasites in and on animals.

The present invention also provides a method for treating, controlling, preventing and protecting animals against infestation and infection by parasites, which comprises orally, topically or parenterally administering or applying to the animals a parasiticidally effective amount of a mixture according to the invention or a composition comprising it.

The invention also provides a process for the preparation of a composition for treating, controlling, preventing or protecting animals against infestation or infection by parasites which comprises a parasiticidally effective amount of a mixture according to the invention or a composition comprising it.

Activity of compounds against agricultural pests does not suggest their suitability for control of endo- and ectoparasites in and on animals which requires, for example, low, non-emetic dosages in the case of oral application, metabolic compatibility with the animal, low toxicity, and a safe handling.

Surprisingly it has now been found that the mixtures according to the invention are suitable for combating endo- and ectoparasites in and on animals.

Mixtures according to the invention and compositions comprising them are preferably used for controlling and preventing infestations and infections animals including warm-blooded animals (including humans) and fish. They are for example suitable for controlling and preventing infestations and infections in mammals such as cattle, sheep, swine, camels, deer, horses, pigs, poultry, rabbits, goats, dogs and cats, water buffalo, donkeys, fallow deer and reindeer, and also in fur-bearing animals such as mink, chinchilla and raccoon, birds such as hens, geese, turkeys and ducks and fish such as fresh- and salt-water fish such as trout, carp and eels.

Mixtures according to the invention and compositions comprising them are preferably used for controlling and preventing infestations and infections in domestic animals, such as dogs or cats. Infestations in warm-blooded animals and fish include, but are not limited to, lice, biting lice, ticks, nasal bots, keds, biting flies, muscoid flies, flies, myiasitic fly larvae, chiggers, gnats, mosquitoes and fleas.

The mixtures according to the invention and compositions comprising them are suitable for systemic and/or non-systemic control of ecto- and/or endoparasites. They are active against all or some stages of development.

The mixtures according to the invention are especially useful for combating ectoparasites.

The mixtures according to the invention are especially useful for combating parasites of the following orders and species, respectively:

fleas (Siphonaptera), e.g. Ctenocephalides felis, Ctenocephalides canis, Xenopsylla cheopis, Pulex irritans, Tunga penetrans, and Nosopsyllus fasciatus,
cockroaches (Blattaria-Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,
flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni Anopheles leucosphyrus, Anopheles minimus, Anopheles quadrimaculatus, Calliphora vicina, Chrysomya bezziana, Chrysomya hominivorax, Chrysomya macellaria, Chrysops discalis, Chrysops silacea, Chrysops atlanticus, Cochliomyia hominivorax, Cordylobia anthropophaga, Culicoides furens, Culex pipiens, Culex nigripalpus, Culex quinquefasciatus, Culex tarsalis, Culseta inornata, Culiseta melanura, Dermatobia hominis, Fannia canicularis, Gasterophilus intestinalis, Glossina morsitans, Glossina palpalis, Glossina fuscipes, Glossina tachinoides, Haematobia irritans, Haplodiplosis equestris, Hippelates spp., Hypoderma lineata, Leptoconops torrens, Lucilia caprina, Lucilia cuprina, Lucilia sericata, Lycoria pectoralis, Mansonia spp., Musca domestica, Muscina stabulans, Oestrus ovis, Phlebotomus argentipes, Psorophora columbiae, Psorophora discolor, Prosimulium mixtum, Sarcophaga haemorrhoidalis, Sarcophaga sp., Simulium vittatum, Stomoxys calcitrans, Tabanus bovinus, Tabanus atratus, Tabanus lineola, and Tabanus similis,
lice (Phthiraptera), e.g. Pediculus humanus capitis, Pediculus humanus corporis, Pthirus pubis, Haematopinus eurysternus, Haematopinus suis, Linognathus vituli Bovicola bovis, Menopon gainae, Menacanthus stramineus and Solenopotes capillatus.
ticks and parasitic mites (Parasitiformes): ticks (Ixodida), e.g. Ixodes scapularis, Ixodes holocyclus, Ixodes pacificus, Rhiphicephalus sanguineus, Dermacentor andersoni, Dermacentor variabilis, Amblyomma americanum, Ambryomma maculatum, Omithodorus hermsi, Omithodorus turicata and parasitic mites (Mesostigmata), e.g. Omithonyssus bacoti and Dermanyssus gallinae,
Actinedida (Prostigmata) und Acaridida (Astigmata) e.g. Acarapis spp., Cheyetiella spp., Omithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., and Laminosioptes spp,
Bugs (Heteropterida): Cimex lectularius, Cimex hemipterus, Reduvius senilis, Triatoma spp., Rhodnius ssp., Panstrongylus ssp. and Arilus critatus,
Anoplurida, e.g. Haematopinus spp., Linognathus spp., Pediculus spp., Phtirus spp., and Solenopotes spp,
Mallophagida (suborders Arnblycerina and Ischnocerina), e.g. Trimenopon spp., Menopon spp., Trinoton spp., Bovicola spp., Werneckiella spp., Lepikentron spp., Trichodectes spp., and Felicola spp,

### Roundworms Nematoda:

Wipeworms and Trichinosis (Trichosyringida), e.g. Trichinellidae (Trichinella spp.), (Trichuridae) Trichuris spp., Capillaria spp,
Rhabditida, e.g. Rhabditis spp, Strongyloides spp., Helicephalobus spp,
Strongylida, e.g. Strongylus spp., Ancylostoma spp., Necator americanus, Bunostomum spp. (Hookworm), Trichostrongylus spp., Haemonchus contortus., Ostertagia spp., Cooperia spp., Nematodirus spp., Dictyocaulus spp., Cyathostoma spp., Oesophagostomum spp., Stephanurus dentatus, Ollulanus spp., Chabertia spp., Stephanurus dentatus, Syngamus trachea, Ancylostoma spp., Uncinaria spp., Globocephalus spp., Necator spp., Metastrongylus spp., Muellerius capillaris, Protostrongylus spp., Angiostrongylus spp., Parelaphostrongylus spp. Aleurostrongylus abstrusus, and Dioctophyma renale,
Intestinal roundworms (Ascaridida), e.g. Ascaris lumbricoides, Ascaris suum, Ascaridia galli, Parascaris equorum, Enterobius vermicularis (Threadworm), Toxocara canis, Toxascaris leonine, Skrjabinema spp., and Oxyuris equi,
Camallanida, e.g. Dracunculus medinensis (guinea worm)
Spirurida, e.g. Thelazia spp. Wuchereria spp., Brugia spp., Onchocerca spp., Dirofilari spp.a, Dipetalonema spp., Setaria spp., Elaeophora spp., Spirocerca lupi, and Habronema spp.,
Thorny headed worms (Acanthocephala), e.g. Acanthocephalus spp., Macracanthorhynchus hirudinaceus and Oncicola spp,

### Planarians (Plathelminthes):

Flukes (Trematoda), e.g. Faciola spp., Fascioloides magna, Paragonimus spp., Dicrocoelium spp., Fasciolopsis buski, Clonorchis sinensis, Schistosoma spp., Trichobilharzia spp., Alaria alata, Paragonimus spp., and Nanocyetes spp,
Cercomeromorpha, in particular Cestoda (Tapeworms), e.g. Diphyllobothrium spp., Tenia spp., Echinococcus spp., Dipylidium caninum, Mulficeps spp., Hymenolepis spp., Mesocestoides spp., Vampirolepis spp., Moniezia spp., Anoplocephala spp., Sirometra spp., Anoplocephala spp., and Hymenolepis spp.

The mixtures according to the invention and compositions containing them are particularly useful for the control of pests from the orders Diptera, Siphonaptera and Ixodida.

Moreover, the use of the mixtures according to the invention and compositions containing them for combating mosquitoes is especially preferred.

The use of the mixtures according to the invention and compositions containing them for combating flies is a further preferred embodiment of the present invention.

Furthermore, the use of the compounds of formula I and compositions containing them for combating fleas is especially preferred.

The use of the mixtures according to the invention and compositions containing them for combating ticks is a further preferred embodiment of the present invention.

The mixtures according to the invention also are especially useful for combating endoparasites (roundworms nematoda, thorny headed worms and planarians).

Administration can be carried out both prophylactically and therapeutically.

Administration of the active compounds or mixtures is carried out directly or in the form of suitable preparations, orally, topically/dermally or parenterally.

For oral administration to warm-blooded animals, the compounds of formula I, compounds II or the mixtures according to the invention may be formulated as animal feeds, animal feed premixes, animal feed concentrates, pills, solutions, pastes, suspensions, drenches, gels, tablets, boluses and capsules. In addition, the compounds of formula I, compounds II or the mixtures according to the invention may be administered to the animals in their drinking water.

For oral administration, the dosage form chosen should provide the animal with 0.01 mg/kg to 100 mg/kg of animal body weight per day of the compounds of formula I, compounds II or the mixtures according to the invention, preferably with 0.5 mg/kg to 100 mg/kg of animal body weight per day.

Alternatively, the compounds of formula I, compounds II or the mixtures according to the invention may be administered to animals parenterally, for example, by intraruminal, intramuscular, intravenous or subcutaneous injection. The compounds of formula I, compounds II or the mixtures according to the invention may be dispersed or dissolved in a physiologically acceptable carrier for subcutaneous injection. Alternatively, the compounds of formula I, compounds II or the mixtures according to the invention may be formulated into an implant for subcutaneous administration. In addition the compounds of formula I, compounds II or the mixtures according to the invention may be transdermally administered to animals. For parenteral administration, the dosage form chosen should provide the animal with 0.01 mg/kg to 100 mg/kg of animal body weight per day of the compounds of formula I, compounds II or the mixture according to the invention.

The compounds of formula I, compounds II or the mixtures according to the invention may also be applied topically to the animals in the form of dips, dusts, powders, collars, medallions, sprays, shampoos, spot-on and pour-on formulations and in ointments or oil-in-water or water-in-oil emulsions. For topical application, dips and sprays usually contain 0.5 ppm to 5,000 ppm and preferably 1 ppm to 3,000 ppm of the compounds of formula I, compounds II or the mixtures according to the invention. In addition, the compounds of formula I, compounds II or the mixtures according to the invention may be formulated as ear tags for animals, particularly quadrupeds such as cattle and sheep.

Suitable preparations are:
Solutions such as oral solutions, concentrates for oral administration after dilution, solutions for use on the skin or in body cavities, pouring-on formulations, gels;
Emulsions and suspensions for oral or dermal administration; semi-solid preparations;
Formulations in which the active compound is processed in an ointment base or in an oil-in-water or water-in-oil emulsion base;
Solid preparations such as powders, premixes or concentrates, granules, pellets, tablets, boluses, capsules; aerosols and inhalants, and active compound-containing shaped articles. Compositions suitable for injection are prepared by dissolving the active ingredient in a suitable solvent and optionally adding further ingredients such as acids, bases, buffer salts, preservatives, and solubilizers. The solutions are filtered and filled sterile.

Suitable solvents are physiologically tolerable solvents such as water, alkanols such as ethanol, butanol, benzyl alcohol, glycerol, propylene glycol, polyethylene glycols, N-methylpyrrolidone, 2-pyrrolidone, and mixtures thereof.

The active compounds can optionally be dissolved in physiologically tolerable vegetable or synthetic oils which are suitable for injection.

Suitable solubilizers are solvents which promote the dissolution of the active compound in the main solvent or prevent its precipitation. Examples are polyvinylpyrrolidone, polyvinyl alcohol, polyoxyethylated castor oil, and polyoxyethylated sorbitan ester.

Suitable preservatives are benzyl alcohol, trichlorobutanol, p-hydroxybenzoic acid esters, and n-butanol.

Oral solutions are administered directly. Concentrates are administered orally after prior dilution to the use concentration. Oral solutions and concentrates are prepared according to the state of the art and as described above for injection solutions, sterile procedures not being necessary.

Solutions for use on the skin are trickled on, spread on, rubbed in, sprinkled on or sprayed on.

Solutions for use on the skin are prepared according to the state of the art and according to what is described above for injection solutions, sterile procedures not being necessary.

Further suitable solvents are polypropylene glycol, phenyl ethanol, phenoxy ethanol, ester such as ethyl or butyl acetate, benzyl benzoate, ethers such as alkyleneglycol alkylether, e.g. dipropylenglycol monomethylether, ketons such as acetone, methylethylketone, aromatic hydrocarbons, vegetable and synthetic oils, dimethylformamide, dimethylacetamide, transcutol, solketal, propylencarbonate, and mixtures thereof.

It may be advantageous to add thickeners during preparation. Suitable thickeners are inorganic thickeners such as bentonites, colloidal silicic acid, aluminium monostearate, organic thickeners such as cellulose derivatives, polyvinyl alcohols and their copolymers, acrylates and methacrylates.

Gels are applied to or spread on the skin or introduced into body cavities. Gels are prepared by treating solutions which have been prepared as described in the case of the injection solutions with sufficient thickener that a clear material having an ointment-like consistency results. The thickeners employed are the thickeners given above.

Pour-on formulations are poured or sprayed onto limited areas of the skin, the active compound penetrating the skin and acting systemically.

Pour-on formulations are prepared by dissolving, suspending or emulsifying the active compound in suitable skin-compatible solvents or solvent mixtures. If appropriate, other auxiliaries such as colorants, bioabsorption-promoting substances, antioxidants, light stabilizers, adhesives are added.

Suitable solvents which are: water, alkanols, glycols, polyethylene glycols, polypropylene glycols, glycerol, aromatic alcohols such as benzyl alcohol, phenylethanol, phenoxyethanol, esters such as ethyl acetate, butyl acetate, benzyl benzoate, ethers such as alkylene glycol alkyl ethers such as dipropylene glycol monomethyl ether, diethylene glycol mono-butyl ether, ketones such as acetone, methyl ethyl ketone, cyclic carbonates such as propylene carbonate, ethylene carbonate, aromatic and/or aliphatic hydrocarbons, vegetable or synthetic oils, DMF, dimethylacetamide, n-alkylpyrrolidones such as methylpyrrolidone, n-butylpyrrolidone or n-octylpyrrolidone, N-methylpyrrolidone, 2-pyrrolidone, 2,2-dimethyl-4-oxy-methylene-1,3-dioxolane and glycerol formal.

Suitable colorants are all colorants permitted for use on animals and which can be dissolved or suspended.

Suitable absorption-promoting substances are, for example, DMSO, spreading oils such as isopropyl myristate, dipropylene glycol pelargonate, silicone oils and copolymers thereof with polyethers, fatty acid esters, triglycerides, fatty alcohols.

Suitable antioxidants are sulfites or metabisulfites such as potassium metabisulfite, ascorbic acid, butylhydroxytoluene, butylhydroxyanisole, tocopherol.

Suitable light stabilizers are, for example, novantisolic acid.

Suitable adhesives are, for example, cellulose derivatives, starch derivatives, polyacrylates, natural polymers such as alginates, gelatin.

Emulsions can be administered orally, dermally or as injections.

Emulsions are either of the water-in-oil type or of the oil-in-water type.

They are prepared by dissolving the active compound either in the hydrophobic or in the hydrophilic phase and homogenizing this with the solvent of the other phase with the aid of suitable emulsifiers and, if appropriate, other auxiliaries such as colorants, absorption-promoting substances, preservatives, antioxidants, light stabilizers, viscosity-enhancing substances.

Suitable hydrophobic phases (oils) are:

liquid paraffins, silicone oils, natural vegetable oils such as sesame oil, almond oil, castor oil, synthetic triglycerides such as caprylic/capric biglyceride, triglyceride mixture with vegetable fatty acids of the chain length C₈-C₁₂ or other specially selected natural fatty acids, partial glyceride mixtures of saturated or unsaturated fatty acids possibly also containing hydroxyl groups, mono- and diglycerides of the C₈-C₁₀ fatty acids,
fatty acid esters such as ethyl stearate, di-n-butyryl adipate, hexyl laurate, dipropylene glycol perlargonate, esters of a branched fatty acid of medium chain length with saturated fatty alcohols of chain length C₁₆-C₁₈, isopropyl myristate, isopropyl palmitate, caprylic/capric acid esters of saturated fatty alcohols of chain length C₁₂-C₁₈, isopropyl stearate, oleyl oleate, decyl oleate, ethyl oleate, ethyl lactate, waxy fatty acid esters such as synthetic duck coccygeal gland fat, dibutyl phthalate, diisopropyl adipate, and ester mixtures related to the latter, fatty alcohols such as isotridecyl alcohol, 2-octyldodecanol, cetylstearyl alcohol, oleyl alcohol, and fatty acids such as oleic acid and mixtures thereof.

Suitable hydrophilic phases are: water, alcohols such as propylene glycol, glycerol, sorbitol and mixtures thereof.

Suitable emulsifiers are:

non-ionic surfactants, e.g. polyethoxylated castor oil, polyethoxylated sorbitan monooleate, sorbitan monostearate, glycerol monostearate, polyoxyethyl stearate, alkylphenol polyglycol ether;
ampholytic surfactants such as di-sodium N-lauryl-p-iminodipropionate or lecithin;
anionic surfactants, such as sodium lauryl sulfate, fatty alcohol ether sulfates, mono/dialkyl polyglycol ether orthophosphoric acid ester monoethanolamine salt;
cation-active surfactants, such as cetyltrimethylammonium chloride.

Suitable further auxiliaries are: substances which enhance the viscosity and stabilize the emulsion, such as carboxymethylcellulose, methylcellulose and other cellulose and starch derivatives, polyacrylates, alginates, gelatin, gum arabic, polyvinylpyrrolidone, polyvinyl alcohol, copolymers of methyl vinyl ether and maleic anhydride, polyethylene glycols, waxes, colloidal silicic acid or mixtures of the substances mentioned.

Suspensions can be administered orally or topically/dermally. They are prepared by suspending the active compound in a suspending agent, if appropriate with addition of other auxiliaries such as wetting agents, colorants, bioabsorption-promoting substances, preservatives, antioxidants, light stabilizers.

Liquid suspending agents are all homogeneous solvents and solvent mixtures.

Suitable wetting agents (dispersants) are the emulsifiers given above.

Other auxiliaries which may be mentioned are those given above.

Semi-solid preparations can be administered orally or topically/dermally. They differ from the suspensions and emulsions described above only by their higher viscosity.

For the production of solid preparations, the active compound is mixed with suitable excipients, if appropriate with addition of auxiliaries, and brought into the desired form.

Suitable excipients are all physiologically tolerable solid inert substances. Those used are inorganic and organic substances. Inorganic substances are, for example, sodium chloride, carbonates such as calcium carbonate, hydrogencarbonates, aluminium oxides, titanium oxide, silicic acids, argillaceous earths, precipitated or colloidal silica, or phosphates. Organic substances are, for example, sugar, cellulose, foodstuffs and feeds such as milk powder, animal meal, grain meals and shreds, starches.

Suitable auxiliaries are preservatives, antioxidants, and/or colorants which have been mentioned above.

Other suitable auxiliaries are lubricants and glidants such as magnesium stearate, stearic acid, talc, bentonites, disintegration-promoting substances such as starch or crosslinked polyvinylpyrrolidone, binders such as starch, gelatin or linear polyvinylpyrrolidone, and dry binders such as microcrystalline cellulose.

In general, “parasiticidally effective amount” means the amount of active ingredient needed to achieve an observable effect on growth, including the effects of necrosis, death, retardation, prevention, and removal, destruction, or otherwise diminishing the occurrence and activity of the target organism. The parasiticidally effective amount can vary for the various compounds/mixtures/compositions used in the invention. A parasiticidally effective amount of the compositions will also vary according to the prevailing conditions such as desired parasiticidal effect and duration, target species, mode of application, and the like.

The compositions which can be used in the invention can comprise generally from about 0.001 to 95% of the mixture according to the invention.

Generally it is favorable to apply the mixture according to the invention in total amounts of 0.5 mg/kg to 100 mg/kg per day, preferably 1 mg/kg to 50 mg/kg per day.

Ready-to-use preparations contain the compounds acting against parasites, preferably ectoparasites, in concentrations of 10 ppm to 80 per cent by weight, preferably from 0.1 to 65 per cent by weight, more preferably from 1 to 50 per cent by weight, most preferably from 5 to 40 per cent by weight.

Preparations which are diluted before use contain the compounds acting against ectoparasites in concentrations of 0.5 to 90 per cent by weight, preferably of 1 to 50 per cent by weight.

Furthermore, the preparations comprise the mixtures according to the invention against endoparasites in concentrations of 10 ppm to 2 per cent by weight, preferably of 0.05 to 0.9 per cent by weight, very particularly preferably of 0.005 to 0.25 per cent by weight.

In a preferred embodiment of the present invention, the compositions comprising the mixtures according to the invention are applied dermally/topically.

In a further preferred embodiment, the topical application is conducted in the form of compound-containing shaped articles such as collars, medallions, ear tags, bands for fixing at body parts, and adhesive strips and foils.

Generally it is favorable to apply solid formulations which release the active compounds in total amounts of 10 mg/kg to 300 mg/kg, preferably 20 mg/kg to 200 mg/kg, most preferably 25 mg/kg to 160 mg/kg body weight of the treated animal in the course of three weeks.

For the preparation of the shaped articles, thermoplastic and flexible plastics as well as elastomers and thermoplastic elastomers are used. Suitable plastics and elastomers are polyvinyl resins, polyurethane, polyacrylate, epoxy resins, cellulose, cellulose derivatives, polyamides and polyester which are sufficiently compatible with the active compounds. A detailed list of plastics and elastomers as well as preparation procedures for the shaped articles is given e.g. in WO 03/086075.

### EXAMPLES

The present invention is now illustrated in further detail by the following examples.

The compounds I of formula I can be accomplished according to standard methods of organic chemistry, e.g. by the methods or working examples described in WO 2007/006670, PCT/EP2012/065650, PCT/EP2012/065651.

The characterization can be done by coupled High Performance Liquid Chromatography/mass spectrometry (HPLC/MS), by NMR or by their melting points.

A group of especially preferred compounds of formula I are compounds of formula IA-1 as listed in table C above.

Method A: Analytical HPLC column: RP-18 column Chromolith Speed ROD from Merck KgaA (Germany). Elution: acetonitrile+0.1% trifluoroacetic acid (TFA)/water+0.1% trifluoroacetic acid (TFA) in a ratio of from 5:95 to 95:5 in 5 minutes at 40° C.

Method B: Analytical UPLC column: Phenomenex Kinetex 1.7 μm XB-C18 100A; 50×2.1 mm; mobile phase: A: water+0.1% trifluoroacetic acid (TFA); B: acetonitrile+0.1% TFA; gradient: 5-100% B in 1.50 minutes; 100% B 0.20 min; flow: 0.8-1.0 mL/min in 1.50 minutes at 60° C.

MS-method: ESI positive.

¹H-NMR. The signals are characterized by chemical shift (ppm) vs. tetramethylsilane, by their multiplicity and by their integral (relative number of hydrogen atoms given). The following abbreviations are used to characterize the multiplicity of the signals: m=multiplett, q=quartett, t=triplett, d=doublet and s=singulett.

### PREPARATION EXAMPLES

log P determinations were performed via capillary electrophorese on a cePro9600™ from CombiSep.

Starting Materials

6,8-dichloro-1H-benzo[d][1,3]oxazine-2,4-dione and 6-chloro-8-methyl-1H-3,1-benzoxazine-2,4-dione were prepared according to WO 2007/43677.

S,S-Diisopropyl-S-aminosulfonium 2,4,6-trimethylphenylsulfonat was prepared according to Y. Tamura et al, Tetrahedron 1975, 31, 3035-3040.

2-(3-Chloropyridin-2-yl)-5-bromo-2H-pyrazole-3-carbonyl chloride was prepared according to WO 2007/24833.

### PREPARATION EXAMPLES P.1 to P.4

### Example P.1

### S,S-Dimethyl sulfinium sulfate

To a solution of sodium methylate (15.76 g of a 30% solution in methanol, 87.54 mmol, 1.100 equiv.) in methanol (60 mL) was added dimethyl sulphide (5.44 g, 6.40 mL, 87.6 mmol, 1.10 equiv.) at −5-0° C. To this mixture was added a pre-cooled solution (−20° C.) of hydroxylamine-O-sulfonic acid (9.00 g, 79.6 mmol) in methanol (60 mL) and the internal temperature was maintained at −5-0° C. After stirring at room temperature overnight, all solids were removed by filtration. The filtrate was concentrated in vacuo and the residue was triturated with acetonitrile (50 mL) to yield the title compound (7.88 g, 39%).

The following compounds were prepared by analogy to example P.1:
S,S-diethyl sulfinium sulfate
S-ethyl-S-isopropyl sulfinium sulfate
S,S-diisopropyl sulfinium sulfate
S,S-bis(2-cyclopropylmethyl) sulfinium sulfate
S,S-bis(2-cyclopropylethyl) sulfinium sulfate
S,S-bis(cyclobutylmethyl) sulfinium sulfate
S,S-bis(cyclopentylmethyl) sulfinium sulfate
S-cyclopropylmethyl-S-ethyl sulfinium sulfate
S-(2-cyclopropylethyl)-S-ethyl sulfinium sulfate
S-(2-cyclopropylethyl)-S-isopropyl sulfinium sulfate
S-(1-cyclopropylethyl)-S-isopropyl sulfinium sulfate
S-cyclobutylmethyl-S-ethyl sulfinium sulfate
S-cyclopentylmethyl-S-ethyl sulfinium sulfate
S-cyclopropylmethyl-S-isopropyl sulfinium sulfate
S-cyclobutylmethyl-S-isopropyl sulfinium sulfate
S-cyclopentylmethyl-S-isopropyl sulfinium sulfate
S,S-di-n-propyl sulfinium sulfate
S-vinyl-S-ethyl sulfinium sulfate

### Example P.2

### 8-Bromo-6-chloro-1H-benzo[d][1,3]oxazine-2,4-dione

To a solution of 2-amino-3-bromo-5-chlorobenzoic acid (10.0 g, 39.9 mmol) in dioxane (170 mL) was added phosgene (20% in toluene, 42.0 mL, 79.9 mmol) over a period of 15 mins. The reaction was stirred at ambient temperature for 48 h and then concentrated in vacuo. The resulting solid was crushed and further dried in vacuo to yield the desired product (12.6 g, 114%) which was used in the subsequent step without further purification.

The following compounds were prepared by analogy to example P.2:
6,8-dichloro-1H-benzo[d][1,3]oxazine-2,4-dione,
6,8-dibromo-1H-benzo[d][1,3]oxazine-2,4-dione,
6-Bromo-8-chloro-1H-benzo[d][1,3]oxazine-2,4-dione,
8-Bromo-6-chloro-1H-benzo[d][1,3]oxazine-2,4-dione,
6-chloro-8-methyl-1H-benzo[d][1,3]oxazine-2,4-dione,
6-bromo-8-methyl-1H-benzo[d][1,3]oxazine-2,4-dione,
6-cyano-8-methyl-1H-benzo[d][1,3]oxazine-2,4-dione,
6-chloro-8-trifluoromethyl-1H-benzo[d][1,3]oxazine-2,4-dione,
8-chloro-6-trifluoromethyl-1H-benzo[d][1,3]oxazine-2,4-dione,
6-bromo-8-trifluoromethyl-1H-benzo[d][1,3]oxazine-2,4-dione,
8-bromo-6-trifluoromethyl-1H-benzo[d][1,3]oxazine-2,4-dione,
8-chloro-6-cyano-1H-benzo[d][1,3]oxazine-2,4-dione,
6-chloro-8-methoxy-1H-benzo[d][1,3]oxazine-2,4-dione,
6-chloro-8-cyclopropyl-1H-benzo[d][1,3]oxazine-2,4-dione,
6-chloro-8-ethyl-1H-benzo[d][1,3]oxazine-2,4-dione,
6-difluoromethoxy-8-methyl-1H-benzo[d][1,3]oxazine-2,4-dione,
6-cyano-8-methoxy-1H-benzo[d][1,3]oxazine-2,4-dione,
6-fluoro-8-methyl-1H-benzo[d][1,3]oxazine-2,4-dione,
6-iodo-8-methyl-1H-benzo[d][1,3]oxazine-2,4-dione,
6-nitro-8-methyl-1H-benzo[d][1,3]oxazine-2,4-dione,
6-(5-chloro-2-thienyl)-8-methyl-1H-benzo[d][1,3]oxazine-2,4-dione,
6-(3-pyrazol-1H-yl)-8-methyl-1H-benzo[d][1,3]oxazine-2,4-dione,
6-(3-isoxazolyl)-8-methyl-1H-benzo[d][1,3]oxazine-2,4-dione,
6-(hydroxyiminomethyl)-8-methyl-1H-benzo[d][1,3]oxazine-2,4-dione,
6-(methoxyiminomethyl)-8-methyl-1H-benzo[d][1,3]oxazine-2,4-dione,
6-(dimethylhydrazonomethyl)-8-methyl-1H-benzo[d][1,3]oxazine-2,4-dione and
6-(2,2,2-trifluoroethylhydrazonomethyl)-8-methyl-1H-benzo[d][1,3]oxazine-2,4-dione.

### Example P.3

### 1-(3-chloro-2-pyridyl)-3-trifluoromethyl-1H-pyrazol

a) 2.71 kg of 1,1,1-trifluoro-4-methoxy-but-3-en-2-one, 2.44 kg of ethanol and 3.10 kg of water were charged into a reaction vessel. 20 ml of concentrated hydrochloric acid and 0.80 kg of hydrazine hydrate were successively added and the mixture was heated to reflux for 4 h. The mixtures was allowed to cool and neutralized by addition of 10% aqueous NaOH to about pH 4-5. Then the mixture was evaporated. Toluene was added and the mixture was again evaporated to yield 2 kg of raw 3-trifluoromethylpyrazole with a purity of >85%.
b) 1.72 kg (10.75 mol) of the raw 3-trifluoromethylpyrazole obtained in step a), 1.75 kg (11.83 mol) of 2,3-dichloropyridine and 4.73 kg of dimethyl formamide were charged to a reaction vessel. 2.97 kg (21.50 mol) of potassium carbonate were added, the mixture was heated to 120° C. with stirring and kept at 120-125° C. for further 3 h. The reaction mixtures was cooled to 25° C. and poured into 20 l of water. The thus obtained mixture was extracted twice with 5 L of tert.-butylmethyl ether. The combined organic phases were washed with 4 l of water and then evaporated to dryness. Toluene was added and the mixture was again evaporated to dryness. Thereby, the 2.7 kg of the title compound was obtained (purity >75% as determined by GC; yield 81.5%). The product can be purified by distillation.

¹H-NMR (400 MHz, CDCl₃): δ [delta]=6.73 (d, 1H), 7.38 (d, 1H), 7.95 (m, 1H), 8.14 (m, 1H), 8.46 (m, 1H).

### Example P.4

### 2-(3-Chloropyridin-2-yl)-5-trifluoromethyl-2H-pyrazole-3-carbonyl chloride

In a reaction vessel equipped with a thermometer, septum, nitrogen inlet and stirring bar, 10.0 g (40.4 mmol) of 1-(3-chloro-2-pyridyl)-3-trifloromethyl-1H-pyrazole were dissolved in 50 ml of dry dimethoxyethane. By means of a syringe, 40.4 ml of a 2 M solution (80.8 mmol, 2.0 equiv.) of isopropyl magnesium chloride in tetrahydrofuran were added dropwise with stirring, while cooling the vessel with an ice bath and keeping the internal temperature at about 5° C. The mixture was stirred for further 2 hours at 5° C. Then the ice-bath was removed and carbon dioxide was bubbled through mixture causing an increase of the temperature up to 28° C. After 10 minutes, the exothermic reaction has ceased, and, the mixture was cooled and all volatiles were removed by evaporation. The residue containing the carboxylate compound I-A was taken up in 50 mL of dichloromethane and one drop of dry DMF was added. To this mixture, 14.41 g (121.2 mmol, 3.0 equiv.) of thionyl chloride were added and heated to reflux for 3 hours. After cooling, the resulting precipitate was removed by filtration and the mother liquid was concentrated in vacuum to obtain 13.0 g of the title compound (purity >85%, yield 100%) which was used in the next step without further purification.

¹H-NMR (400 MHz, CDCl₃): δ[delta]=7.43-7.54 (m, 2H), 7.93 (d, 1H), 8.52 (m, 1H).

### Example P.5

### 2-amino-5-chloro-N-(dimethyl-λ⁴-sulfanylidene)-3-methyl-benzamide

To a solution of 6-chloro-8-methyl-1H-3,1-benzoxazine-2,4-dione (3.00 g, 12.8 mmol) in dichloromethane (40 mL) was added dimethyl sulfinium sulfate (2.25 g, 8.93 mmol, 0.70 equiv.) and potassium tert-butylate (1.58 g, 14.0 mmol, 1.10 equiv.) at room temperature. The mixture was stirred for 1.5 h, upon which water was added and the layers were separated. The aqueous layer was extracted with dichloromethane, combined organic layers were dried over sodium sulphate and concentrated in vacuo. The residue was purified by flash-chromatography on silica gel to yield the title compound (2.63 g, 84%).

Characterization by HPLC-MS: 1.855 min, M=245.00.

### Example P.6

### 2-amino-5-chloro-N-(bis-2-methylpropyl-λ⁴-sulfanylidene)-3-methyl-benzamide

To a solution of 6-chloro-8-methyl-1H-3,1-benzoxazine-2,4-dione (3.00 g, 12.8 mmol) in dichloromethane (40 mL) was added bis-2-methylpropyl sulfinium sulfate (3.76 g, 8.93 mmol, 0.70 equiv.) and potassium tert-butylate (1.58 g, 14.0 mmol, 1.10 equiv.) at room temperature.

The mixture was stirred for 1.5 h, upon which water was added and the layers were separated.

The aqueous layer was extracted with dichloromethane, combined organic layers were dried over sodium sulphate and concentrated in vacuo. The residue was purified by flash-chromatography on silica gel to yield the title compound (2.89 g, 69%).

Characterization by ¹H-NMR (400 MHz, DMSO-d₆): δ[delta]=1.04 (m, 12H), 2.06 (s, 3H), 2.96 (m, 2H), 3.01 (m, 2H), 6.62 (br. s, 2H), 7.03 (s, 1H), 7.72 (s, 1H).

### Example P.7

### 2-amino-5-chloro-N-(diethyl-λ⁴-sulfanylidene)-3-methyl-benzamide

To a solution of 6-chloro-8-methyl-1H-3,1-benzoxazine-2,4-dione (2 g, 0.01 mol) in anhydrous propylene carbonate (30 mL) was added bis-2-ethyl sulfinium sulfate (2.04 g, 0.01 mol, 0.70 equiv.) and triethyl amine (1.38 mL, 1.0 g g, 0.01 mol, 1.05 equiv.) at room temperature. The mixture was stirred for 4.5 h, and then added dropwise to ice-water. The mixture was extracted with dichloromethane and the combined organic layers were dried over sodium sulphate and concentrated in vacuo. The residue was triturated with ether to yield the title compound (1.43 g, 55%).

Characterization by ¹H-NMR (400 MHz, CDCl₃): δ[delta]=1.39 (t, 6H), 2.13 (s, 3H), 3.02 (q, 4H), 5.95 (br. S, 2H), 7.01 (s, 1H), 7.98 (s, 1H).

### Example P.8

### 2-amino-3,5-dichloro-N-(bis-2-methylpropyl-λ⁴-sulfanylidene)-benzamide

The title compound was prepared by analogy to the method of example P.6

Yield: 60%

Characterization by ¹H-NMR (400 MHz, DMSO-d₆): δ[delta]=1.23 (d, 6H), 1.38 (d, 6H), 3.42 (m, 2H), 7.02 (br. s, 2H), 7.41 (s, 1H), 7.95 (s, 1H).

### Example P.9

### 2-amino-3,5-dibromo-N-(bis-2-methylpropyl-λ⁴-sulfanylidene)-benzamide

The title compound was prepared by analogy to the method of example P.6

Yield: 66%

Characterization by HPLC-MS: 3.409 min, m/z=410.90 (Method A)

### Preparation of the Compounds of Formula IA-1

### Examples 1 to 4

### Example 1

### 2-(3-chloro-2-pyridyl)-N-[2,4-dichloro-6-[(diethyl-λ⁴-sulfanylidene)carbamoyl]phenyl]-5-(trifluoromethyl)pyrazole-3-carboxamide (Compound I-16)

To a suspension of potassium carbonate (8.08 g, 58.5 mmol, 1.50 equiv) and 2-amino-3,5-dichloro-N-(diethyl-λ⁴-sulfanylidene)benzamide (11.43 g, 38.98 mmol) in acetonitrile (100 mL) was added a solution of 2-(3-chloro-2-pyridyl)-5-(trifluoromethyl)pyrazole-3-carbonyl chloride (15.8 g, 43.31 mmol, 1.10 equiv.) in acetonitrile (50 mL) at room temperature. After 6 h at this temperature, the solids were filtered off. The resulting filtrate was washed with water and dried over Na₂SO₄. After filtration, the filtrate was concentrated in vacuum and the resulting solids were crystallized from diisopropyl ether to yield the title compound (19.53 g, 88%).

Characterization by ¹H-NMR (400 MHz, DMSO-d₆):

δ[delta]=1.13 (t, 6H), 2.91 (m, 2H), 3.08 (m, 2H), 7.67 (dd, 1H), 7.77 (s, 2H), 7.89 (s, 1H), 8.22 (d, 1H), 8.51 (d, 1H), 10.73 (s, 1H).

### Example 2

### Synthesis of 2-(3-chloro-2-pyridyl)-N-[2,4-dichloro-6-[(bis-2-propyl-λ⁴-sulfanylidene)carbamoyl]phenyl]-5-(trifluoromethyl)pyrazole-3-carboxamide (Compound (I-26)

To a suspension of potassium carbonate (0.892 g, 6.46 mmol, 1.10 equiv) and 2-amino-3,5-dichloro-N-(bis-2-propyl-λ⁴-sulfanylidene)benzamide (2.05 g, 5.87 mmol) in toluene (30 mL) was added a solution of 2-(3-chloro-2-pyridyl)-5-(trifluoromethyl)pyrazole-3-carbonyl chloride (2.02 g, 5.87 mmol, 1.00 equiv.) in toluene (20 mL) at 60° C. After 45 min at this temperature, the mixture was cooled and water was added. The resulting precipitate was collected by filtration, washed with water and toluene and dried to obtain the title compound (3.07 g, 84%).

Characterization by HPLC-MS: 1.395 min, M=602.1 (Method B)

Characterization by ¹H-NMR (400 MHz, DMSO-d₆):

δ[delta]=1.18 (d, 6H), 1.22 (d, 6H), 3.30 (m, 2H), 7.68 (dd, 1H), 7.75 (m, 2H), 7.81 (s, 1H), 8.21 (d, 1H), 8.54 (d, 1H), 10.76 (s, 1H).

### Example 3

### Synthesis of 2-(3-chloro-2-pyridyl)-N-[2-methyl-4-chloro-6-[(bis-2-propyl-λ⁴-sulfanylidene)carbamoyl]phenyl]-5-(trifluoromethyl)pyrazole-3-carboxamide (Compound I-21)

To a suspension of potassium carbonate (126.01 g, 911.76 mmol, 1.30 equiv) and 2-amino-3-methyl-5-chloro-N-(bis-2-propyl-λ⁴-sulfanylidene)benzamide (211 g, 701 mmol) in dichloromethane (300 mL) was added a solution of 2-(3-chloro-2-pyridyl)-5-(trifluoromethyl)pyrazole-3-carbonyl chloride (256.78 g, 771.49 mmol, 1.10 equiv.) in dichloromethane (200 mL) at room temperature. After 2 h at this temperature, the solids were filtered off. The resulting filtrate was washed with water and dried over Na₂SO₄. After filtration, the filtrate was concentrated in vacuum and the resulting solids were crystallized from diisopropyl ether to yield the title compound (344.2 g, 85%).

Characterization by HPLC-MS: 1.303 min, M=574.3 (Method B)

Characterization by ¹H-NMR (400 MHz, DMSO-d₆): δ[delta]=1.20 (d, 6H), 1.30 (d, 6H), 2.15 (s, 3H), 3.30 (m, 2H), 7.41 (s, 1H), 7.62 (m, 2H), 7.80 (s, 1H), 8.22 (d, 1H), 8.52 (d, 1H), 10.88 (s, 1H).

### Example 4a

### 2-(3-chloro-2-pyridyl)-N-[2-methyl-4-chloro-6-[(diethyl-λ⁴-sulfanylidene)carbamoyl]phenyl]-5-(trifluoromethyl)pyrazole-3-carboxamide (Compound I-11)

To a suspension of potassium carbonate (0.71 g, 10 mmol, 1.3 equiv) and 2-amino-3-methyl-5-chloro-N-(diethyl-λ⁴-sulfanylidene)benzamide (1.42 g, 3.96 mmol) in propylene carbonate (20 mL) was added a solution of 2-(3-chloro-2-pyridyl)-5-(trifluoromethyl)pyrazole-3-carbonyl chloride (1.35 g, 4.35 mmol, 1.10 equiv.) in propylene carbonate (10 mL) at room temperature.

After 24 h at this temperature, the mixture was poured onto water and spiked with ethanol under vigorous stirring. The resulting solids were collected by filtration and contained pure title compound (1.57 g, 73%).

Characterization by HPLC-MS: 1.19 min, m/z 546.1 (M+H)+; (Method B)

Characterization by ¹H-NMR (500 MHz, DMSO) [delta]: 10.87 (s, 1H), 8.53 (d, 1H), 8.22 (d, 1H), 7.75 (s, 1H), 7.65 (m, 2H), 7.40 (s, 1H), 3.09 (m, 2H), 2.92 (m, 2H) 1.15 (m, 6H).

### Example 4b

### 2-(3-chloro-2-pyridyl)-N-[2-methyl-4-chloro-6-[(diethyl-λ⁴-sulfanylidene)carbamoyl]phenyl]-5-(trifluoromethyl)pyrazole-3-carboxamide (Compound I-11)

To a solution of 2-(3-chloro-2-pyridyl)-5-(trifluoromethyl)pyrazole-3-carbonyl chloride (150 g, 435 mmol) in acetonitrile (900 mL) at room temperature was added potassium carbonate (59 g, 427 mmol). A solution of 2-amino-5-chloro-N-(diethyl-sulfanylidene)-3-methyl-benzamide (117 g, 427 mmol) in acetonitrile (100 mL) was added dropwise within 1 hour while maintaining a reaction temperature of 25-28° C. with occasional cooling (slightly exothermic reaction). The mixture was stirred for 16 hours at room temperature. The reaction mixture was then poured on ice-water mixture (5

L) and the pH was adjusted to 7-8 with concentrated HCl. The mixture stirred for an additional 2 hours. The light brown solid was filtered, washed with water and dried under air to give the crude product (229 g).

3 combined batches of crude product (789 g) were suspended in acetonitrile (2.6 L) and dissolved upon heating at 60° C. After 1 hour of stirring at 60° C. the solution was cooled by means of an ice-bath and the thereby formed solid was filtered off. The mother-liquor was concentrated to 300 mL and cooled with ice-bath. Thereby additional solid formed was filtered. The combined solids were washed with cold acetonitrile and dried at 50° C. in a vacuum-oven over night to give the title product (703 g, 89%) as a crystalline white solid.

By the methods described in examples 1 to 4 or analogy thereof, the compounds of formula (IA-1) summarized in table C were prepared:

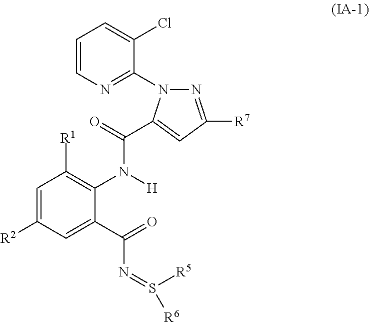

TABLE C

| | | | | | | | RT | |
|---|---|---|---|---|---|---|---|---|
| | R¹ | R² | R⁷ | R⁵ | R⁶ | MS | [min] | m/z |
| I-1 | Me | Cl | CF₃ | CH₃ | CH₃ | logP: 2.9 [pH = 10.0]; | | |
| | | | | | | m.p: 182° C. | | |
| I-2 | Me | Cl | CHF₂ | CH₃ | CH₃ | B | 1.06 | 500.2 |
| I-3 | Me | Cl | Br | CH₃ | CH₃ | A | 3.067 | 529.95 |
| I-4 | Me | Cl | Cl | CH₃ | CH₃ | | | |
| I-5 | Me | Cl | CN | CH₃ | CH₃ | | | |
| I-6 | Cl | Cl | CF₃ | CH₃ | CH₃ | A | 3.372 | 539.95 |
| I-7 | Cl | Cl | CHF₂ | CH₃ | CH₃ | B | 1.062 | 520.2 |
| I-8 | Cl | Cl | Br | CH₃ | CH₃ | A | 3.015 | 549.80 |
| I-9 | Cl | Cl | Cl | CH₃ | CH₃ | | | |
| I-10 | Cl | Cl | CN | CH₃ | CH₃ | | | |
| I-11 | Me | Cl | CF₃ | C₂H₅ | C₂H₅ | B | 1.207 | 546.1 |
| I-12 | Me | Cl | CHF₂ | C₂H₅ | C₂H₅ | B | 1.134 | 528.2 |
| I-13 | Me | Cl | Br | C₂H₅ | C₂H₅ | A | 3.309 | 557.95 |
| I-14 | Me | Cl | Cl | C₂H₅ | C₂H₅ | | | |
| I-15 | Me | Cl | CN | C₂H₅ | C₂H₅ | B | 1.098 | 503.3 |
| I-16 | Cl | Cl | CF₃ | C₂H₅ | C₂H₅ | A | 3.450 | 565.90 |
| I-17 | Cl | Cl | CHF₂ | C₂H₅ | C₂H₅ | B | 1.144 | 549.9 |
| I-18 | Cl | Cl | Br | C₂H₅ | C₂H₅ | | | |
| I-19 | Cl | Cl | Cl | C₂H₅ | C₂H₅ | | | |
| I-20 | Cl | Cl | CN | C₂H₅ | C₂H₅ | B | 1.119 | 524.9 |
| I-21 | Me | Cl | CF₃ | CH(CH₃)₂ | CH(CH₃)₂ | B | 1.303 | 574.3 |
| I-22 | Me | Cl | CHF₂ | CH(CH₃)₂ | CH(CH₃)₂ | B | 1.225 | 556.3 |
| I-23 | Me | Cl | Br | CH(CH₃)₂ | CH(CH₃)₂ | logP: 2.9 [pH = 10.0] | | |
| I-24 | Me | Cl | Cl | CH(CH₃)₂ | CH(CH₃)₂ | | | |
| I-25 | Me | Cl | CN | CH(CH₃)₂ | CH(CH₃)₂ | B | 1.19 | 531.3 |
| I-26 | Cl | Cl | CF₃ | CH(CH₃)₂ | CH(CH₃)₂ | A | 3.835 | 596.05 |
| I-27 | Cl | Cl | CHF₂ | CH(CH₃)₂ | CH(CH₃)₂ | B | 1.24 | 578 |
| I-28 | Cl | Cl | Br | CH(CH₃)₂ | CH(CH₃)₂ | A | 3.538 | 605.80 |
| I-29 | Cl | Cl | Cl | CH(CH₃)₂ | CH(CH₃)₂ | | | |
| I-30 | Cl | Cl | CN | CH(CH₃)₂ | CH(CH₃)₂ | B | 1.209 | 553.1 |
| I-31 | Br | Br | CF₃ | C₂H₅ | C₂H₅ | B | 1.218 | 655.9 |
| I-32 | Br | Br | CHF₂ | C₂H₅ | C₂H₅ | B | 1.171 | 638.1 |
| I-33 | Br | Br | Br | C₂H₅ | C₂H₅ | | | |
| I-34 | Br | Br | Cl | C₂H₅ | C₂H₅ | | | |
| I-35 | Br | Br | CN | C₂H₅ | C₂H₅ | | | |
| I-36 | Br | Br | CF₃ | CH(CH₃)₂ | CH(CH₃)₂ | A | 3.665 | 683.90 |
| I-37 | Br | Br | CHF₂ | CH(CH₃)₂ | CH(CH₃)₂ | B | 1.245 | 666.1 |
| I-38 | Br | Br | Br | CH(CH₃)₂ | CH(CH₃)₂ | | | |
| I-39 | Br | Br | Cl | CH(CH₃)₂ | CH(CH₃)₂ | | | |
| I-40 | Br | Br | CN | CH(CH₃)₂ | CH(CH₃)₂ | | | |
| I-41 | Cl | CN | CF₃ | CH(CH₃)₂ | CH(CH₃)₂ | | | |

### B. Biology

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 20-22):

$$E = X + Y - \frac{XY}{100}$$

When the observed combined control effect is greater than the expected combined control effect (E), then the combined effect is synergistic.

The following tests demonstrate the control efficacy of compounds, mixtures or compositions of this invention on specific pests. However, the pest control protection afforded by the compounds, mixtures or compositions is not limited to these species. In certain instances, combinations of a compound of this invention with other invertebrate pest control compounds or agents are found to exhibit synergistic effects against certain important invertebrate pests.

The analysis of synergism or antagonism between the mixtures or compositions was determined using Colby's equation.

### BIOLOGICAL EXAMPLES

### B.1 Vetch Aphid (Megoura viciae)

For evaluating control of vetch aphid (Megoura viciae) through contact or systemic means the test unit consisted of 24-well-microtiter plates containing broad bean leaf disks.

The compounds or mixtures were formulated using a solution containing 75% water (v/v) and 25% DMSO (v/v). Different concentrations of formulated compounds or mixtures were sprayed onto the leaf disks at 2.5 μl, using a custom built micro atomizer, at two replications.

For experimental mixtures in these tests identical volumes of both mixing partners at the desired concentrations respectively, were mixed together.

After application, the leaf disks were air-dried and 5-8 adult aphids placed on the leaf disks inside the microtiter plate wells. The aphids were then allowed to suck on the treated leaf disks and incubated at 23±1° C., 50±5% RH for 5 days. Aphid mortality and fecundity was then visually assessed. For the mixture tested the results are as follows:

| Vetch Aphid | ppm | Average Control % |
|---|---|---|
| Spirotetramat + I-11 | 0 + 1 | 0 |
| | 80 + 0 | 25 |
| | 80 + 1 | 75* |

*synergistic control effect according to Colby's equation

### B.2 Green Peach Aphid (Myzus persicae)

For evaluating control of green peach aphid (Myzus persicae) through systemic means the test unit consisted of 96-well-microtiter plates containing liquid artificial diet under an artificial membrane.

The compounds or mixtures were formulated using a solution containing 75% water (v/v) and 25% DMSO (v/v). Different concentrations of formulated compounds or mixtures were pipetted into the aphid diet, using a custom built pipetter, at two replications.

For experimental mixtures in these tests identical volumes of both mixing partners at the desired concentrations respectively, were mixed together.

After application, 5-8 adult aphids were placed on the artificial membrane inside the microtiter plate wells. The aphids were then allowed to suck on the treated aphid diet and incubated at 23±1° C., 50±5% RH for 3 days. Aphid mortality and fecundity was then visually assessed. For the mixture tested the results are as follows:

| Green Peach Aphid | ppm | Average Control % |
|---|---|---|
| Spirotetramat + I-11 | 0 + 1 | 0 |
| | 80 + 0 | 50 |
| | 80 + 1 | 75* |
| Spirotetramat + I-16 | 0 + 1 | 25 |
| | 3.2 + 0 | 0 |
| | 3.2 + 1 | 75* |
| Thiacloprid + I-11 | 0 + 1 | 0 |
| | 0.0016 + 0 | 50 |
| | 0.0016 + 1 | 100* |

*synergistic control effect according to Colby's equation

### B.3 Boll Weevil (Anthonomus grandis)

For evaluating control of boll weevil (Anthonomus grandis) the test unit consisted of 24-well-microtiter plates containing an insect diet and 20-30 A. grandis eggs.

The compounds or mixtures were formulated using a solution containing 75% water and 25% DMSO. Different concentrations of formulated compounds or mixtures were sprayed onto the insect diet at 20 μl, using a custom built micro atomizer, at two replications.

For experimental mixtures in these tests identical volumes of both mixing partners at the desired concentrations respectively, were mixed together.

After application, microtiter plates were incubated at 23±1° C., 50±5% RH for 5 days. Egg and larval mortality was then visually assessed. For the mixture tested the results are as follows:

| | | Average |
|---|---|---|
| Boll Weevil | ppm | (Control %) |
| Spinosad + I-21 | 0 + 5 | 0 |
| | 0.08 + 0 | 0 |
| | 0.08 + 5 | 50* |
| Thiacloprid + I-11 | 0 + 1 | 0 |
| | 0.0016 + 0 | 0 |
| | 0.0016 + 1 | 50* |
| Ethiprol + I-31 | 0 + 1 | 0 |
| | 2 + 0 | 50 |
| | 2 + 1 | 100* |

*synergistic control effect according to Colby's equation

### B.4 Mediterranean Fruitfly (Ceratitis capitata)

For evaluating control of Mediterranean fruitfly (Ceratitis capitata) the test unit consisted of 96-well-microtiter plates containing an insect diet and 50-80 C. capitata eggs.

The compounds or mixtures were formulated using a solution containing 75% water and 25% DMSO. Different concentrations of formulated compounds or mixtures were sprayed onto the insect diet at 5 μl, using a custom built micro atomizer, at two replications.

For experimental mixtures in these tests identical volumes of both mixing partners at the desired concentrations respectively, were mixed together.

After application, microtiter plates were incubated at 28±1° C., 80±5% RH for 5 days. Egg and larval mortality was then visually assessed. For the mixture tested the results are as follows:

| | | Average |
|---|---|---|
| Mediterranean fruitfly | ppm | (Control %) |
| Spinosad + I-21 | 0 + 5 | 0 |
| | 0.08 + 0 | 0 |
| | 0.08 + 5 | 75* |
| Ethiprol + I-21 | 0 + 5 | 0 |
| | 10 + 0 | 0 |
| | 10 + 5 | 75* |
| Ethiprol + I-16 | 0 + 5 | 0 |
| | 10 + 0 | 0 |
| | 10 + 5 | 50* |
| Clothianidin + I-31 | 0 + 2 | 0 |
| | 1 + 0 | 0 |
| | 1 + 2 | 75* |

*synergistic control effect according to Colby's equation

### B.5 Tobacco Budworm (Heliothis virescens)

For evaluating control of tobacco budworm (Heliothis virescens) the test unit consisted of 96-well-microtiter plates containing an insect diet and 15-25 H. virescens eggs.

The compounds or mixtures were formulated using a solution containing 75% water (v/v) and 25% DMSO (v/v). Different concentrations of formulated compounds or mixtures were sprayed onto the insect diet at 10 μl, using a custom built micro atomizer, at two replications.

For experimental mixtures in these tests identical volumes of both mixing partners at the desired concentrations respectively, were mixed together.

After application, microtiter plates were incubated at 28±1° C., 80±5% RH for 5 days. Egg and larval mortality was then visually assessed. For the mixture tested the results are as follows:

| | | Average |
|---|---|---|
| Tobacco budworm | ppm | (Control %) |
| Spirotetramat + I-21 | 0 + 0.2 | 0 |
| | 3.2 + 0 | 0 |
| | 3.2 + 0.2 | 50* |
| Ethiprol + I-21 | 0 + 1 | 50 |
| | 0.08 + 0 | 0 |
| | 0.08 + 1 | 100* |
| Spinosad + I-11 | 0 + 0.2 | 0 |
| | 0.08 + 0 | 0 |
| | 0.08 + 0.2 | 50* |
| Spinosad + I-16 | 0 + 1 | 0 |
| | 0.4 + 0 | 0 |
| | 0.4 + 1 | 50* |
| Clothianidin + I-31 | 0 + 1 | 0 |
| | 0.08 + 0 | 0 |
| | 0.08 + 1 | 50* |

*synergistic control effect according to Colby's equation

### B.6 Cowpea Aphid (aphis craccivora)

Potted cowpea plants colonized with approximately 100-150 aphids of various stages are sprayed after the pest population has been recorded. Population reduction is assessed after 24, 72, and 120 hours.

### B.7 Diamond Back Moth (Plutella Xylostella)

The active compound is dissolved at the desired concentration in a mixture of 1:1 (vol/vol) distilled water:aceteone. Surfactant (Alkamuls® EL 620) is added at a rate of 0.1% (vol/vol). The test solution is prepared at the day of use.

Leaves of cabbage are dipped in test solution and air-dried. Treated leaves are placed in petri dishes lined with moist filter paper and inoculated with ten 3rd instar larvae. Mortality is recorded 72 hours after treatment. Feeding damages are also recorded using a scale of 0-100%.

### B.8 Orchid Thrips (Dichromothrips Corbetti)

Dichromothrips corbetti adults used for bioassay are obtained from a colony maintained continuously under laboratory conditions. For testing purposes, the test compound is diluted to a concentration of 300 ppm (wt compound: vol diluent) in a 1:1 mixture of acetone:water (vol:vol), plus 0.01% vol/vol Kinetic® surfactant.

Thrips potency of each compound is evaluated by using a floral-immersion technique. Plastic petri dishes are used as test arenas. All petals of individual, intact orchid flowers are dipped into treatment solution and allowed to dry. Treated flowers are placed into individual petri dishes along with 10-15 adult thrips. The petri dishes are then covered with lids. All test arenas are held under continuous light and a temperature of about 28° C. for duration of the assay. After 4 days, the numbers of live thrips are counted on each flower, and along inner walls of each petri dish. The level of thrips mortality is extrapolated from pre-treatment thrips numbers.

### B.9 Silverleaf Whitefly (Bemisia argentifolii)

The active compounds are formulated in cyclohexanone as a 10,000 ppm solution supplied in tubes. The tubes are inserted into an automated electrostatic sprayer equipped with an atomizing nozzle and they serve as stock solutions for which lower dilutions are made in 50% acetone:50% water (v/v). A nonionic surfactant (Kinetic®) is included in the solution at a volume of 0.01% (v/v).

Cotton plants at the cotyledon stage (one plant per pot) are sprayed by an automated electrostatic plant sprayer equipped with an atomizing spray nozzle. The plants are dried in the sprayer fume hood and then removed from the sprayer. Each pot is placed into a plastic cup and about 10 to 12 whitefly adults (approximately 3-5 days old) are introduced. The insects are collected using an aspirator and a nontoxic Tygon® tubing connected to a barrier pipette tip.

The tip, containing the collected insects, is then gently inserted into the soil containing the treated plant, allowing insects to crawl out of the tip to reach the foliage for feeding. Cups are covered with a reusable screened lid. Test plants are maintained in a growth room at about 25° C. and about 20-40% relative humidity for 3 days, avoiding direct exposure to fluorescent light (24 hour photoperiod) to prevent trapping of heat inside the cup. Mortality is assessed 3 days after treatment, compared to untreated control plants.

### B.10 Southern Armyworm (Spodoptera eridania)

The active compounds are formulated in cyclohexanone as a 10,000 ppm solution supplied in tubes. The tubes are inserted into an automated electrostatic sprayer equipped with an atomizing nozzle and they serve as stock solutions for which lower dilutions are made in 50% acetone:50% water (v/v). A nonionic surfactant (Kinetic) is included in the solution at a volume of 0.01% (v/v).

Lima bean plants (variety Sieva) are grown 2 plants to a pot and selected for treatment at the 1^{st} true leaf stage. Test solutions are sprayed onto the foliage by an automated electrostatic plant sprayer equipped with an atomizing spray nozzle. The plants are dried in the sprayer fume hood and then removed from the sprayer. Each pot is placed into perforated plastic bags with a zip closure. About 10 to 11 armyworm larvae are placed into the bag and the bags zipped closed. Test plants are maintained in a growth room at about 25° C. and about 20-40% relative humidity for 4 days, avoiding direct exposure to fluorescent light (24 hour photoperiod) to prevent trapping of heat inside the bags. Mortality and reduced feeding are assessed 4 days after treatment, compared to untreated control plants.

### B.11 Red Spider Mite (Tetranychus kanzawai)

The active compound is dissolved at the desired concentration in a mixture of 1:1 (vol:vol) distilled water:acetone. Add surfactant (Alkamuls® EL 620) at the rate of 0.1% (vol/vol). The test solution is prepared at the day of use.

Potted cowpea beans of 7-10 days of age are cleaned with tap water and sprayed with 5 ml of the test solution using air driven hand atomizer. The treated plants are allowed to air dry and afterwards inculated with 20 or more mites by clipping a cassava leaf section with known mite population. Treated plants are placed inside a holding room at about 25-27° C. and about 50-60% relative humidity.

Percent mortality is assessed 72 hours after treatment.

### B.12 Rice Green Leafhopper (Nephotettix virescens)

Rice seedlings are cleaned and washed 24 hours before spraying. The active compounds are formulated in 50:50 acetone:water (vol:vol), and 0.1% vol/vol surfactant (EL 620) is added.

Potted rice seedlings are sprayed with 5 ml test solution, air dried, placed in cages and inoculated with 10 adults. Treated rice plants are kept at about 28-29° C. and relative humidity of about 50-60%. Percent mortality is recorded after 72 hours.

### B13. Rice Brown Plant Hopper (Nilaparvata lugens)

Rice seedlings are cleaned and washed 24 hours before spraying. The active compounds are formulated in 50:50 acetone:water (vol:vol) and 0.1% vol/vol surfactant (EL 620) is added.

Potted rice seedlings are sprayed with 5 ml test solution, air dried, placed in cages and inoculated with 10 adults. Treated rice plants are kept at about 28-29° C. and relative humidity of about 50-60%. Percent mortality is recorded after 72 hours.

### B.14 Colorado Potato Beetle (Leptinotarsa decemlineata)

The active compounds are formulated in cyclohexanone as a 10,000 ppm solution supplied in tubes. The tubes are inserted into an automated electrostatic sprayer equipped with an atomizing nozzle and they serve as stock solutions for which lower dilutions are made in 50% acetone:50% water (v/v). A nonionic surfactant (Kinetic®) is included in the solution at a volume of 0.01% (v/v).

Eggplants are grown 2 plants to a pot and are selected for treatment at the 1st true leaf stage. Test solutions are sprayed onto the foliage by an automated electrostatic plant sprayer equipped with an atomizing spray nozzle. The plants are dried in the sprayer fume hood and then removed from the sprayer. The treated foliage is then cut and removed from the pot and placed in a Petri dish lined with moistened filter pa-per. Five beetle larvae are introduced into each Petri dish and the dish is covered by a Petri dish lid. Petri dishes are maintained in a growth room at about 25° C. and about 20-40% relative humidity for 4 days, avoiding direct exposure to fluorescent light (24 hour photoperiod) to prevent trapping of heat inside the dishes. Mortality and reduced feeding are assessed 4 days after treatment, compared to untreated control plants.

1-25. (canceled)

26. Pesticidal mixtures comprising as active compounds
1) at least one pesticidally active anthranilamide compound of formula (I): 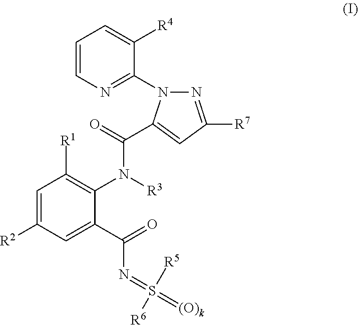
wherein
R¹ is selected from the group consisting of halogen, methyl and halomethyl;
R² is selected from the group consisting of hydrogen, halogen, halomethyl and cyano;
R³ is selected from hydrogen, C₁-C₆ alkyl, C₁-C₆ haloalkyl, C₂-C₆-alkenyl, C₂-C₆-haloalkenyl, C₂-C₆-alkinyl, C₂-C₆-haloalkinyl, C₃-C₈-cycloalkyl, C₃-C₈-halocycloalkyl, C₁-C₄-alkoxy-C₁-C₄-alkyl, C₁-C₄-haloalkoxy-C₁-C₄-alkyl, C(═O)R^{a}, C(═O)OR^{b} and C(═O)NR^{c}R^{d};
R⁴ is hydrogen or halogen;
R⁵, R⁶ are selected independently of one another from the group consisting of hydrogen, C₁-C₁₀-alkyl, C₃-C₈-cycloalkyl, C₂-C₁₀-alkenyl, C₂-C₁₀-alkynyl, wherein the aforementioned aliphatic and cycloaliphatic radicals may be substituted with 1 to 10 substituents R^{e}, and phenyl, which is unsubstituted or carries 1 to 5 substituents R^{f}; or
R⁵ and R⁶ together represent a C₂-C₇-alkylene, C₂-C₇-alkenylene or C₆-C₉-alkynylene chain forming together with the sulfur atom to which they are attached a 3-, 4-, 5-, 6-, 7-, 8-, 9- or 10-membered saturated, partially unsaturated or fully unsaturated ring, wherein 1 to 4 of the CH₂ groups in the C₂-C₇-alkylene chain or 1 to 4 of any of the CH₂ or CH groups in the C₂-C₇-alkenylene chain or 1 to 4 of any of the CH₂ groups in the C₆-C₉-alkynylene chain may be replaced by 1 to 4 groups independently selected from the group consisting of C═O, C═S, O, S, N, NO, SO, SO₂ and NH, and wherein the carbon and/or nitrogen atoms in the C₂-C₇-alkylene, C₂-C₇-alkenylene or C₆-C₉-alkynylene chain may be substituted with 1 to 5 substituents independently selected from the group consisting of halogen, cyano, C₁-C₆-alkyl, C₁-C₆-haloalkyl, C₁-C₆-alkoxy, C₁-C₆-haloalkoxy, C₁-C₆-alkylthio, C₁-C₆-haloalkylthio, C₃-C₈-cycloalkyl, C₃-C₈-halocycloalkyl, C₂-C₆-alkenyl, C₂-C₆-haloalkenyl, C₂-C₆-alkynyl and C₂-C₆-haloalkynyl; said substituents being identical or different from one another if more than one substituent is present;
R⁷ is selected from the group consisting of bromo, chloro, difluoromethyl, trifluoromethyl, nitro, cyano, OCH₃, OCHF₂, OCH₂F, OCH₂CF₃, S(═O)ₙCH₃, and S(═O)ₙCF₃;
R^{a} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkylsulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄ alkoxy; phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy, (C₁-C₆-alkoxy)carbonyl, C₁-C₆-alkylamino and di-(C₁-C₆-alkyl)amino,
R^{b} is selected from the group consisting of C₁-C₆-alkyl, C₂-C₆-alkenyl, C₂-C₆-alkinyl, C₃-C₈-cycloalkyl, C₁-C₆-alkoxy, C₁-C₆-alkylthio, C₁-C₆-alkylsulfinyl, C₁-C₆-alkylsulfonyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 substituents selected from C₁-C₄-alkoxy; phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆-haloalkoxy and (C₁-C₆-alkoxy)carbonyl;
R^{c}, R^{d} are, independently from one another and independently of each occurrence, selected from the group consisting of hydrogen, cyano, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄-alkoxy;
C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, phenyl, benzyl, pyridyl and phenoxy, wherein the four last mentioned radicals may be unsubstituted, partially or fully halogenated and/or carry 1, 2 or 3 substituents selected from C₁-C₆-alkyl, C₁-C₆-haloalkyl, C₁-C₆-alkoxy, C₁-C₆ haloalkoxy and (C₁-C₆-alkoxy)carbonyl; or R^{c} and R^{d}, together with the nitrogen atom to which they are bound, may form a 3-, 4-, 5-, 6- or 7-membered saturated, partially unsaturated or fully unsaturated heterocyclic ring which may additionally contain 1 or 2 further heteroatoms or heteroatom groups selected from N, O, S, NO, SO and SO₂, as ring members, where the heterocyclic ring may optionally be substituted with halogen, C₁-C₄-haloalkyl, C₁-C₄-alkoxy or C₁-C₄-haloalkoxy;
R^{e} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, —C(═NR^{c})NR^{c}R^{d}, phenyl, benzyl, pyridyl and phenoxy, wherein the last four radicals may be unsubstituted, partially or fully halogenated and/or carry 1, 2 or 3 substituents selected from C₁-C₆-alkyl, C₁-C₆-haloalkyl, C₁-C₆-alkoxy and C₁-C₆-haloalkoxy; or
two vicinal radicals Re together form a group ═O, ═CH(C₁-C₄-alkyl), ═C(C₁-C₄-alkyl)C₁-C₄-alkyl, ═N(C₁-C₆-alkyl) or ═NO(C₁-C₆-alkyl);
R^{f} is independently selected from the group consisting of halogen, cyano, nitro, —OH, —SH, —SCN, C₁-C₆-alkyl, C₂-C₆-alkenyl, C₂-C₆-alkinyl, C₃-C₈-cycloalkyl, wherein one or more CH₂ groups of the aforementioned radicals may be replaced by a C═O group, and/or the aliphatic and cycloaliphatic moieties of the aforementioned radicals may be unsubstituted, partially or fully halogenated and/or may carry 1 or 2 radicals selected from C₁-C₄ alkoxy;
C₁-C₆-alkoxy, C₁-C₆-haloalkoxy, C₁-C₆-alkylthio, C₁-C₆-alkylsulfinyl, C₁-C₆-alkylsulfonyl, C₁-C₆-haloalkylthio, —OR^{a}, —NR^{c}R^{d}, —S(O)ₙR^{a}, —S(O)ₙNR^{c}R^{d}, —C(═O)R^{a}, —C(═O)NR^{c}R^{d}, —C(═O)OR^{b}, —C(═S)R^{a}, —C(═S)NR^{c}R^{d}, —C(═S)OR^{b}, —C(═S)SR^{b}, —C(═NR^{c})R^{b}, and —C(═NR^{c})NR^{c}R^{d};
k is 0 or 1;
n is 0, 1 or 2;
or a stereoisomer, salt, tautomer or N-oxide, or a polymorphic crystalline form, a co-crystal or a solvate of a compound or a stereoisomer, salt, tautomer or N-oxide thereof;
and
2) at least one pesticidally active compound II selected from group M consisting of
II-M.1 Acetylcholine esterase (AChE) inhibitors from the class of
II-M.1A carbamates, including aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of
II-M.1B organophosphates, including acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;
II-M.2 GABA-gated chloride channel antagonists such as:
II-M.2A cyclodiene organochlorine compounds, including endosulfan or chlordane; or
II-M.2B fiproles (phenylpyrazoles), including ethiprole, fipronil, flufiprole, pyrafluprole and pyriprole;
II-M.3 Sodium channel modulators from the class of
II-M.3A pyrethroids, including acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or
II-M.3B sodium channel modulators such as DDT or methoxychlor;
II-M.4 Nicotinic acetylcholine receptor agonists (nAChR) from the class of
II-M.4A neonicotinoids, including acetamiprid, chlothianidin, dinotefuran, imidacloprid, nitenpyram, thiacloprid and thiamethoxam; or the compounds
II-M.4A.1: 1-[(6-chloro-3-pyridinyl)methyl]-2,3,5,6,7,8-hexahydro-9-nitro-(5S,8R)-5,8-Epoxy-H-imidazo[1,2-a]azepine; or
II-M.4A.2: 1-[(6-chloro-3-pyridyl)methyl]-2-nitro-1-[(E)-pentylideneamino]guanidine; or
II-M4A.3: 1-[(6-chloro-3-pyridyl)methyl]-7-methyl-8-nitro-5-propoxy-3,5,6,7-tetrahydro-2H-imidazo[1,2-a]pyridine; or
II-M.4B nicotine.
II-M.5 Nicotinic acetylcholine receptor allosteric activators from the class of spinosyns, including spinosad or spinetoram;
II-M.6 Chloride channel activators from the class of avermectins and milbemycins, including abamectin, emamectin benzoate, ivermectin, lepimectin or milbemectin;
II-M.7 Juvenile hormone mimics, such as
II-M.7A juvenile hormone analogues as hydroprene, kinoprene and methoprene; or others as
II-M.7B fenoxycarb, or
II-M.7C pyriproxyfen;
II-M.8 miscellaneous non-specific (multi-site) inhibitors, including
II-M.8A alkyl halides as methyl bromide and other alkyl halides, or
II-M.8B chloropicrin, or
II-M.8C sulfuryl fluoride, or
II-M.8D borax, or
II-M.8E tartar emetic;
II-M.9 Selective homopteran feeding blockers, including
II-M.9B pymetrozine, or
II-M.9C flonicamid;
II-M.10 Mite growth inhibitors, including
II-M.10A clofentezine, hexythiazox and diflovidazin, or
II-M.10B etoxazole;
II-M.11 Microbial disruptors of insect midgut membranes, including bacillus thuringiensis or bacillus sphaericus and the insecticdal proteins they produce such as bacillus thuringiensis subsp. israelensis, bacillus sphaericus, bacillus thuringiensis subsp. aizawai, bacillus thuringiensis subsp. kurstaki and bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;
II-M.12 Inhibitors of mitochondrial ATP synthase, including
II-M.12A diafenthiuron, or
II-M.12B organotin miticides such as azocyclotin, cyhexatin or fenbutatin oxide, or
II-M.12C propargite, or
II-M. 12D tetradifon;
II-M.13 Uncouplers of oxidative phosphorylation via disruption of the proton gradient, including chlorfenapyr, DNOC or sulfluramid;
II-M. 14 Nicotinic acetylcholine receptor (nAChR) channel blockers, including nereistoxin analogues as bensultap, cartap hydrochloride, thiocyclam or thiosultap sodium;
II-M.15 Inhibitors of the chitin biosynthesis type 0, such as benzoylureas including bistrifluron, chlorfluazuron, diflubenzuron, flucycloxuron, flufenoxuron, hexaflumuron, lufenuron, novaluron, noviflumuron, teflubenzuron or triflumuron;
II-M.16 Inhibitors of the chitin biosynthesis type 1, including buprofezin;
II-M. 17 Moulting disruptors, Dipteran, including cyromazine;
II-M. 18 Ecdyson receptor agonists such as diacylhydrazines, including methoxyfenozide, tebufenozide, halofenozide, fufenozide or chromafenozide;
II-M. 19 Octopamin receptor agonists, including amitraz;
II-M.20 Mitochondrial complex III electron transport inhibitors, including
II-M.20A hydramethylnon, or
II-M.20B acequinocyl, or
II-M.20C fluacrypyrim;
II-M.21 Mitochondrial complex I electron transport inhibitors, including
II-M.21A METI acaricides and insecticides such as fenazaquin, fenpyroximate, pyrimidifen, pyridaben, tebufenpyrad or tolfenpyrad, or
II-M.21B rotenone;
II-M.22 Voltage-dependent sodium channel blockers, including
II-M.22A indoxacarb, or
II-M.22B metaflumizone; or
II-M.22C 1-[(E)-[2-(4-cyanophenyl)-1-[3-(trifluoromethyl)phenyl]ethylidene]amino]-3-[4-(difluoromethoxy)phenyl]urea;
II-M.23 Inhibitors of the acetyl CoA carboxylase, including Tetronic and Tetramic acid derivatives, including spirodiclofen, spiromesifen or spirotetramat;
II-M.24 Mitochondrial complex IV electron transport inhibitors, including
II-M.24A phosphine such as aluminium phosphide, calcium phosphide, phosphine or zinc phosphide, or
II-M.24B cyanide.
II-M.25 Mitochondrial complex II electron transport inhibitors, such as beta-ketonitrile derivatives, including cyenopyrafen or cyflumetofen;
II-M.26 Ryanodine receptor-modulators from the class of diamides, including flubendiamide, chlorantraniliprole (Rynaxypyr®), cyantraniliprole (Cyazypyr®), or
the phthalamide compounds
II-M.26.1: (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and
II-M.26.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, or the compound
II-M.26.3: 3-bromo-N-{2-bromo-4-chloro-6-[(1-cyclopropylethyl)carbamoyl]phenyl}-1-(3-chlorpyridin-2-yl)-1H-pyrazole-5-carboxamide (proposed ISO name: cyclaniliprole),
or the compound
II-M.26.4: methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate; or a compound selected from II-M.26.5a) to II-M.26.5d):
II-M.26.5a: N-[2-(5-amino-1,3,4-thiadiazol-2-yl)-4-chloro-6-methyl-phenyl]-5-bromo-2-(3-chloro-2-pyridyl)pyrazole-3-carboxamide;
II-M.26.5b: 5-chloro-2-(3-chloro-2-pyridyl)-N-[2,4-dichloro-6-[(1-cyano-1-methyl-ethyl)carbamoyl]phenyl]pyrazole-3-carboxamide;
II-M.26.5c: 5-bromo-N-[2,4-dichloro-6-(methylcarbamoyl)phenyl]-2-(3,5-dichloro-2-pyridyl)pyrazole-3-carboxamide;
II-M.26.5d: N-[2-(tert-butylcarbamoyl)-4-chloro-6-methyl-phenyl]-2-(3-chloro-2-pyridyl)-5-(fluoromethoxy)pyrazole-3-carboxamide; or
II-M.26.6: N2-(1-cyano-1-methyl-ethyl)-N1-(2,4-dimethylphenyl)-3-iodo-phthalamide; or
II-M.26.7: 3-chloro-N2-(1-cyano-1-methyl-ethyl)-N1-(2,4-dimethylphenyl)phthalamide;
II-M.X insecticidal active compounds of unknown or uncertain mode of action, including afidopyropen, azadirachtin, amidoflumet, benzoximate, bifcnazate, bromopropylate, chinomethionat, cryolite, dicofol, flufenerim, flometoquin, fluensulfone, flupyradifurone, piperonyl butoxide, pyridalyl, pyrifluquinazon, sulfoxaflor, pyflubumide, or the compounds
II-M.X.1: 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide, or the compound
II-M.X.2: cyclopropaneacetic acid, 1,1′-[(3S,4R,4aR,6S,6aS,12R, 12aS,12bS)-4-[[(2-cyclopropylacetyl)oxy]methyl]-1,3,4,4a,5,6,6a,12,12a, 12b-decahydro-12-hydroxy-4,6a, 12b-trimethyl-11-oxo-9-(3-pyridinyl)-2H,11H-naphtho[2,1-b]pyrano[3,4-e]pyran-3,6-diyl]ester, or the compound
II-M.X.3: 11-(4-chloro-2,6-dimethylphenyl)-12-hydroxy-1,4-dioxa-9-azadispiro[4.2.4.2]-tetradec-11-en-10-one, or the compound
II-M.X.4 3-(4′-fluoro-2,4-dimethylbiphenyl-3-yl)-4-hydroxy-8-oxa-1-azaspiro[4.5]dec-3-en-2-one, or the compound
II-M.X.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of bacillus firmus (Votivo, I-1582), or
II-M.X.6: a compound selected from the group of
II-M.X.6a: (E/Z)—N-[1-[(6-chloro-3-pyridyl)methyl]-2-pyridylidene]-2,2,2-trifluoro-acetamide;
II-M.X.6b: (E/Z)—N-[1-[(6-chloro-5-fluoro-3-pyridyl)methyl]-2-pyridylidene]-2,2,2-trifluoro-acetamide;
II-M.X.6c: (E/Z)-2,2,2-trifluoro-N-[1-[(6-fluoro-3-pyridyl)methyl]-2-pyridylidene]acetamide;
II-M.X.6d: (E/Z)—N-[1-[(6-bromo-3-pyridyl)methyl]-2-pyridylidene]-2,2,2-trifluoro-acetamide;
II-M.X.6e: (E/Z)—N-[1-[1-(6-chloro-3-pyridyl)ethyl]-2-pyridylidene]-2,2,2-trifluoro-acetamide;
II-M.X.6f: (E/Z)—N-[1-[(6-chloro-3-pyridyl)methyl]-2-pyridylidene]-2,2-difluoro-acetamide;
II-M.X.6g: (E/Z)-2-chloro-N-[1-[(6-chloro-3-pyridyl)methyl]-2-pyridylidene]-2,2-difluoro-acetamide;
II-M.X.6h: (E/Z)—N-[1-[(2-chloropyrimidin-5-yl)methyl]-2-pyridylidene]-2,2,2-trifluoro-acetamide and II-M.X.6i: (E/Z)—N-[1-[(6-chloro-3-pyridyl)methyl]-2-pyridylidene]-2,2,3,3,3-pentafluoro-propanamide), or
II-M.X.7: triflumezopyrim; or
II-M.X.8: 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, or
II-M.X.9: 3-[3-chloro-5-(trifluoromethyl)phenyl]-4-oxo-1-(pyrimidin-5-ylmethyl)pyrido[1,2-a]pyrimidin-1-ium-2-olate; or
II-M.X.10: 8-chloro-N-[2-chloro-5-methoxyphenyl)sulfonyl]-6-trifluoromethyl)-imidazo[1,2-a]pyridine-2-carboxamide; or
II-M.X.11: 4-[5-(3,5-dichlorophenyl)-5-(trifluoromethyl)-4H-isoxazol-3-yl]-2-methyl-N-(1-oxothietan-3-yl)benzamide; or
II-M.X.12: 5-[3-[2,6-dichloro-4-(3,3-dichloroallyloxyl)phenoxy]propoxy]-1H-pyrazole; or
II-M.Y Biopesticides, e.g.
II-M.Y-1: Microbial pesticides with insecticidal, acaricidal, molluscidal and/or nematicidal activity: Bacillus firmus, B. thuringiensis ssp. israelensis, B. t. ssp. galleriae, B. t. ssp. kurstaki, Beauveria bassiana, Burkholderia sp., Chromobacterium subtsugae, Cydia pomonella granulosis virus, Isaria fumosorosea, Lecanicillium longisporum, L. muscarium (formerly Verticillium lecanii), Metarhizium anisopliae, M. anisopliae var. acridum, Paecilomyces fumosoroseus, P. lilacinus, Paenibacillus poppiliae, Pasteuria spp., P. nishizawae, P. reneformis, P. usagae, Pseudomonas fluorescens, Steinernema feltiae, Streptomces galbus;
II-M.Y-2) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Quillay extract, Tagetes oil;
in synergistically effective amounts.

27. Pesticidal mixtures according to claim 26, comprising a compound of formula I and a compound II in a weight ratio of from 500:1 to 1:100.

28. Pesticidal mixtures according to claim 26, in which the compound of formula I is a compound of formula IA: 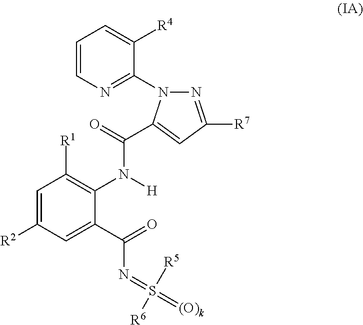
wherein
R⁴ is halogen.

29. Pesticidal mixtures according to claim 26, in which the compound of formula I is a compound of formula IB: 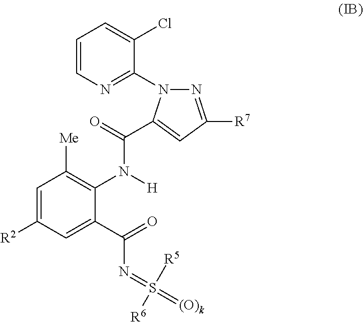
wherein
R² is selected from the group consisting of bromo, chloro, cyano;
R⁷ is selected from the group consisting of bromo, chloro, trifluoromethyl, OCHF₂.

30. Pesticidal mixtures according to claim 26, in which the compound of formula I is a compound of formula IC: 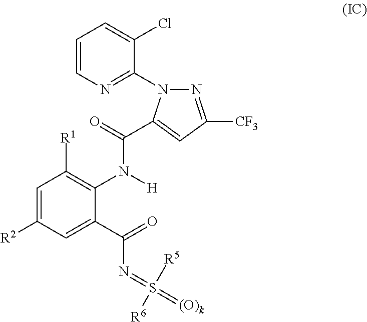
wherein
R¹ is selected from the group consisting of halogen and halomethyl;
R² is selected from the group consisting of bromo, chloro and cyano.

31. Pesticidal mixtures according to claim 26, in which the compound of formula I is a compound of formula ID: 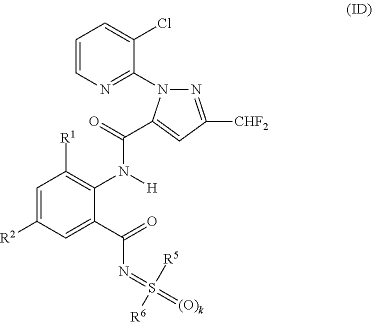
wherein
R¹ is selected from the group consisting of halogen, methyl and halomethyl;
R² is selected from the group consisting of bromo, chloro and cyano.

32. Pesticidal mixtures according to claim 26, in which in the compound of formula I
R⁵ and R⁶ are selected from methyl, ethyl, isopropyl, n-propyl, n-butyl, isobutyl, tert-butyl, cyclopropyl, cyclopropylmethyl.

33. Pesticidal mixtures according to claim 26, in which in the compound of formula I
R⁵ and R⁶ are identical.

34. Pesticidal mixtures according to claim 26, comprising a compound II which is a neonicotinoid.

35. Pesticidal mixtures according to claim 34, comprising a compound II which is selected from clothianidin, dinotefuran, imidacloprid, thiacloprid or thiamethoxam, in particular dinotefuran.

36. Pesticidal mixtures according to claim 26, comprising a compound II which is fipronil.

37. Pesticidal mixtures according to claim 26, comprising a compound II which is a pyrethroid.

38. Pesticidal mixtures according to claim 34, comprising a compound II which is a alpha-cypermethrin.

39. Pesticidal mixtures according to claim 26, comprising a compound II which is chlorfenapyr.

40. Pesticidal mixtures according to claim 26, comprising a compound II which is II-M.X.2 is cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester.

41. Pesticidal mixtures according to claim 25, comprising a compound II which is abamectin.

42. Pesticidal mixtures according to claim 25, comprising a compound II which is an inhibitor of the acetyl CoA carboxylase, including Tetronic and Tetramic acid derivatives, spirodiclofen, spiromesifen or spirotetramat.

43. Pesticidal mixtures according to claim 25, comprising a compound II which is a selective homopteran feeding blocker, including pymetrozine and flonicamid.

44. Pesticidal mixtures according to claim 25, comprising a compound II which is sulfoxaflor.

45. Pesticidal mixtures according to claim 25, comprising a compound II which is a Ryanodine receptor modulator including chlorantraniliprole and cyantraniliprole.

46. A method for controlling insects, acarids or nematodes comprising contacting an insect, acarid or nematode or their food supply, habitat, breeding grounds or their locus with a mixture according to claim 25 in pesticidally effective amounts.

47. A method of protecting plants from attack or infestation by insects, acarids or nematodes comprising contacting the plant, or the soil or water in which the plant is growing, with a pesticidally effective amount of a mixture according to claim 26.

48. A method for protection of plant propagation material comprising contacting the plant propagation material with a mixture as defined in claim 26 in pesticidally effective amounts.

49. Seed, comprising the mixture according to claim 26 in an amount of from 0.1 g to 10 kg per 100 kg of seeds.

50. A pesticidal composition, comprising a liquid or solid carrier and a mixture according to claim 26.
